(19) United States
(12) Patent Application Publication
(10) Pub. No.: US 2019/0332921 A1
(43) Pub. Date: Oct. 31, 2019

(54) DECENTRALIZED STORAGE STRUCTURES AND METHODS FOR ARTIFICIAL INTELLIGENCE SYSTEMS

(71) Applicant: Vosai, Inc., Doral, FL (US)

(72) Inventor: Daniel Jose Rodriguez, Miami, FL (US)

(21) Appl. No.: 16/383,342

(22) Filed: Apr. 12, 2019

Related U.S. Application Data
(60) Provisional application No. 62/657,514, filed on Apr. 13, 2018.

(51) Int. Cl. G06N 3/04; G06F 16/29; G06F 16/2457; G06F 9/54; H04L 9/06

(52) U.S. Cl. CPC G06N 3/0454; G06F 16/29; G06F 16/24575; H04L 2209/38; G06F 9/541; H04L 9/0643; G06F 16/24573

(57) ABSTRACT

The present disclosure generally relates to decentralized storage and methods for artificial intelligence. For example, blockchain storage structure can be adapted for storing artificial intelligence learnings. Nodes of a chain can includes hash codes generated and validated by a community of learners operating computing system across a distributed network. The hash codes can be validated hash codes in which a community of learners determines through a competitive process a consensus interpretation of a machine learning. The validated hash codes can represent machine learnings, without storing the underlying media or files in the chain itself. This can allow a customer to subsequently query the chain, such as by establishing a query condition and searching the chain, and determine new learnings and insights from the community.

### CROSS-REFERENCE TO RELATED APPLICATION

This patent application is a non-provisional patent application of, and claims priority to, U.S. Provisional Patent Application No. 62/657,514 filed Apr. 13, 2018, titled “Decentralized Storage Structures and Methods for Artificial Intelligence Systems,” the disclosure of which is hereby incorporated by reference in its entirety.

### TECHNICAL FIELD

The technology described herein relates generally to decentralized storage and methods for artificial intelligence.

### BACKGROUND

Artificial intelligence systems typically are stored and executed on centralized networks that involve significant hardware and infrastructure. Problems with existing systems may include one or more of the following: lack of transparency, access control, computational limitations, costs of fault tolerance, narrow focus, and infrastructure technology changes. There is a need for a technical solution to remedy one or more of these problems of existing artificial intelligence systems, or at least provide an alternative thereto.

### SUMMARY

The present disclosure generally relates to decentralized storage and methods for artificial intelligence. Described herein includes adapting blockchain storage structures for storing artificial intelligence learnings. Nodes of a chain can include hash codes generated and validated by a community of learners operating computing systems across a distributed network. The hash codes can be validated hash codes in which a community of learners determines through a competitive process a consensus interpretation of a machine learning. The validated hash codes can represent machine learnings, without storing the underlying media or files in the chain itself. This can allow a customer to subsequently query the chain, such as by establishing a query condition and searching the chain to determine new leanings and insights from the community. Through the process, the customer can thus benefit from the community of artificial intelligence leanings across a variety of domain use cases, often without needing robust or expert-level artificial intelligence skills at the customer level.

While many embodiments are described herein, in an embodiment, a method for storing artificial intelligence data for a blockchain is disclosed. The method includes analyzing by two or more computers a first media file. The method further includes generating by the first computer a first hash code describing the first media file. The method further includes generating by the second computer a second hash code describing the first media file. The method further includes comparing the first hash code and the second hash code. The method further includes selecting a validated hash code based on a comparison between the first hash code and the second hash code. The method further includes adding a first block to a chain node, wherein the first block includes the validated hash code describing the first media file.

In another embodiment, the chain node is associated with a side storage chain. In this regard, the method can further include merging the first block with a main storage chain, the main storage chain including a compendium of learned content across a domain. The chain node can further include a metadata block describing attributes of an environment associated with the first media file. The chain node can further include a related block describing a relationship of the chain node to another chain node. The chain node can further include a data block including information derived from a machine learning process.

In another embodiment, the first media file can include a sound file, a text file, or an image file. The validated hash code can reference one or more of the sound file, the text file, or the image file without storing the one or more of the sound file, the text file, or the image file on the chain node or associated chain nodes.

In another embodiment, the method further includes determining the first or second computer is a validated learner by comparing the first hash code and the second hash code with the validated hash code. The method, in turn, can further include transmitting a token to the first or second computer in response to a determination of the first or second computer being a validated learner.

In another embodiment, the method can further include receiving a second media file from a customer. The method, in turn, can further include generating another hash code by analyzing the second media file with the two or more computers, or another group of computers. In some cases, the method can further include computing a query condition for the artificial intelligence data by comparing the another hash code with the validated hash code of the first block or other information of the chain node, and delivering the query condition to the customer for incorporation into a customer application.

In another embodiment, a decentralized memory storage structure is disclosed. The storage structure includes a main storage chain stored on a plurality of storage components and comprising a plurality of main blocks. The storage structure further includes one or more side storage chains stored on the plurality of storage components and comprising a plurality of side blocks. One or more of the side blocks can be merged into the main storage chain based on a validation process.

In another embodiment, the plurality of main blocks and the plurality of side blocks include unique, non-random identifiers, wherein the identifiers describe at least one of a text, an image, or an audio. In this regard, the at least one of the text, the image, or the audio may not be stored on the main storage chain or the side storage chain.

In another embodiment, the plurality of main blocks and the plurality of side blocks include block relationships describing a relationship between each block and another block in the respective main chain or side chain. The storage structure can include two or more computers geographically distributed across the decentralized memory storage structure and defining a community of learners. In this regard, the validation process can include determining a validation hash code from the community of learners by comparing hash codes generated by individual ones of the two or more computers.

In another embodiment, a method for creating a multimedia hash for a blockchain storage structure is disclosed. The method includes generating a first perception hash code from a first media file. The method further includes generating a second perception hash code from a second media file. The method further includes generating a context hash code using the first and second perception hash code. The method further includes storing the context hash code on a chain node, the chain node including metadata describing attributes of an environment associated with the first and second media file.

In another embodiment, the method can further include performing a validation process on the first or second perception hash code. The validation process can rely on a community of learners, each operating a computer that collectively defines a decentralized memory storage structure. Each of the community of learners can generate a hash code for the first or second media file. The generated hash codes can be compared among the community of learners to determine a validated hash code for the first or second perception hash code. The first and second media file can be different media types, the media types include a sound file, a text file, or an image file.

In another embodiment, the method further includes generating a third perception hash code from a third media file associated with the environment. In this regard, the operation of generating the context hash code can further include generating the context hash code using the third perception hash code. In some cases, the environment can be a first environment. As such, the method can further include generating a subsequent context hash code for another media file associated with a second environment, and analyzing the second environment with respect to the first environment by querying a chain associated with the chain node using the subsequent context hash code.

In another embodiment, a method of querying a data storage structure for artificial intelligence data is disclosed. The method includes receiving raw data from a customer for a customer application, the data including media associated with an environment. The method further includes generating hash codes from the raw data using a decentralized memory storage structure. The method further includes computing a query condition by comparing the hash codes with information stored on one or more nodes of a chain. The method further includes delivering the query condition to the customer for incorporation into the customer application.

In another embodiment, the operation of receiving includes using an API adaptable to the customer application across a domain of use cases. The API can include a data format for translating user requests into the query condition for traversing the one or more nodes. The data format can be a template modifiable by the customer.

In another embodiment, the information stored on the one or more chains can include validated hash codes validated by a community of users. In this regard, the information further includes metadata descriptive of the environment.

In another embodiment, the operation of generating hash codes from the raw data comprises generating context hash codes describing the media associated with the environment. In this regard, this can further include updating the one or more nodes of the chain with the generated hash codes. In some cases, the chain can be a private chain. In this regard, the operation of updating can further include pushing information associated with the updated one or more nodes of the private chain to other chains of a distributed network.

In addition to the exemplary aspects and embodiments described above, further aspects and embodiments will become apparent by reference to the drawings and by study of the following description.

### BRIEF DESCRIPTION OF THE DRAWINGS

FIG. 1 depicts a system architecture diagram;

FIG. 2 depicts a diagram of a user interface of a learner application;

FIG. 3 depicts a diagram including functional modules of a learner user interface;

FIG. 4 depicts a diagram including functional modules of a plug-in subsystem of the learner user interface;

FIG. 5 depicts a diagram including functional modules of a hardware sub-system of the plug-in sub-system;

FIG. 6 depicts a diagram including functional modules of an algorithm subsystem of the plug-in subsystem;

FIG. 7 depicts a diagram including functional modules of an IAlgorithm module of the algorithm sub-system;

FIG. 8 depicts a diagram including functional modules of an IModel module of the algorithm sub-system;

FIG. 9 depicts a diagram including functional modules of an IPayload module of the algorithm sub-system;

FIG. 10 depicts a flow chart illustrating a method of learning interactions with a community of learners;

FIG. 11 depicts a graph illustrating unit of work and quality of work relative to time;

FIG. 12 depicts a graph illustrating a learning effect with many units of work;

FIG. 13 depicts a graph illustrating a transition from learning to identification;

FIG. 14 depicts a diagram of a miner ranking system;

FIG. 15 depicts a diagram illustrating a mining (learning) process as new media is encountered on the network;

FIG. 16 depicts a simplified diagram illustrating interactions between customers, developers, providers, validators, and learners;

FIG. 17 depicts a simplified diagram illustrating interactions between an artificial intelligence system including a centralized portion, a decentralized portion, and outside actors.

FIG. 18 depicts a diagram of a blockchain including a main chain and a side chain;

FIG. 19 depicts a diagram illustrating use of the Ethereum network to purchase a token on the pathway of FIG. 18;

FIG. 20 depicts a diagram illustrating various blocks that could be used in the blockchain;

FIG. 21 depicts a diagram illustrating various types of metadata, hash code, and related blocks for one of the blocks illustrated in FIG. 20;

FIG. 22 depicts a flow chart illustrating logic for generating a hash code and appending the code to a blockchain;

FIG. 23 depicts a diagram illustrating hashing and related media processing;

FIG. 24 depicts a diagram illustrating storage of media in centralized stores;

FIG. 25 depicts a diagram illustrating a process of creating a context hash code;

FIG. 26 depicts a diagram illustrating a process of creating a context hash code in which perception hashes are combined first, prior to creating a context hash;

FIG. 27 depicts a diagram illustrating a comparison of hash codes to allow for similarity checks between contexts;

FIG. 28 depicts a diagram illustrating merging data from one chain to another chain;

FIG. 29 depicts a diagram illustrating blocks in a main chain and a side chain;

FIG. 30 depicts a diagram illustrating pathway relationship between pathway blocks or nodes;

FIG. 31 depicts a diagram illustrating a graph organization of pathway blocks or nodes;

FIG. 32 depicts a diagram illustrating a list organization of pathway blocks or nodes;

FIG. 33 depicts a diagram illustrating pathway node interactions;

FIG. 34 depicts a diagram illustrating a centralized/decentralized deployment architecture;

FIG. 35 depicts a diagram illustrating a decentralized deployment architecture;

FIG. 36 depicts a diagram illustrating a pathway network architecture;

FIG. 37 depicts a diagram illustrating pathway node interactions;

FIG. 38 depicts a diagram illustrating pathway deployment configurations;

FIG. 39 depicts a diagram illustrating private/public pathway synchronization;

FIG. 40 depicts a diagram illustrating miner/pathway deployment;

FIG. 41 depicts a diagram illustrating token flow interactions across a network;

FIG. 42 depicts a diagram illustrating payment system interactions across a network;

FIG. 43 depicts a diagram illustrating various user interfaces for indicating the status of AGI;

FIG. 44 depicts a diagram illustrating a simplified compute layer approach;

FIG. 45 depicts a diagram illustrating a simplified AI system including centralized and decentralized portions;

FIG. 46 depicts a diagram illustrating a simplified compute layer of the AI system;

FIG. 47 depicts a simplified block diagram of a computing system;

FIG. 48 depicts a flow diagram for storing artificial intelligence data;

FIG. 49 depicts a flow diagram for creating a multimedia hash for a blockchain storage system; and

FIG. 50 depicts a flow diagram of querying a data storage structure from artificial intelligence data.

### DETAILED DESCRIPTION

The description that follows includes sample systems, methods, and apparatuses that embody various elements of the present disclosure. However, it should be understood that the described disclosure can be practiced in a variety of forms in addition to those described herein.

The present disclosure describes systems, devices, and techniques that are related to a network or system for artificial intelligence (AI), such as artificial general intelligence (AGI). The network may include AI algorithms designed to operate on a decentralized network of computers (e.g., world computer, fog) powered by a specific blockchain and tokens designed for machine learning. The network may unlock existing unused decentralized processing power, and this processing power may be used on devices throughout the world to meet, for example, the growing demands of machine learning and computer vision systems. The network may be more efficient, resilient, and cost effective as compared to existing centralized cloud computing organizations.

The artificial intelligence network or system may include democratically controlled AI, such as AGI, for image classification and contextualization as well as natural language processing (NLP) running on a decentralized network of computers (e.g., World Computer). The AGI may be accessed via one or more application programming interface (API) calls, thereby providing easy access to image analytics and natural language communication. The AGI may be enterprise-ready, with multiple customers in queue. Miners may process machine learning (ML) algorithms on their rigs rather than generating random hash codes to secure the network, and the miners may be incentivized by being compensated for their efforts. The AGI may learn and grow autonomously backed by a compendium of knowledge on a blockchain, and the blockchain may be accessible to the public.

The artificial intelligence network or system may use a peer-to-peer machine learning blockchain. Each node within the blockchain may serve as a learned context for the AGI, which may be instantly available to all network users. Each entry may have a unique fingerprint called a hash which is unique to the context of the entry. Indexing contexts by hash allows the network to find and distribute high volumes of contexts with high efficiency and fault tolerance. The peer-to-peer network can rebalance and recover in response to events, which can keep the data safe and flowing.

The artificial intelligence network or system may use a token, similar to Bitcoin and Ethereum. Instead of using proof-of-work consensus for the mining process, miners in the network or system can earn tokens by providing useful and valuable computer instruction processing to solve actual problems, rather than complex mathematical problems that are useful only to the network. The tokens, or other forms of consideration for resources and time, may be stored in cryptocurrency wallets or the like and freely transacted as users see fit, for example.

The artificial intelligence network or system may include protocols, systems, and tools to provide AI, such as AGI, applicable to any domain. The network may be based on open-source technologies and systems and may be governed by a governance body. The network may be in an open ecosystem for decentralized processing power, and developers may be provided an open and sustainable platform to build, enhance, and monetize.

The AI, such as AGI, may be applicable to multiple industries including construction, agriculture, law enforcement, and infrastructure. For example, in a world that's ever growing in population, the demands on food production are strained. Diseases, illnesses, infections, and wasteful methods are all problems farmers face. The AI may aid them in detecting these issues ahead of time by consuming real world data (e.g., images) of farms and distilling them down to actionable results (e.g., trees infected with disease). Construction can be improved by minimizing waste as much as possible. To minimize waste, rework performed per project, which typically is 5-10% of a project size, may be reduced. The artificial intelligence system may abate this by distilling terabytes of imagery down to actionable results. Meaning, it can inform field engineers of errors as they occur (i.e., “pipe 123 is off by 2.5 cm”), or prevent the errors from happening in the first place by providing distilled reports to project teams with instructions on how to proceed with the build based on the previous day's progress.

### Ecosystem

The artificial intelligence network or system may offer certain benefits to clients, miners (learners), partners, and vendors. Regarding clients, the system may offer a decentralized machine learning compute platform solution with advantages over existing cloud-based computing options, including the possibility of lower costs, end-to-end encryption at rest, redundancy, self-healing, and resilience to some kinds of failures and attacks. Furthermore, the network may allow clients to tune performance of AGI interactions to suit their needs in order to keep up with the demands of their business. For example, clients with large volumes of images may need to process this imagery rapidly in bulk, in which case they may optimize for speed of processing. Clients may be able to send requests to the network with the desired performance metrics and other parameters, and pay for the computation of the request.

Miners, or learners, are the core service providers of the network. Learners may use the network to process machine learning requests ultimately mining new blocks on the chain, validating mined blocks between transactions, propagating blocks between chains, and ultimately producing results on chains for clients and other miners to leverage. The network may be designed to reward participants for such services in the form of tokens. The network may be designed to reward participants at multiple levels—from large scale data centers to local entrepreneurs with mining rigs that cover the last mile. Moreover, the network may reward those that innovate upon hardware and software components which can be leveraged by the miner software. The network may be freely transacted, allowing miners to retain tokens or exchange them for other currencies like ETH, BTC, USD, EUR and more. The network may use one or more factors, such as a unit of work (UoW) and quality of work (QoW), to analyze and collectively determine the effectiveness of a miner's computational infrastructure. Together, this enables miners, the active nodes in the network providing the computational power to the clients, to do useful work while mining tokens.

The artificial intelligence network or system may yield opportunity for additional parties in the machine learning and computer vision ecosystem. The network may drive additional demand for processing units and algorithmic developments in the AI ecosystem. Furthermore, mining software may come pre-installed on computer systems, creating a new class of devices optimized for the network. ISPs, cloud providers, research organizations, and educational institutions, for example, may participate both as miners and as vendors to other miners.

The blockchain may be a next-generation protocol for machine learning that seeks to make machine learning transparent, secure, private, safer, decentralized, and permanent. The blockchain may leverage hybrid data stores based on graphs, documents, and key/value mechanisms. Example information processed by the network may include telemetry data, audio, video, imagery, and other sensory data which require extensive processing in order to produce actionable results, such that it removes additional work from organizations and provides the key insights.

### Blockchain

(i) Problems with Existing Systems

Problems with existing systems include no transparency, access control, computational limitations, costs of fault tolerance, narrow focus, and infrastructure technology changes. Each of these problems is discussed in more detail in the following paragraphs.

Regarding transparency, many cloud providers and data centers offer privacy and security mechanisms, but improvements are needed when it comes to privacy and user data. For example, many governments have demanded and obtained access to private data stored by companies. Email providers, for example, have disclosed data to the government without user permission. Furthermore, user data has been sold between companies for profit. Additionally, select entities and/or personnel have used, developed, expanded, and controlled existing systems for their own monetary gain, without visibility to the public. Using blockchain, the network provides transparency.

Regarding access control, under existing systems there is no visibility into who contributes data, processes data, interprets data, and consumes the data. For example, in existing systems, a user has to feed vast amounts of information to these systems. The organizations running these systems may use the data derived from this information, but this is not visible to the user or the public. Once the organizations have the learned data or meta-data around the provided data, it is easy for the organization to use the data to their benefit, without visibility to the user. Using blockchain, the network described herein provides visibility into data usage.

Regarding computational limitations, AI, such as AGI, requires extensive compute power. The compute power required is costly, custom, and not completely available in modern day cloud providers. Existing cloud providers focus on delivering an infrastructure that works very well for standard websites, e-commerce, and enterprise systems. However, the infrastructure is not able to compute massive amounts of data using graphics processing units (GPUs) and is not able to scale to thousands of central processing unit (CPU) cores at a cost-effective price. It takes countless GPU's, or any other type of processing unit, to perform extensive computations, and thus problems arise when using cloud computing for AI. Using blockchain, the network described herein has extensive compute power for AGI.

Regarding costs of fault tolerance, machine learning systems are expensive to build. They often require thousands of GPU-based servers processing petabytes of information as fast as possible. Moreover, the network and storage requirements alone for this infrastructure is astronomical. It has become such a problem that it has led to new developments in server architecture that deviate from the CPU/GPU paradigm. The advent of tensor processing units (TPUs) and data processing units (DPUs) are promising, but have yet to be proven in the market. Many of these solutions are not yet readily available to the masses for deployment and use. The costs are astronomical to make the infrastructure fault tolerant with disaster recovery zones spanning the globe. Additionally, the infrastructure will be outdated in a few years or less after it has been deployed, requiring further costs to replace/update the infrastructure. Using blockchain, these costs can be reduced and/or eliminated.

Regarding narrow focus, AI solutions of today are very narrow in focus because of how the AI solutions are being implemented by companies. For example, a company may use an AI algorithm to focus the algorithm on one niche area for business reasons. For example, the company may simply want to focus on identification of oranges and the related problems with oranges. There are hundreds of algorithms, frameworks, applications, and solutions “powered by AI” yet many of them are very narrow in focus. Part of this reason is the sheer size of the infrastructure required to handle more extensive AI algorithms. These narrow focuses limit the progress of AI and what can be done. When an AI solution is narrowly focused, the solution applies a generic algorithm/equation that is applicable to many problem domains to a single problem, such as using a machine learning (ML)/computer vision (CV) algorithm to detect cancer cells. The same underlying technology can be applied to a myriad of contexts.

Infrastructure technology changes, from main frames, client server, a server room, a cage in a data center, user data centers, or leveraging a third party data center to cloud providers, have occurred in the recent past. These advancements have provided organizations cost savings but also resulted in cost increases at the same time. Organizations have been forced to continually upgrade, change, or migrate systems between these environments, time and time again. Moreover, if the enterprise systems are developed using too many of the tools provided by these infrastructures, then the enterprise systems become difficult to migrate to the new system.

A few key issues have arisen in the field of Computer Science as it relates to the adoption of machine learning. These key issues revolve around limited or laggard infrastructures, complex system interfaces specific to the computation of machine learning algorithms, models and respective data sets, and lastly “in-house” expertise as it relates to machine learning, computer vision, and natural language processing.

For example, for years Computer Scientists have been creating algorithms for machine learning, computer vision, and natural language processing yet the hardware required for these complex algorithms has either been absent, lacking, or lagging behind where it should be. Ultimately, scientists' resort to constructing custom infrastructures which are costly and burdensome to operate. Yet another example, are the organizations—which include research, education, and the enterprise—that suffer from adopting machine learning technologies due to lack of expertise or insufficient infrastructure. Of the organizations that can amass expertise or proper infrastructure, their implementations result in a very narrow application of machine learning. The one thing these organizations do have plenty of is data. These organizations have massive amounts of information and no way of working with it to make it work for, instead of against them.

The previous observations are coupled with two concepts. The first concept is the evolution of infrastructure through the decades. Organizations went from building their own infrastructures to moving to data centers and now to the cloud. Yet another evolution is occurring with decentralization. The second concept, is the innovation of the cryptocurrency mining community as it relates to the hardware systems devised to streamline the costs, operations, and effectiveness of validating transactions between parties on a respective blockchain. More specifically, the hardware systems devised for cryptocurrency mining also apply to machine learning almost perfectly. Lastly, at the heart of their computational efforts, the miner must brute force cryptographic hashes. Albeit a very good approach to securing a transaction, however, the computation's result is a hash code for a transaction. What if this computation could be processing for machine learning instead, producing a resultant for the betterment of the organization and ultimately all of those involved with the organization and related partners?

Lastly, we address the concept of a decentralized ledger that is transparent, secure, and private. These ledgers are called blockchains in the cryptocurrency world. Coupling the idea of a blockchain with a database for machine learning where everyone could access and benefit from would be at worst altruistic, and at best advance technologies on all fronts. In a sense, freeing the information of machine learning for any interested parties to build upon, driving impact to their users, customers, and ultimately the world.

Reference will now be made to the accompanying drawings, which assist in illustrating various features of the present disclosure. The following description is presented for purposes of illustration and description. Furthermore, the description is not intended to limit the inventive aspects to the forms disclosed herein. Consequently, variations and modifications commensurate with the following teachings, and skill and knowledge of the relevant art, are within the scope of the present inventive aspects.

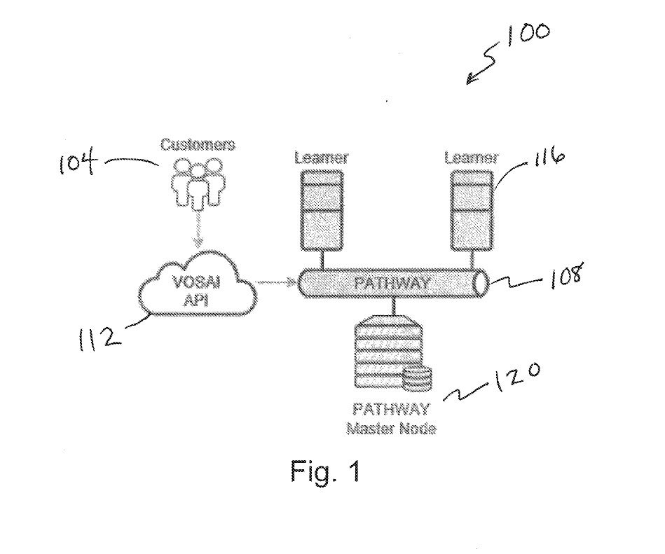

FIG. 1 depicts a system architecture diagram 100. The system architecture diagram 100 includes three main components: (i) Mining Software, (ii) Custom Blockchain, and (iii) Simple RESTful API. Customers 104 can interact with a VOSAI blockchain, PATHWAY 108 through a simple JSON RESTful API 112 which serves as the gateway/proxy to the VOSAI decentralized network. Over time, we foresee this API being purely decentralized but for the time being it is the only centralized portion of the VOSAI system.

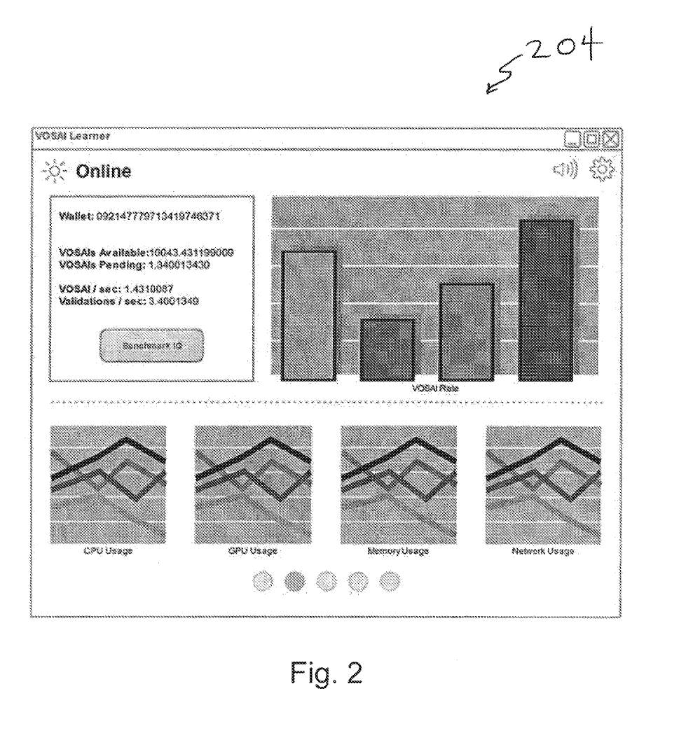

Miners and Pathway Nodes make up the decentralized network of the VOSAI system. For example, miner or learners 116 are shown in relationship to the PATHWAY 108. Miners use the VOSAI Learner as their mining software, as explained in greater detail below with respect to FIG. 2. The VOSAI Learner enables miners to perform machine learning computations.

PATHWAY 108 is our blockchain which serves as a decentralized database for machine learning. VOSAI may have its own set of miners for development purposes. Furthermore, VOSAI will have official master nodes, such as master nodes 120 shown in FIG. 1, as well as authorized partner master nodes in its network. Master Node providers must first be approved by VOSAI.

FIG. 2 depicts a diagram 204 of a user interface of a learner application. The VOSAI Learner is our mining application. It is used by miners to perform machine learning computations in exchange for VOSAI tokens. A specialized miner application like the VOSAI Learner allows miners to earn substantially more over all other cryptocurrencies to date.

Miners earn more by performing actual real work like machine learning computations for image recognition or natural language processing. Unlike other miner applications, VOSAI Learner allows miners to integrate their own hardware or software specialized for machine learning computation. This one ability enables miners to monetize on their own innovations.

VOSAI Learner is meant to interact directly with a miners' computer and the VOSAI blockchain called PATHWAY. The Learner comes pre-packaged with a set of supported machine learning algorithms as well as an understanding on how these algorithms are applied to certain data sets.

Upon the initial installation of the VOSAI Learner, a miner's computer is benchmarked indicating to the miner what the machines earning potential may be. Please refer to later sections about Miner IQ. Once installed and configured on a miner's computer, the VOSAI Learner listens to network requests in a P2P fashion. These requests originate from the network either through miner interaction or direct customer requests against the VOSAI API.

The VOSAI Learner receives a JSON request combined with associated data payloads (e.g., image set) and begins to process this information. Multiple miners compete to finish the work. The first to finish wins and is then validated by the remaining miners. The miners can only validate the winner if they have finished performing the computation as well.

Upon completing work and validation, perception hash codes are created for the input and resultant data payloads. These perception hash codes are then written to Pathway respectively by cooperating miners. Any miner partaking in the interaction will receive their share of respective tokens. Therefore, many miners receive tokens with the winner obviously receiving the most.

Lastly, once information is written to Pathway then and only then are miners rewarded for their work. At which point, the original consumer of the VOSAI API is given results for their request while miners are paid accordingly. The VOSAI Learner is for any person or organization that is actively mining cryptocurrencies today. Moreover, it is also for those looking to get into mining.

Lastly, there are two more personas VOSAI Leaner applies to that have been left on the sidelines for years. Those are the scientists and engineers actively creating AI hardware and algorithms. The VOSAI Learner allows these personas to create new hardware or software algorithms and easily plug them into the VOSAI Learner. Moreover, these personas can monetize their innovations by sharing the technology with the community. Either by adding to the VOSAI Learner set of algorithms or selling customized hardware solutions designed specifically for AI processing.

Miners today suffer tremendously with the volatility in cryptocurrency pricing. The cost for mining changes too frequently for the earnings to remain predictable. In the end, put simply, miners validate transactions and generate hash codes. The amount of work required today is far too costly to operate.

With VOSAI Learner, miners are performing machine learning computations.

Machine learning computation comes at a premium price in today's market. In other words, you have to pay much more for machine learning computation than you do for standard computation (e.g., web page serving).

Therefore, miner's look to use VOSAI Learner for the simple reason of earning more consistent and higher revenues. Lastly, it's difficult for engineers and scientists to develop new innovations without a large tech company behind them. Yet, with VOSAI Learner, the barrier for these personas is much lower. These individuals can focus on the core innovation while having at their disposal a network to monetize their innovation. They may choose to monetize by creating their own mining operations with these innovations, or they may add these innovations to the VOSAI ecosystem.

VOSAI is responsible for the supported algorithms in place as distributed to production miners. Therefore, innovators creating new algorithms and hardware must go through a certification process with VOSAI in order to be part of the ecosystem.

Learning is the process of taking a dataset and classifying it according to the context of the dataset. For example, if a set of images (e.g., apples) is sent for classification, then the act of classification takes place through the process of learning. The learner may be a stand-alone downloadable desktop application that can run on standard desktop PCs, servers, and single board computers (e.g., Raspberry PI). The learner application may leverage the machines hardware to its maximum potential including leveraging CPUs, GPUs, DPUs, TPUs, and any other related hardware supporting machine learning algorithms (e.g., field-programmable gate array (FPGA), Movidius). The learner application may benchmark systems and send metrics to the system in order to inform learners (miners) of the capability of their particular hardware configuration. In turn, metrics are shared with the network to inform other learners on the network which configurations are best suited for machine learning. An example user interface of the learner application is illustrated in FIG. 2. The learner application may include one or more of the following features: cross platform desktop application, links directly to wallets, plugin architecture for custom CV/ML algorithms, marketplace for plugins, built in benchmarking, and dashboards over the network.

The following table illustrates how each type of learner operator plays in this ecosystem. These roles are determined by each individual person. In this case—the miner/learner.

TABLE

| Normal Nelson | Innovator Ivan | Hardware Harry |
|---|---|---|
| Nelson is noteavvy in | Ivan is a Computer Scientist | Harry is a Computer Engineer |
| algorithms nor can he make | with expertise in machine | with expertise in integrated |
| his own hardware. He can | learning algorithms. He is like | circuit design and PCB |
| assemble his learning rig | Nelson but focused on | manufacturing. He's like |
| based on best practices from | software innovation. Ivan | Nelson too but focused on |
| the community. Nelson | developed a new algorithm | hardware innovation. Harry |
| focuses on learning data sets | that improved his efficiency | developed a new GPU that |
| 100% of the time. | and quality of work. Ivan | cuts energy costs in half and |
| Nelson leverages Ivan's and | focuses on innovating | improved performance by |
| Harry's innovations to | software and uses learning to | 200%. Harry focuses on |
| improve his learning. | test his new algorithms. | making great hardware and |
| | Ivan's UoW has decreased | testing it against learning for |
| | and QoW has increased. | benchmarking and |
| | | production. |
| | | Harry's UoW has decreased. |

The blockchain for the artificial intelligence system may be referred to as PATHWAY. The need for creating a blockchain specific to the AI system pertains to the need for a decentralized data store for the learning acquired by the learning processes. In other words, the blockchain is the primary decentralized database of learned information. For example, if we are teaching the artificial intelligence system to understand what an apple looks like, then once learned that information becomes a part of the blockchain. The blockchain may have one or more of the following high-level features: works along-side other blockchains (e.g., Ethereum), not meant for financial transactions, tokens can be purchased through normal blockchains (e.g., Ethereum), only specific tokens are used on the AI blockchain, at least two primary chains on the AI blockchain (a main-chain stores concrete learned artifacts, and a side-chain is used for learning), there may be an additional token used for IQ, transactions from the side-chain(s) only propagate up to the main-chain once fully processed and approved by the network, blockchain based on either a linked-list style blockchain architecture, a graph/tree or a combination of the two, blockchain is traversable for not just transactions but also for look ups, and traversal algorithms and blockchain designed to allow for O(h) or better complexity searches and insertions.

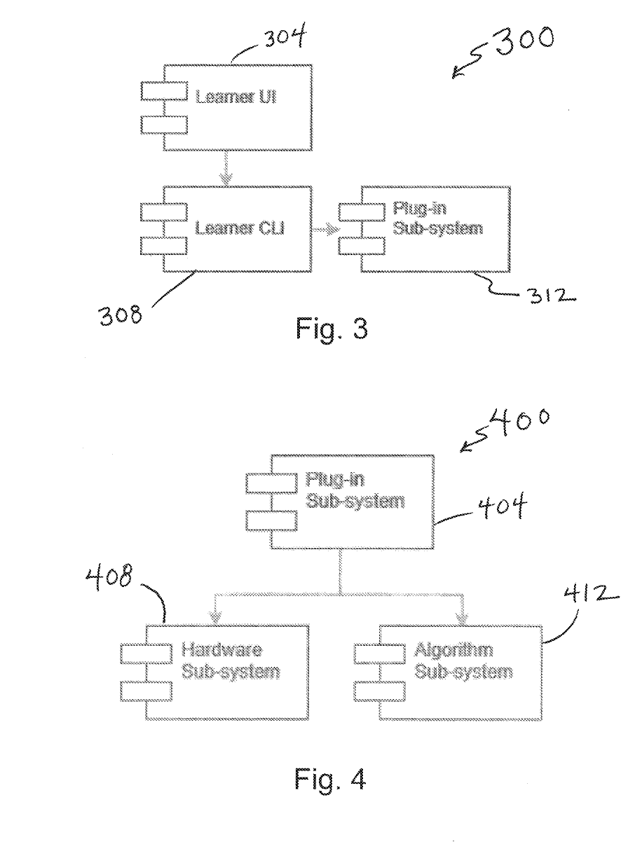

FIG. 3 depicts a diagram 300 including functional modules of a learner user interface 304. The VOSAI Learner is currently privately available for alpha preview to select partners and developers. Internally, VOSAI Learner is comprised from a set of sub-systems of which are illustrated below.

At the core of the VOSAI Learner is the Learner CLI component 308 which handles all interactions and events that take place within the Learner application. CLI is the command line interface module for VOSAI Learner. The Learner UI leverages modern day cross platform UI/UX frameworks allowing for a simple and easy user experience for miners. Miners will primarily interact with VOSAI Learner through this interface.

Underlying the Learner CLI, is the Plug-in sub-system 312. The Plug-in sub-system 312 allows engineers and scientist to develop their own machine learning algorithms and hardware.

FIG. 4 depicts a diagram 400 including functional modules of a plug-in subsystem 404 of the learner user interface. The Plug-in sub-system 404 leverages two additional child sub-systems. One for Hardware devices and the latter for Algorithms, such as the hardware subsystem 408 and the algorithm sub-system 412 shown in FIG. 4. These are the primary and only mechanisms for hardware and algorithms to be leveraged within the VOSAI Learner.

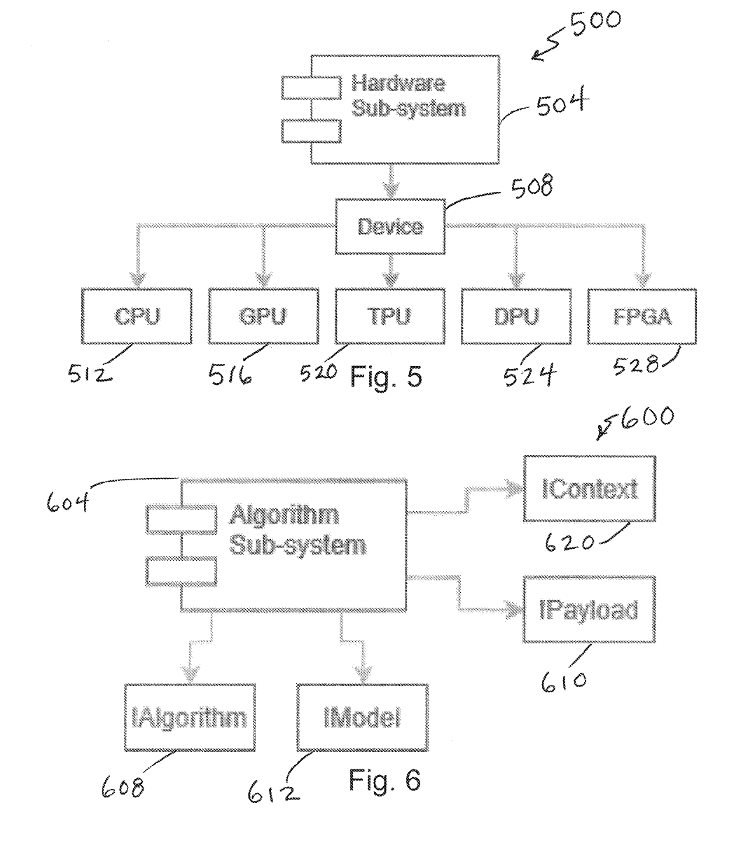

FIG. 5 depicts a diagram 500 including functional modules of a hardware sub-system 504 of the plug-in sub-system, such as any of the plug-in subsystems described herein. In particular, the hardware subsystem can include a device module 508. The device module 508 may permit use of multi components with the hardware module, including and as shown in FIG. 5, a CPU module 512, a GPU module 516, TPU module 520, DPU module 524, and/or FPGA module 528 for the respective hardware devices. Furthermore, it also provides a generic interface for all other hardware devices should one fall outside of this subset of devices. By default, VOSAI Learner comes pre-packaged to support all CPU's and commonly used GPU's for machine learning. Over time, VOSAI will add additional support as it's developed by the organization or the community.

FIG. 6 depicts a diagram 600 including functional modules of an algorithm subsystem 604 of a plug-in subsystem, such as any of the plug-in systems described herein. Similar to the Hardware sub-system, the Algorithm Sub-system supports a myriad of algorithms commonly used for machine learning. These algorithms are pre-packaged and configured with respective models and associated contexts. Therefore, many of these algorithms are pre-trained where required. However, it is not required that they be pre-trained but it is the preferred distribution of the algorithm. In this regard, FIG. 6 shows example algorithm modules IAlgorithim 608, IModel 612, IPayload 616, and IContext 620, including modules for determining which to apply to the inbound data payload (e.g., IContext).

FIG. 7 depicts a diagram 700 including functional modules of an IAlgorithm modules 708 of an algorithm sub-system 704. IAlgorithm 708 represents the universe of available algorithms applicable to machine learning. Initially, VOSAI comes pre-packaged with algorithms applicable to computer vision. Computer Scientists can develop their own algorithms and follow the VOSAI IAlgorithm interface. These algorithms ultimately make their way into the VOSAI platform once approved.

One should assume that a myriad of algorithms can be applied within this architecture. It may be a singular algorithm or a combination thereof, which is grouped together in a Concrete Algorithm 712 implementation within the VOSAI Learner. For example, should a proposed algorithm require common computer vision techniques like using SIFT or SURF, then these would be modularly plugged into the IAlgorithm construct. This would allow the author of the plugin to reference third party libraries supporting their algorithm. An example of a third-party library may include OpenCV, numpy, scikit-learn or sympy. VOSAI currently does not restrict the libraries that may be imported for algorithms. However, we do restrict calling out to online web services. This is not only a potential security risk but would cause latency in the network.

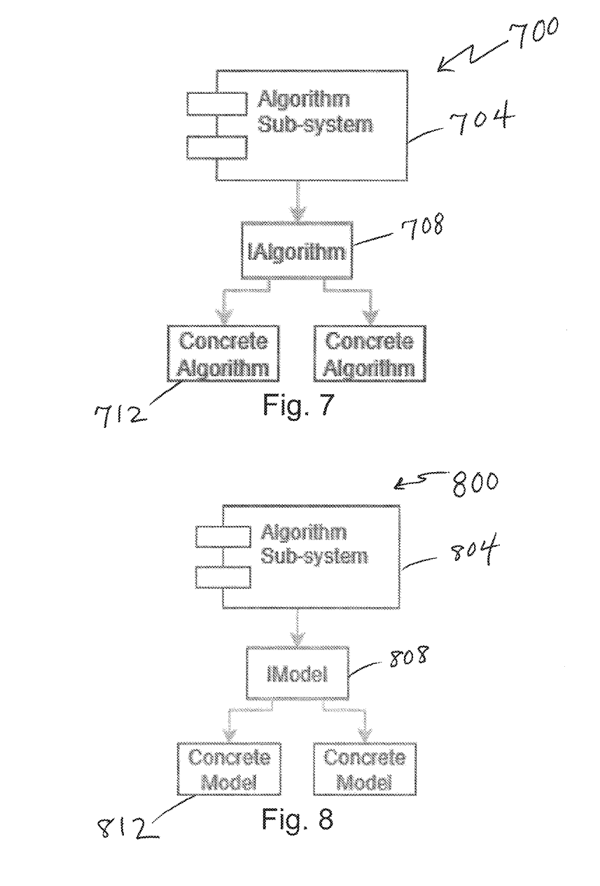

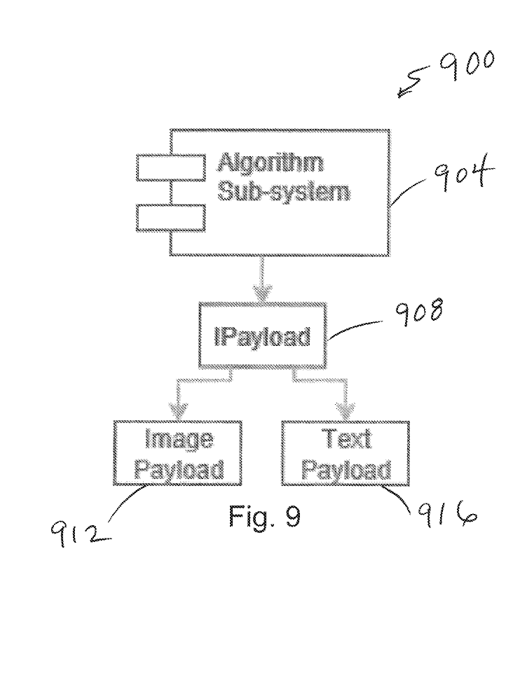

FIG. 8 depicts a diagram 800 including functional modules of an IModel module 808 of an algorithm sub-system 804. IModel 808 represents the results of learning by miners. IAlgorithm is applied to a given payload and context. The resultant of this effort is an IModel 808. Therefore, you can assume when a miner is in the act of learning they are actually creating models for the payload and algorithms applied.

FIG. 9 depicts a diagram 900 including functional modules of an IPayload module 908 of an algorithm sub-system 904. When it comes to IPayload 908 this refers to the media types supported by the VOSAI platform. This is forever extensible in that infinite many payload types can be applied to this process. Initially, upon release of the VOSAI platform, the system supports Image payloads 912 as this is the main focus on machine learning use cases identified.

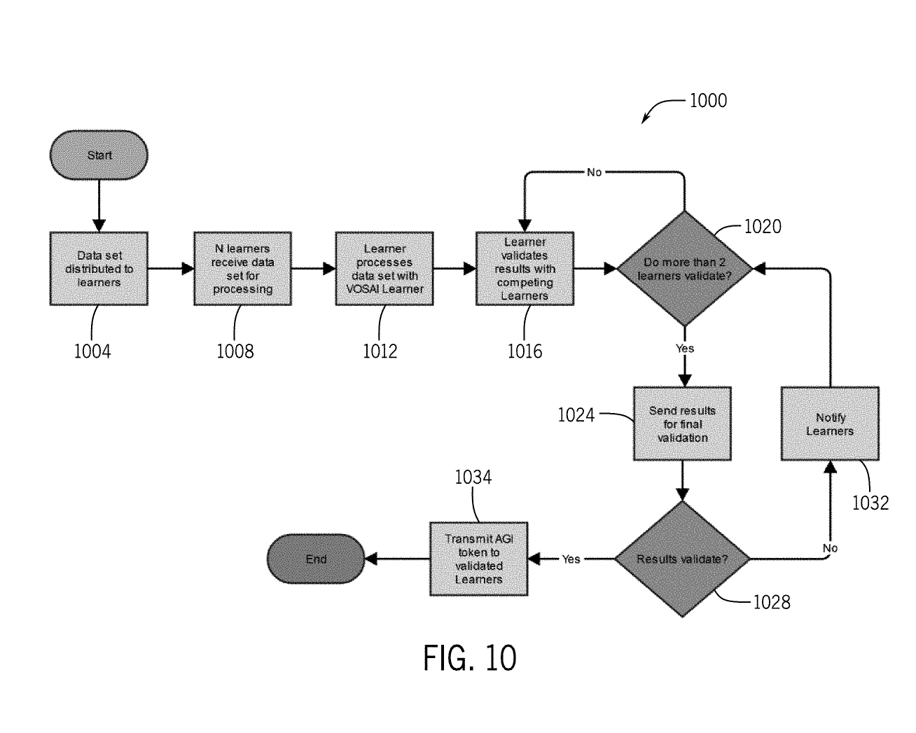

FIG. 10 depicts a flow chart 1000 illustrating a method of learning interactions with a community of learners. In particular, at step 1004 data can be distributed to learners. This could be media or other data types to be validated by the system. In step 1008 shown in FIG. 10, N learners can receive the data set for processing. This can be substantially any multiple of computers across a distributed network, also referred to herein as defining a community of learners. At step 1012, the community of learners can process the data set with the VOSAI learner. This can include, for example, generating hash values for various types of media. At step 1016, the learner application can validate results with competing learners. This can help the learners develop a community consensus or understand of the data to be learned. At step 1020, an assessment is made as to whether more than two learners validate the results. In the event that this condition is not satisfied, learning can continue until multiple learner validate

Once satisfied, at step 1024 the results are sent for final validation. This can take many forms, including having the results verified with respect to information stored on a chain and/or validation results from other users of the community. At step 1028, a final check is made in determining the validating of the results. In the event that this check is not satisfied, at step 1032, the learners are notified. Once verified, however, at step 1032, AGI tokens can be transmitted to validated learners.

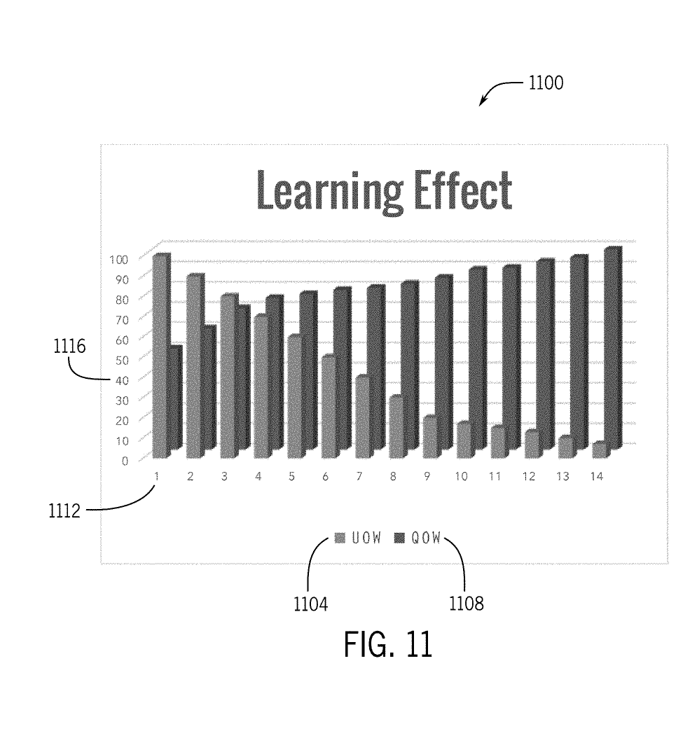

FIG. 11 depicts a graph 1100 illustrating unit of work 1104 and quality of work 1108 relative to time. UoW 1104 and QoW 1108 is plotted along a time axis 1112, with values of UoW 1104 and QoW 1108 ranging from 0 to 100 along a vertical axis 1116. A UoW 1104 may consider one or more of the following metrics to determine the overhead of work: processing unit time (e.g., CPU, GPU, TPU, DPU, Other), memory requirements, storage requirements, network requirements, and dataset size. The number of tokens required may be calculated by understanding the proper UoW 1104 for the given dataset, its resultant, and the quality. The learner may calculate the overhead of the UoW 1104 and validate the resultant with other learners to calculate the QoW 1108. Example equations are provided below.

$$cu = \frac{[ {\sum }_{i = 0}^{N} {CPU}_{i} [ {\sum }_{i = 0}^{M} {CORE}_{j} Use ] ]}{Δ T} \\ gu = \frac{[ {\sum }_{i = 0}^{N} {GPU}_{i} Use ]}{Δ T} + \frac{[ {\sum }_{i = 0}^{N} {GPU}_{i} Memory Use ]}{Δ T} \\ tu = \frac{[ {\sum }_{i = 0}^{N} {TPU}_{i} Use ]}{Δ T} + \frac{[ {\sum }_{i = 0}^{N} {TPU}_{i} Memory Use ]}{Δ T} \\ du = \frac{[ {\sum }_{i = 0}^{N} {DPU}_{i} Use ]}{Δ T} + \frac{[ {\sum }_{i = 0}^{N} {DPU}_{i} Memory Use ]}{Δ T} \\ … Additional PU if available … \\ mem = \frac{Memory Use}{Δ T} \\ nic = \frac{[ {NIC}_{input} dataset ]}{Δ T} + \frac{[ {NIC}_{output} POP ]}{Δ T} \\ UOW = cu + gu + w + du + … + mem + nic + kwk + O \\ where \text{:} \\ PU = processing unit \\ mem = memory for UOW \\ nic = network interforce card \\ dataset = training set \\ POP = Proof of Product \\ kwh = power consumption \\ O = overhead constant \\ Proof of Product is the result of work \\ Quality of work is validated proof of product \\ No . Tokens Required related to Qaw \text{/} UaW \qquad Equations$$

The tokens required may vary based on its UoW 1104 and QoW 1108. As illustrated in FIG. 11, UoW 1104 may decrease and QoW 1108 may increase over time, ultimately driving innovation at the learner level. The graph in FIG. 11 illustrates a cycle which repeats itself as new contexts are found. X is a measure of arbitrary time, where Y is a measure of effort or quality on a scale from 1 to 100. Operators of learner can innovate hardware, software, and their respective configurations.

UoW 1104 may decrease over time as the context of the dataset becomes well known and heavily optimized. For example, hardware and/or software may improve, and/or the context may become specific and optimized, thereby decreasing UoW 1104 over time. As new context scenarios arise, the UoW 1104 may increase. For example, if AGI is classifying images of apples, then it will become easier over time as the AGI learns. However, UoW 1104 increases as soon as new context domains are found (e.g., classifying emotional states of people). At any given time there may be multiple contexts running through the world computer. For example, the AGI may be classifying images, sound, languages, and gases while contextualizing accordingly.

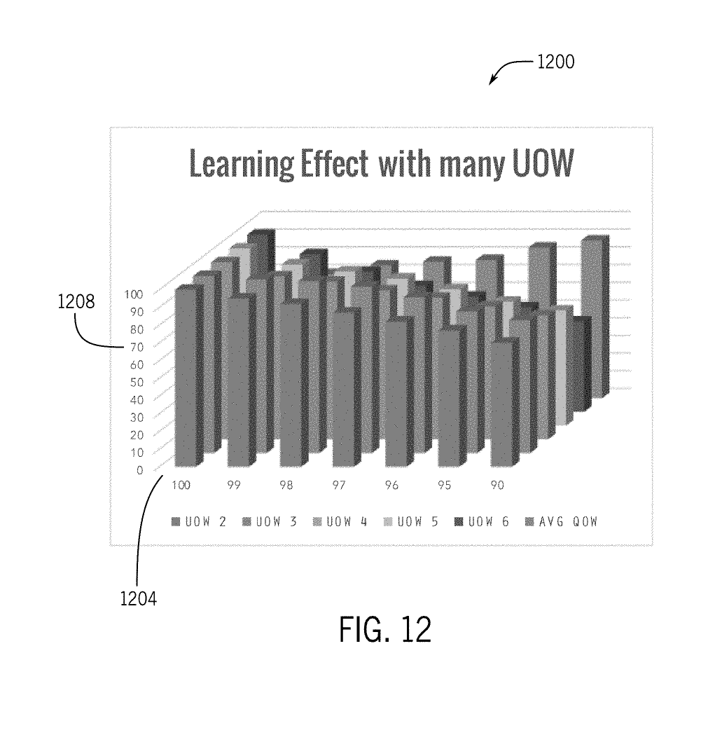

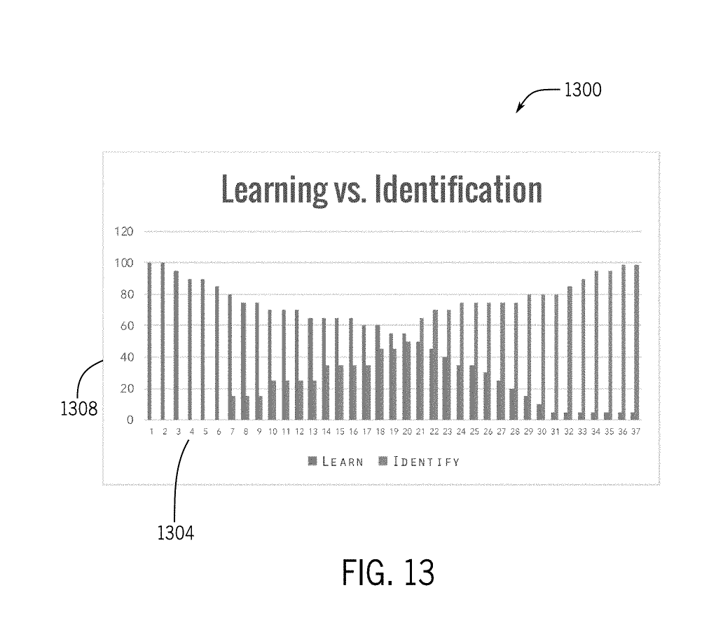

FIG. 12 illustrates how new context scenarios impact the average QoW relative to each UoW category, as shown in diagram 1200. As illustrated in the diagram 1200, different UoWs are decreasing over a time axis 1204, yet the average QoW rises, as a value of each are shown on the vertical axis 1208, ranging from 0 to 100. This may be cyclical in that it is expected to always have more to learn about in the world, ever driving the need for innovation and improvements within the AI evolution.

FIG. 13 illustrates a diagram 1300 showing the transition which will occur over time in regards to transitioning from learning to the process of identification. Identification is the process that happens after learning. The AGI first learns to classify contexts, then the AGI starts to identify the contexts. For example, the AGI first learns what an apple looks like, and then identifies apples in images. As a result of consuming datasets and learning over the datasets, hardware and software may be improved for learning processes and for identification using the learned results. This is shown in FIG. 13 with learning and identification plotted along a time axis 1304, with values of each represented along a vertical axis 1308.

In summary, regarding UoW and QoW, learners may be benchmarked according to their configuration (e.g., hardware/software). This benchmarking may result in a numeric value representing their configurations abilities. The better the numeric value for the learner the more they earn, and vice versa. In other words, the numeric value is how the network/system may qualify the learner configuration (e.g., the combination of hardware and software of their learning “rig”). The higher the number the more performance is achieved by the learners configuration. This can best be expressed by the following equation/algorithm, with the term “IQ” representing the numeric value.

$$IQ = \frac{QoW}{UoW} \\ UoW = \{ 1 , 2 , 3 , 4 , 5 , 6 , 7 , 8 , 9 , 10 \} \\ QoW = \{ 10 , 9 , 8 , 7 , 6 , 5 , 4 , 3 , 2 , 1 \} \qquad Equation$$

The lower the performance of the learner, the lower the IQ, and vice versa. The equation lists UoW and QoW as whole numbers ranging from 1 to 10 for simplicity sake. As previously discussed, learners (miners) are in control of their IQ and can improve their IQ by improving their hardware and/or software, for example.

Tokens can be distributed in a variety of manners throughout the network. The following table illustrates one example illustration of token distribution, according to key stakeholders interacting with the network. All categories below except for learners may have relative vesting schedules over the course of years. In other cases, other distributions are possible.

TABLE

| | |
|---|---|
| Total No. of Tokens | 4,200,000,000 |
| Learners (Miners) | 2,940,000,000 |
| Invectors | 630,000,000 |
| VOSAI | 630,000,000 |

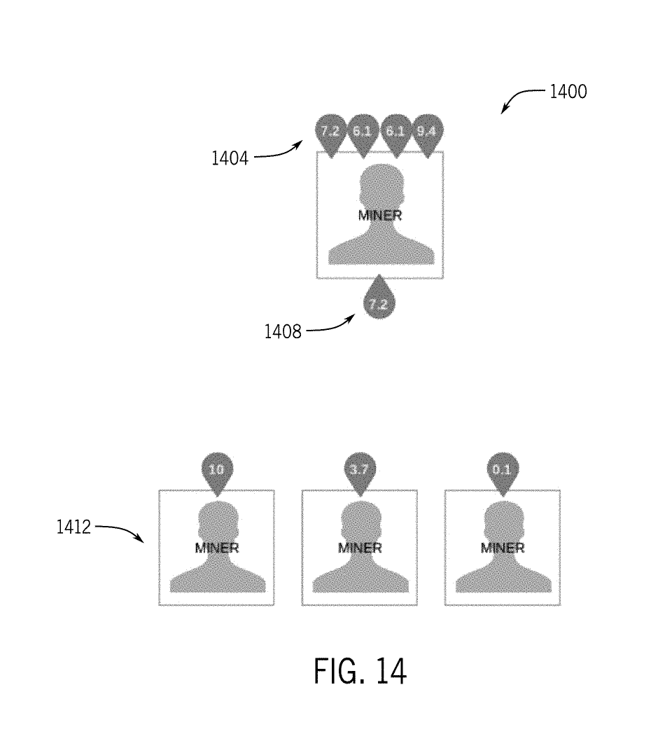

FIG. 14 depicts a diagram 1400 of a miner ranking system. As illustrated in FIG. 14, miners may receive various IQ scores 1404 which determine the earning potential of the rig (e.g., computing system) based on the function. For example, each miner may receive a learning IQ (earning potential for learning functions), an identification IQ (earning potential for identification functions), a utility IQ (earning potential for utility functions, e.g., merging, propagation), and a store IQ (earning potential for store functions, e.g., storing images). A primary or cumulative IQ 1408 may be generated from the individual IQ scores 1404 (e.g., an average of the individual IQ scores), and the cumulative IQ scores 1408 may be used to summarize the rig's earning potential. The IQ may be determined by a VOSAI learner (e.g., computer software application). The IQ may be on a scale from 0 to 10, for example, and the higher the IQ the more earning potential the rig has. The IQ may take into account Moore's law and Wirth Law ensuring innovation is constant. The cumulative IQ score 1408 can be used to rank different miners by earning potential, such as the ranking 1412 shown in FIG. 14.

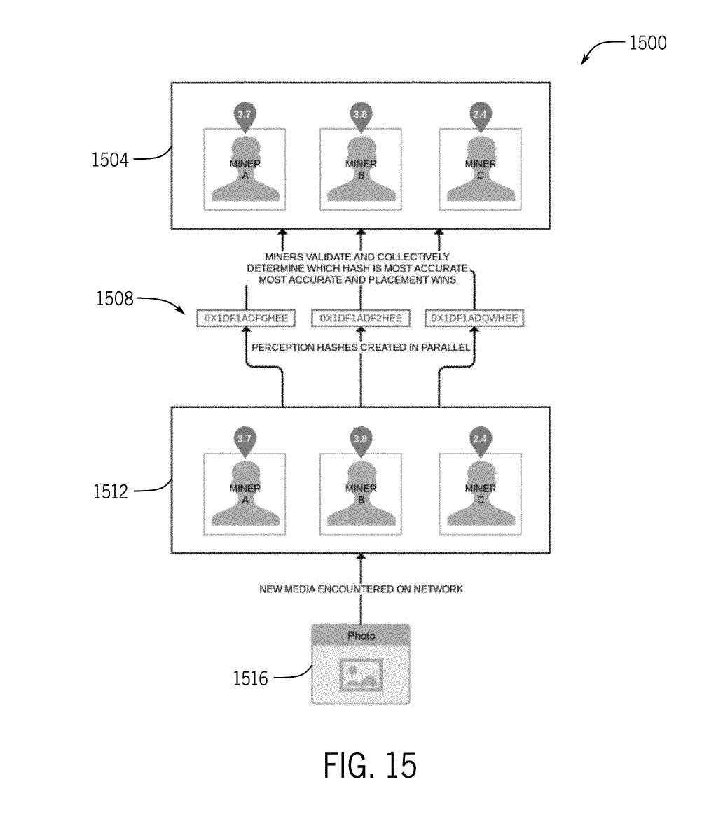

FIG. 15 illustrates a diagram 1500 of a mining (learning) process as new media is encountered on the network. When data gets presented to the network, the network picks the first miners 1504 that are available within a geographic proximity to that data and distributes the data to those miners who have been selected. Different types of miners (e.g., learning miners, propagation/merging miners, identification miners, etc.) may be selected. The miners may be rated according to their IQ, proximity, active status, backlog, and up-time, for example, and the network may pick miners based on their ratings. Alternatively, the data may be broadcast across the network for any miner to work on it. Once the miners receive the data, they began processing the data. The miners generate their hash codes and distribute the hash codes 1508 amongst themselves. Each miner ranks the hash codes 1508 and share their rankings. The miners collectively determine which hash code is most accurate, at functional block 1512, and the miners create the first block into the side chain for that particular piece of work, resulting at functional block 1516. The miners proceed with the merging and propagation process to place the hash code into the main chain. Then, payments are made to the miner who finished first and also the other miners that helped along the way, such as validating, ranking, propagating, and merging.

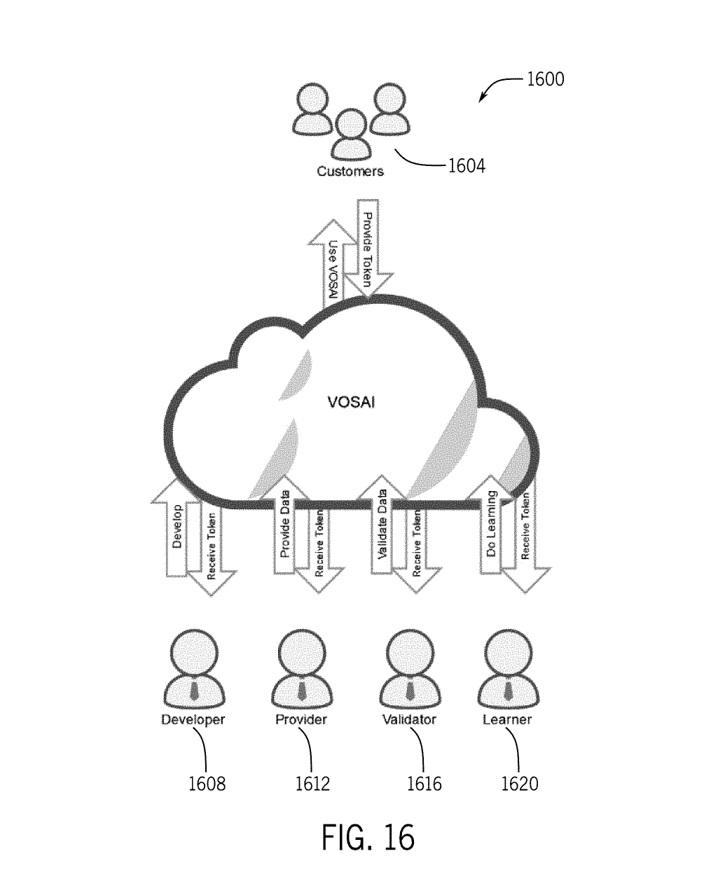

FIG. 16 depicts a simplified diagram 1600 illustrating interactions between customers 1604, developers 1608, providers 1612, validators 1616, and learners 1620. In particular, FIG. 16 shows the transaction of tokens through the VOSAI architecture among the customers 1604, developers 1608, providers 1612, validators 1616, and learners 1620, as is illustrated in greater detail below.

Blockchain Solution

The artificial intelligence network or system described herein may include a blockchain solution specific to AI which allows for complete transparency including access controls, privacy, scalability, open innovation, and continuous evolution.

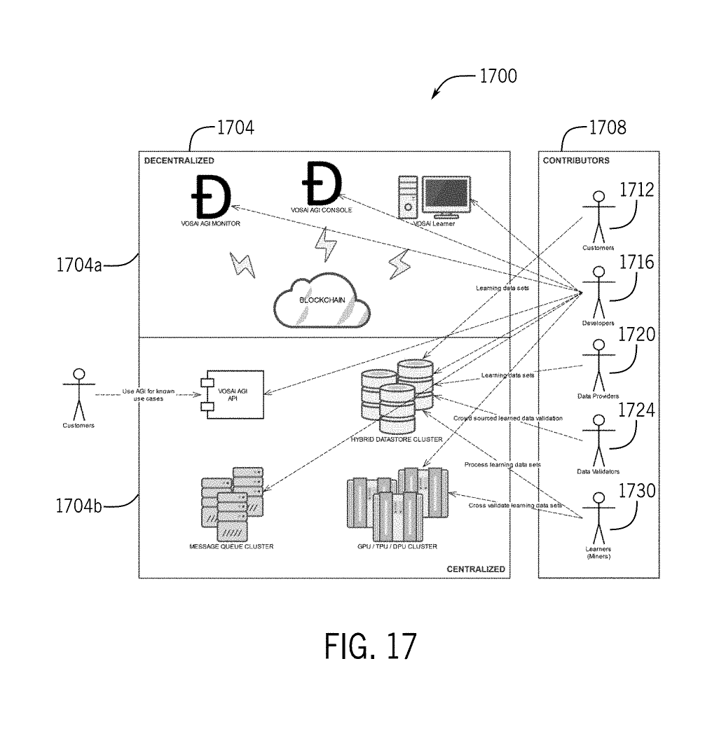

FIG. 17 is a simplified diagram 1700 illustrating interactions between an artificial intelligence network 1704 or system including a centralized portion 1704a, a decentralized 1704b portion, and outside actors 1708. In FIG. 17, customers 1712 both contribute to the AI system and use it for their businesses. In some embodiments, a customer contributes datasets for learning. For example, if the customer owns a call center, then the customer could provide recordings or transcribed conversations from their call center. In return for their contributions, customers may receive tokens for later use.

Developers 1716 may be all encompassing to describe those individuals involved with software development. Developers 1716 may include programmers, developers, architects, testers, and administrators. Developers 1716 may contribute code, test scripts, content, graphics, or datasets for learning. In return for their contributions, developers 1716 may receive tokens for later use.

Data providers 1720 may provide datasets for learning. Data providers 1720 may receive tokens for their contributions when they provide datasets which are not already in the system, for example, in some embodiments, a data provider 1720 could be a future customer.

Data validators 1724 may be used to validate datasets. Data validators 1724 optionally validate datasets which have already gone through the entire cycle of learning, since the learning process itself performs validation. Data validators 1724 may ensure proper performance of the system. Over time, the data validators 1724 may randomly spot check datasets. Data validators 1724 may be crowd sourced. Validation may be automated and completely decentralized without the need for crowd sourcing.

A learner 1730 may be equivalent to a miner in the blockchain world, but their work is different. Learners 1730 may download learner software (e.g. VOSAI Learner) and make their hardware available for learning requests on datasets. Their hardware may be benchmarked in order to determine their overhead for a unit of work. Learners 1730 may be provided tokens for processing learning datasets.

The high level processing of learning over a set of learners is as follows: M learners are given the same learning dataset, all learners race to complete the learning dataset, at least N (where N<M) learners must validate their work with each other, upon success the validated learners receive tokens, and remaining learners do not receive tokens. The processing incentivizes learners to keep up with the latest hardware for machine learning. Furthermore, the processing drives the learners to better configurations and improved algorithm development.

The centralized infrastructure does not compete for work with the learners on the network. The purpose of the centralized infrastructure will be discussed in more detail later. For the context herein, the centralized infrastructure may be useful for validation and central hybrid data stores. The centralized infrastructure may be completely decentralized over time.

At least one token (e.g., VOSAI token) or other type of consideration may be used throughout the system for processing requests from clients/customers and handled by the network and learners. The token may be leveraged in various markets. For example, there may be a primary market used for interactions with the system (e.g. VOSAI) and its respective subsystems/components. In some embodiments, there may be a buy/sell market for the tokens. For example, the tokens may be sold and exchanged publicly between learners, investors, and clients of the system. The price of the tokens may be dictated by market values and/or volume. The tokens may be sold either directly between parties or through public exchanges. The market may use existing blockchains like Ethereum for exchanging the tokens for ETH, for example.

Additionally or alternatively to a buy/sell market, there may be a usage market for the tokens. The tokens may be required for accessing the system/network. The required tokens for a particular transaction may be dependent on unit or work (UoW) and quality of work (QoW) for the request/response tuple, as further explained later. The usage market may use blockchain (e.g. PATHWAY blockchain) for its transactions which are AGI based, rather than currency based.

The token may be based on two primary concepts—a unit of work (UoW) and the quality of that work (QoW). A unit of work (UoW) represents how much work is required to learn a given dataset on a learner. In order to make a request against the AI system/network, consumers must have sufficient tokens to process their request. In turn, learners are given tokens for processing learning datasets. Like learners, contributors are given tokens for contributing to the project. Their contributions come in the form of submitting learning datasets, validation learned datasets, and developing for the project.

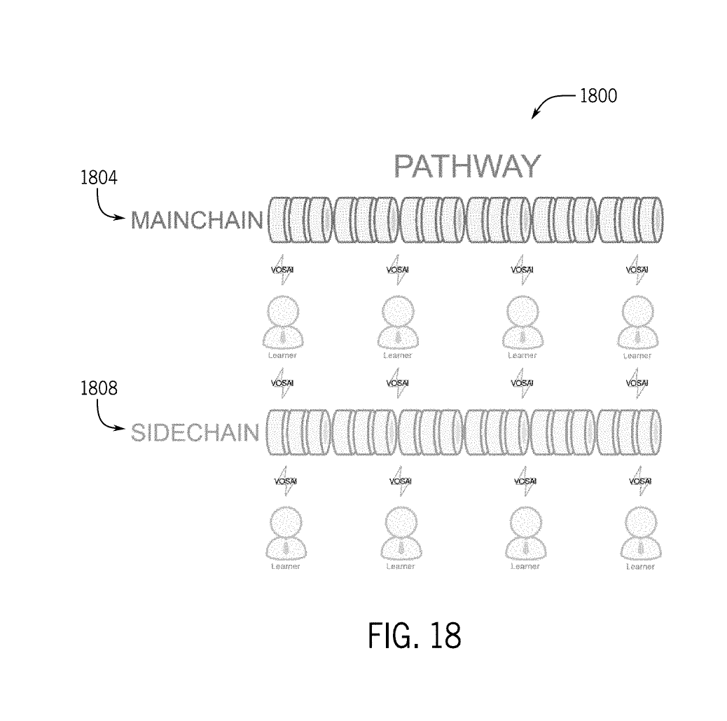

FIG. 18 provides a high-level view of the VOSAI Pathway blockchain 1800. The blockchain 1800 is comprised of at least two chains (e.g. a main-chain 1804 and a side-chain 1808). The main-chain 1804 serves as final storage with less transactions than the side-chain 1808. The one or more side-chains 1808 are where learners store the results of learning including both negative and positive results from the learning. For example, if a set of images represents apples which need to be contextualized, learners may use computer vision/machine learning algorithms to classify these images. This set of images may or may not have apples within them. The learners start learning and training against these sets of images until a consensus is met amongst the learners that a subset of these images is in fact classified as apples. These become committed to the side-chain 1808 as well as those images that are not considered apples. It is at this point that the learners propagate the information back to the main-chain 1804. Any context that makes its way to the main-chain 1804 is considered to be a learned concrete fact and not open for interpretation.

The actual image is not stored on the blockchain, but rather details identifying the image is stored on the blockchain. More specifically, a unique hash is created for every image. This unique hash allows the system to perform image comparisons at the hash level only, which allows the blockchain to be free from storing the actual content. Since this hash is unique, it can be used on the blockchain to describe an entry much like other blockchains. The difference here is that the hash code generated in other blockchains is randomly generated until it finds one that fits, whereas on the Pathway blockchain the hash is unique and forever unique, according to some embodiments. Further, the hash is not randomly generated, but is based on the type of media and other related data regarding the media. i.e. the hash is descriptive of the underlying media. Therefore, if the same duplicate image passes through the VOSAI system it would not be placed onto the Pathway blockchain since it has already been presented to the system. The same logic applied to images also applies to languages, audio, and environmental data should they become a part of the learning data set.

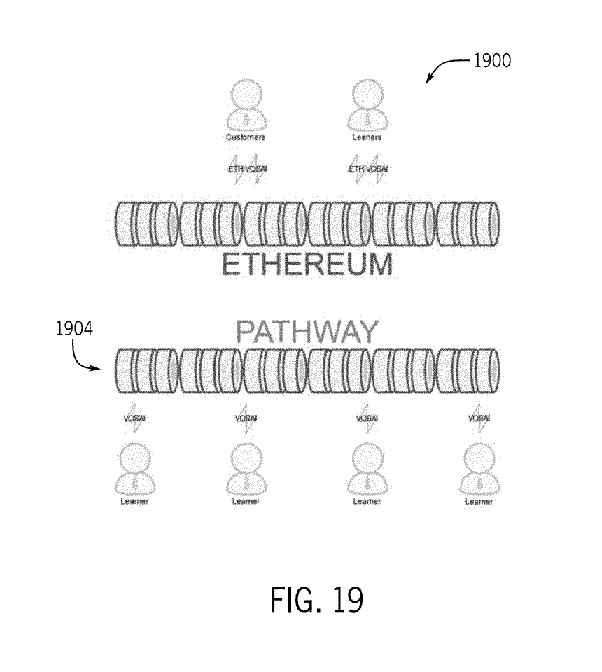

In FIG. 19, customers use the Ethereum network 1900 to purchase tokens (e.g. VOSAI tokens) through either public exchanges or directly from learners/third parties in possession of the tokens. Such tokens can then be used with the PATHWAY blockchain 1904. The system can switch to another network if need be provided it supports the exchange of VOSAI tokens. Learners interact with the blockchain to perform their learning. In return for their work, learners receive tokens according to the IQ of the relative “rig” associated with that UoW and QoW. Therefore, some learners may have more or less earning potential than their peers. Learners can then exchange their tokens on public exchanges and networks where VOSAI is supported (e.g., Ethereum).

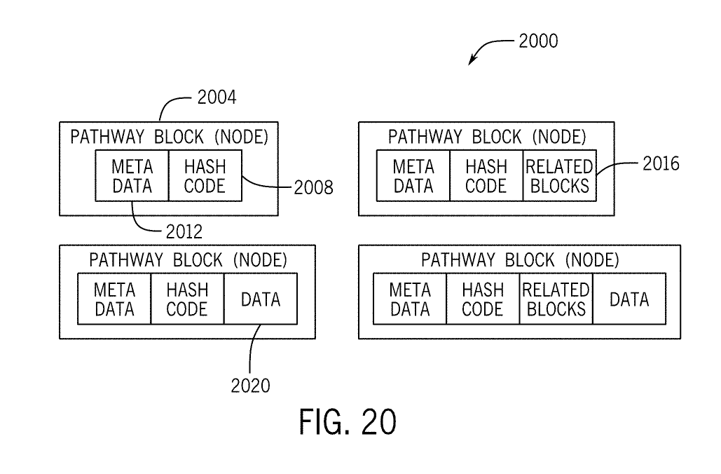

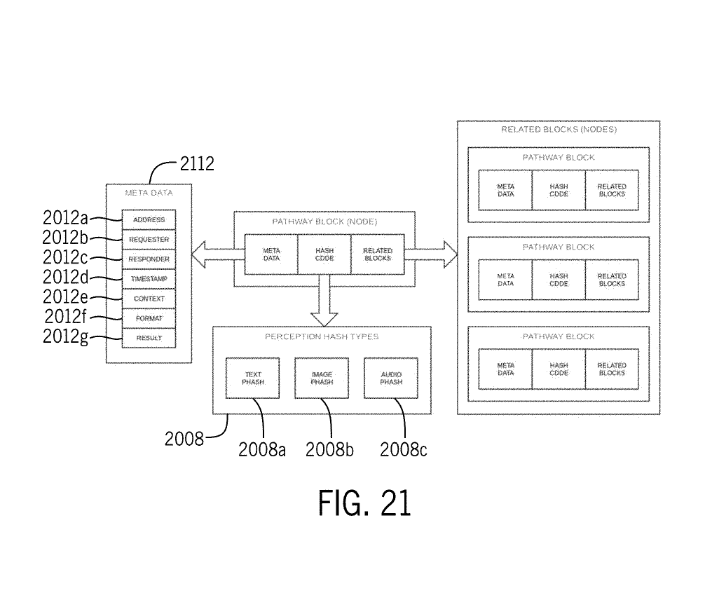

FIG. 20 depicts a diagram 2000 illustrating various blocks that could be used in the blockchain. The blockchain may include various blocks, which may include various types of data. For example, four variants of nodes 2004 that may be on the chain are illustrated in FIG. 20. Each node may include a hash code block 2008 and metadata block 2012, which may include metadata related to the node itself. The metadata block 2012 may include various types of data. For example, as illustrated in FIG. 21, the metadata block may include address data 2012a, requester data 2012b, responder data 2012c, time stamp data 2012d, context data 2012e, format data 2012f, and result data 2012g. The address data 2012a, requester data 2012b, and responder data 2012c may include an alphanumeric user identification, for example. The context data 2012e may include a variable string. The format data 2012f may indicate what kind of format the original data was in, such as an image, audio, text, or another format. The result data 2012g may indicate whether the system identified the input as positive, negative, or neutral. For example, during training, pictures may be fed into the system, and the system attempts to identify which pictures are of apples. Pictures that the system identifies as including apples may be recorded as positive, pictures that system identifies as not including apples may be recorded as negative, and pictures that the system cannot identify may be recorded as neutral.

Each node may include the hash code block 2008. The hash code block 2008 may include contextual hash or perception hash, for example. As illustrated in FIG. 21, perception hash may include text perception hash 2008a, an image perception hash 2008b, and/or an audio perception hash 2008c, and/or any other format related to or derived from the perception. The types of perception hash may be used within the blockchain, and each type of perception hash may be determined based on the context. The perception hash allows comparisons between hashes of similar context.

Some nodes may include a related block 2016. The related block 2016 may include arrays, lists, or graphs of related nodes, as illustrated in FIG. 21. The nodes may be related in many ways. In some embodiments, the related nodes may be context specific. For example, if one node has a picture of an apple, then that node is related to another node with a picture of an apple and yet another node with a picture of an apple tree.

Some nodes may include a data block 2020. The data block 2020 may store data in the block itself. The data may include various types of data. For example, the data may be related to what the AI system has learned. The data may include hash code. Depending on the circumstance, one or all of the example nodes illustrated in FIG. 20 may be used.

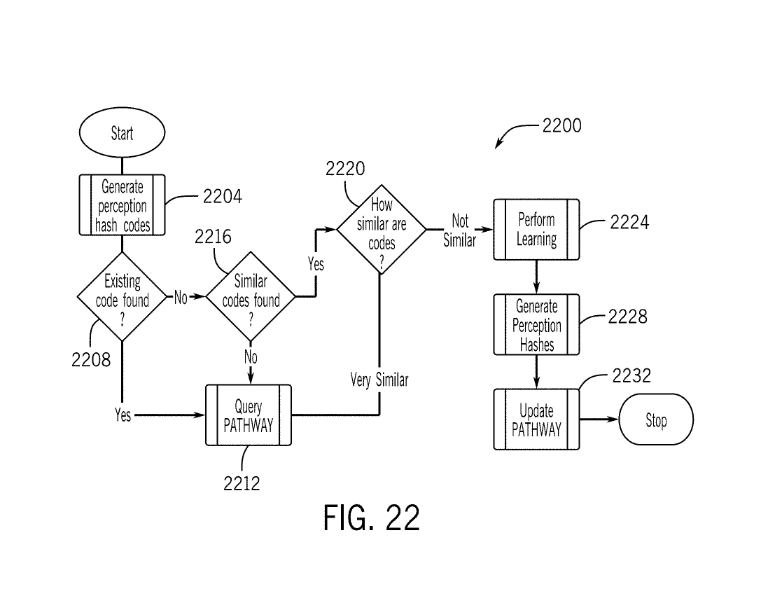

FIG. 22 depicts a flow chart 2200 illustrating logic for generating a hash code and appending the code to a blockchain. Perception hashes are at the core of the VOSAI system and replace cryptographic hash codes. These perception hashes not only apply to machine learning but also any sector and/or industry requiring the storing of information on chain. This eliminates the needs for larger data sets and addresses multiple “big data” problems.

Perceptual hashing is the use of an algorithm that produces a snippet or fingerprint of various forms of multimedia. Perceptual hash functions are analogous if features are similar, whereas cryptographic hashing relies on the avalanche effect of a small change in input value creating a drastic change in output value. Perceptual hash functions are widely used in finding cases of online copyright infringement as well as in digital forensics because of the ability to have a correlation between hashes so similar data can be found. For example, a publisher could maintain a database of text hashes of popular online books or articles for which the authors hold copyrights to, anytime a user uploads an online book or article that has a copyright, the hashes will be almost exactly the same and could be flagged as plagiarism. This same flagging system can be used for any multimedia or text file.

Perception hash codes reduce the footprint of data as well as allow the data to be compared without having the original data sets. In other words, perception hash codes are comparable to each other and can indicate the variance between two data sets represented by their respective perception hash codes while reducing the monumental data sizes that may accompany the original data. Perception hash codes have been extensively used across many facets of Computer Science. As such, there has been a small but substantial effort made in the space in regards to existing algorithms.

The following algorithms exist in the space of perception hashing. Of which each was analyzed and prototyped to validate our thesis.

1. Perceptual Hashing Algorithm

a. Finger printing of media files derived from features of its content

2. aHash

a. Average Hash

b. Simple perceptual hash

c. Ideal for finding similar images

d. Quick and easy to use

e. Fastest algorithm

f. Very rigid

3. pHash

a. Perceptive Hash

b. More robust than aHash

c. Most accurate of algorithms

d. Discrete Cosine Transform (DCT)

e. Leverages DCT for reducing frequencies

4. dHash

a. Difference Hash

b. More accurate than others

c. Nearly identical to aHash

d. Outperforms aHash

e. Use if speed and accuracy are required

In conjunction with perception hash codes, the use of comparison algorithms over these hash codes is required. These are often times specific to the given hashing algorithms. Therefore, they go hand and hand. With hashing comparison, one can perform equality checks and hamming distances between two given perception hashes. These operations serve as a comparison on the original data and what the deviation of the data sets may be.

It will be appreciated that the foregoing are presented as sample perception hash algorithms. In other cases, other perception hash algorithms may be used, including those for video, audio, or other raw data.

Moreover, these hash codes are used as a replacement to cryptographic hash codes within PATHWAY. This ensures that duplicate information is reduced or ultimately eliminated from the equation. For example, should PATHWAY contain significant amount of data which represents what an APPLE (the fruit) looks like for every possible angle, size and color then this data would no longer be added to PATHWAY. Instead, if new data is presented to be learned it is first validated against PATHWAY to ensure it was not previously learned upon. The initial release of VOSAI will leverage widely adopted hash code algorithms at it applies to image classification, identification, and contextualization.

In this regard, the diagram 2200 illustrates the logic behind generating hash codes and appending to PATHWAY. In the sample of diagram 220, at step 2204, perception hash codes can be generated. For example, perception hash codes can be generated according to another of the methods described hereinabove. At step 2208, the hash code can be evaluated in order to determine if existing hash code is found. If so, at step 2212, the PATHWAY chain can be queried. However, if the hash code analyzed is found to not have existing code, at step 2216, an analysis can be performed to determine is similar hash codes are found. In the event that similar hash codes are not found, again at step 2212, the PATHWAY chain can be queried. However, if the hash code is found to have similarities with those of the system, the hash code can be further analyzed to determine the extent of the similarity, at step 2220. If a high level of similarity exists, again at step 2212 the PATHWAY chain can be queried.

In the event that the hash codes are determined to not be very similar, at step 2224, a learning process can be initiated, such as any of the learning processes described herein. Upon completion of learning, at step 2228 perception hash codes can be generated, for example, according to any of the techniques described herein. Finally, at step 2232, the results of the learning can be appended to the PATHWAY chain, and used for subsequent analysis of queries.

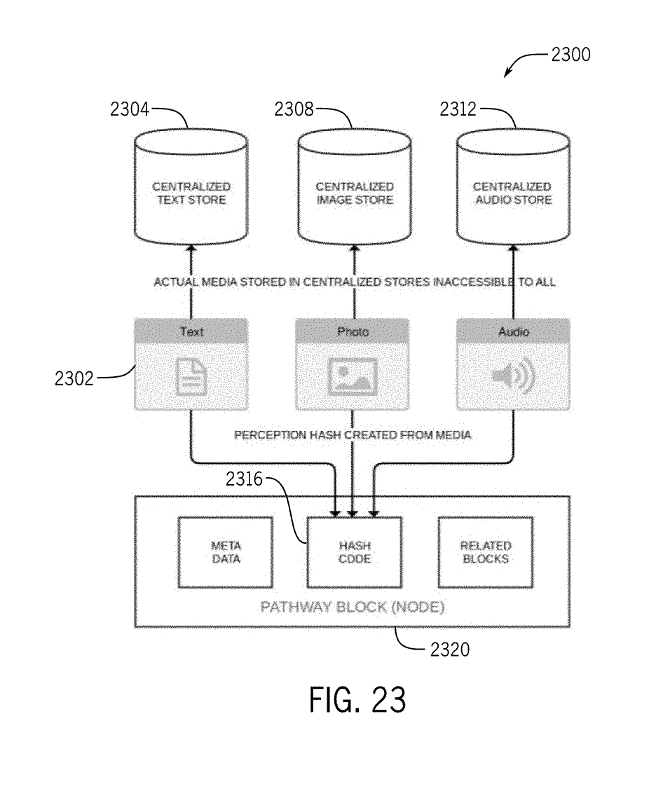

FIG. 23 illustrates a diagram 2300 of hashing and the processing of the media. Referring to FIG. 23, when media comes into the network, the media is not stored on the chain itself. Instead, only the hashes are stored on the blockchain. For example, in FIG. 23, perception hash 2302 is created from text media 2304, photo media 2308, and/or audio media 2312, and the perception hash 2302 is stored in a hash code block 2316 on a node 2320 of the blockchain. Perception hash (PHASH) is a special hash that can be compared and is descriptive of the underlying media. For example, if two hashes of apples exist, then you can compare the hash code to detect similarity of the image without using the image. The media represented by a PHASH is not reverse engineerable, allowing privacy and security to remain intact and allows blocks to be free from the actual media (i.e. the PHASH separates the description from the content). The raw media is stored in a centralized data store that is inaccessible and only is used to improve the AGI. In other words, the actual media or information is not accessible to the outside world and may not be shared or sold. As illustrated in FIG. 23, the text, photo, and audio media may be stored in centralized text, image, and audio stores, respectively. Alternatively, the raw media may be stored in a decentralized infrastructure, such as decentralized databases.

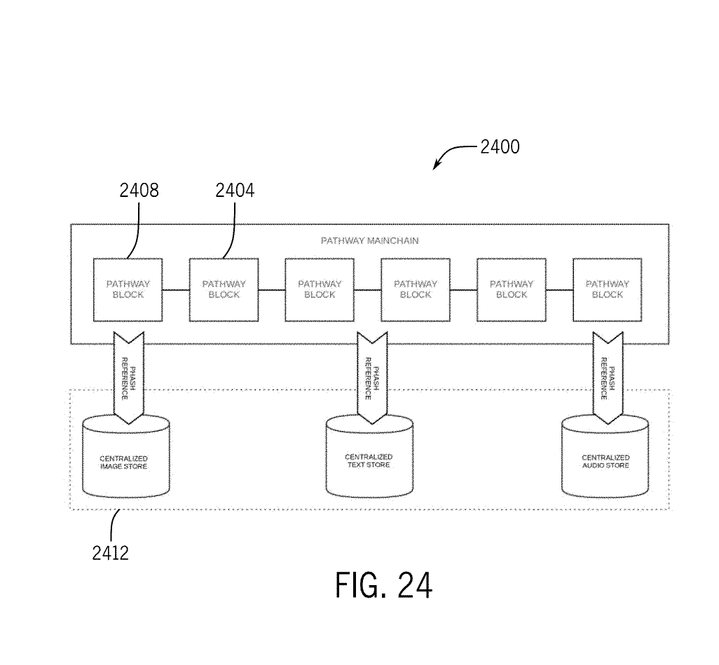

FIG. 24 illustrates a diagram 2400 of a mainchain 2404 of the blockchain with many nodes 2408 (pathway blocks). Media 2412 is stored in separate centralized stores based on its type. For example, actual images may be stored off-chain in a centralized image store, which may be decentralized in some embodiments. Actual text may be stored off-chain in a centralized text store, which may be decentralized in some embodiments. Actual audio may be stored in a centralized audio store, which may be decentralized in some embodiments. The actual images, text, and audio is not accessible to the outside world, nor is it shared or sold. As illustrated in FIG. 24, PHASH references may have been created from the actual media before it is stored, and the PHASH references may be stored in respective nodes on the mainchain.

Perception Hash is the underlying mechanism for much of the platform. The intent of this section is defined changes to machine learning that impact the industry across the board including both hardware and software components related to machine learning. To date, most of machine learning is applied over the original data and much of the work that goes into this is the process of fitting data to an algorithm to train a model and reuse for a later date. Original data typically needs to be transferred to a platform like ours over a network, then stored on a storage device, then distributed between servers and processing units (e.g., CPU, GPU) and processed accordingly. All this is work in transferring information is wasteful.

The use of perception hash allows original data size to shrink by at most 99% of its original size. Rather than the use of original data, which is often in the gigabytes or terabytes, we propose to replace the need for original data by creating perception hashes of the original information. At first glance, this may not seem impactful. But, by removing the large data sets of original information, we can now perform the same machine learning processes on the smallest of devices including mobile devices. This ultimately lowers the time to process data, while the required storage and memory is drastically reduced by at most 99%. Lastly, the power of a processing unit can be drastically lower and not as specialized as prior approaches. Therefore, a simple ARM based CPU can readily perform machine learning and perform similarity to current day approaches.

Specific perception hashes are contemplated and described herein. Recall, that a perception hash is nothing more than a factual representation—better said—fingerprint of the original data. These fingerprints extract that most relevant information to properly represent the entire set of original data. These perception hashes to be developed include the following specific classifications/categories/uses:

Below is a table representing an example of an object perception hash:

OP-HASH STRING
Size Range = 13 bytes to 8544 bytes

| POS | NAME | LEN | TYPE | VALUE |
|---|---|---|---|---|
| 0 | <MEDIA> | 3 | Char | IMG |
| 1 | <FORMAT> | 4 | String | GIF, PNG, JPG, |
| | | | | TGA, BMP, TIF |
| 2 | <COLOR> | 4 | String | RGB, BW, |
| | | | | GREY, CMYK |
| 3 | <NO OF | 2 | Integer | 00 to 99 |
| | SHAPES> | | | |
| 4 | <SHAPE 1 | 32 | String | Alpha numeric (a-z, |
| | NAME> | | | A-Z, 0-9) |
| 5 | <SHAPE 1 X> | 5 | Integer | 00000 to 99999 |
| 6 | <SHAPE 1 Y> | 5 | Integer | 00000 to 99999 |
| 7 | <SHAPE 1 | 4 | Integer | 00000 to 99999 |
| | WIDTH> | | | |
| 8 | <SHAPE 1 | 4 | Integer | 00000 to 99999 |
| | HEIGHT> | | | |
| 9 | <SHAPE 1 | 9 | String | R = NNN, B = |
| | RGB> | | | NNN, G = NNN |
| | | | | Red Value, Blue |
| | | | | Value, Green |
| | | | | Value |
| 10 | <SHAPE 1 | 32 | String | Alpha numeric (a-z, |
| | CLASSIFIER> | | | A-Z, 0-9) |
| 11 | <SHAPE 1 | 32 | String | Alpha numeric (a-z, |
| | QUALIFIER> | | | A-Z, 0-9) |
| 12 | <SHAPE 1 | 144 | String | Alpha numeric (a-z, |
| | PERCEPTION> | | | A-Z, 0-9) |

SUPPORT 32 SHAPES

| | | | | |
|---|---|---|---|---|
| N | <SHAPE N | 32 | String | Alpha numeric (a-z, |
| | NAME> | | | A-Z, 0-9) |
| N + 1 | <SHAPE N X> | 5 | Integer | 00000 to 99999 |
| N + 2 | <SHAPE N Y> | 5 | Integer | 00000 to 99999 |
| N + 3 | <SHAPE N | 4 | Integer | 00000 to 99999 |
| | WIDTH> | | | |
| N + 4 | <SHAPE N | 4 | Integer | 00000 to 99999 |
| | HEIGHT> | | | |
| N + 5 | <SHAPE N | 9 | String | R = NNN, B = |
| | RGB> | | | NNN, G = NNN |
| | | | | Red Value, Blue |
| | | | | Value, Green |
| | | | | Value |
| N + 6 | <SHAPE N | 32 | String | Alpha numeric (a-z, |
| | CLASSIFIER> | | | A-Z, 0-9) |
| N + 7 | <SHAPE N | 32 | String | Alpha numeric (a-z, |
| | QUALIFIER> | | | A-Z, 0-9) |
| N + 8 | <SHAPE 1 | 144 | String | Alpha numeric (a-z, |
| | PERCEPTION> | | | A-Z, 0-9) |

Below is a table representing an example of a face perception hash:

FP-HASH STRING
Size Range = 13 bytes to 10221 bytes

| POS | NAME | LEN | TYPE | VALUE |
|---|---|---|---|---|
| 0 | <MEDIA> | 3 | String | IMG |
| 1 | <FORMAT> | 4 | String | GIF, PNG, JPG, |
| | | | | TGA, BMP, TIF |
| 2 | <COLOR> | 4 | String | RGB, BW, |
| | | | | GREY, CMYK |
| 3 | <NO OF | 2 | Integer | 00 to 99 |
| | FACES> | | | |
| 4 | <FACE 1 | 32 | String | Alpha numeric |
| | NAME> | | | (a-z, A-Z, 0-9) |
| 5 | <FACE 1 X> | 5 | Integer | 00000 to 99999 |
| 6 | <FACE 1 Y> | 5 | Integer | 00000 to 99999 |
| 7 | <FACE 1 | 4 | Integer | 00000 to 99999 |
| | WIDTH> | | | |
| 8 | <FACE 1 | 4 | Integer | 00000 to 99999 |
| | HEIGHT> | | | |
| 9 | <FACE 1 | 9 | String | R = NNN, B = |
| | RGB> | | | NNN, G = NNN |
| | | | | Red Value, Blue |
| | | | | Value, Green |
| | | | | Value |
| 10 | <FACE 1 | 32 | String | Alpha numeric |
| | CLASSIFIER> | | | (a-z, A-Z, 0-9) |
| 11 | <FACE 1 | 32 | String | Alpha numeric |
| | QUALIFIER> | | | (a-z, A-Z, 0-9) |
| 12 | <FACE 1 | 144 | String | Alpha numeric |
| | PERCEPTION> | | | (a-z, A-Z, 0-9) |
| 13 | <FACE 1 SEX> | 1 | String | M = Male, F = |
| | | | | Female, H = |
| | | | | Both, O = Other, |
| | | | | N = Neutral |
| 14 | <FACE 1 | 21 | String | A = Asian, B = |
| | DIVERSITY> | | | Black, E = |
| | | | | European, H = |
| | | | | Hispanic, L = |
| | | | | Latin, W = |
| | | | | White, O = Other - |
| | | | | followed by 2 |
| | | | | char digits after |
| | | | | each for |
| | | | | probability |
| 15 | <FACE 1 | 3 | Integer | 000 to 999 |
| | AGE> | | | |
| 16 | <FACE 1 | 18 | String | A = Anger, D = |
| | EMOTION> | | | Disgust, F = |
| | | | | Fear, J = Joy, S = |
| | | | | Sadness, R = |
| | | | | Surprise - |
| | | | | followed by 2 |
| | | | | char digits after |
| | | | | each for |
| | | | | probability |
| 17 | <FACE 1 | 9 | String | P = Positive, N = |
| | SENTIMENT> | | | Negative, U = |
| | | | | Neutral - |
| | | | | followed by 2 |
| | | | | char digits after |
| | | | | each for |
| | | | | probability |

SUPPORT 32 FACES

| | | | | |
|---|---|---|---|---|
| N | <FACE N | 32 | String | Alpha numeric |
| | NAME> | | | (a-z, A-Z, 0-9) |
| N + 1 | <FACE N X> | 5 | Integer | 00000 to 99999 |
| N + 2 | <FACE N Y> | 5 | Integer | 00000 to 99999 |
| N + 3 | <FACE N | 4 | Integer | 00000 to 99999 |
| | WIDTH> | | | |
| N + 4 | <FACE N | 4 | Integer | 00000 to 99999 |
| | HEIGHT> | | | |
| N + 5 | <FACE N | 9 | String | R = NNN, B = |
| | RGB> | | | NNN, G = NNN |
| | | | | Red Value, Blue |
| | | | | Value, Green |
| | | | | Value |
| N + 6 | <FACE N | 32 | String | Alpha numeric |
| | CLASSIFIER> | | | (a-z, A-Z, 0-9) |
| N + 7 | <FACE N | 32 | String | Alpha numeric |
| | QUALIFIER> | | | (a-z, A-Z, 0-9) |
| N + 8 | <FACE N | 144 | String | Alpha numeric |
| | PERCEPTION> | | | (a-z, A-Z, 0-9) |
| N + 9 | <FACE N | 1 | Char | M = Male, F = |
| | SEX> | | | Female, H = |
| | | | | Both, O = Other, |
| | | | | N = Neutral |
| N + 10 | <FACE N | 21 | String | A = Asian, B = |
| | DIVERSITY> | | | Black, E = |
| | | | | European, H = |
| | | | | Hispanic, L = |
| | | | | Latin, W = |
| | | | | White, O = Other - |
| | | | | followed by 2 |
| | | | | char digits after |
| | | | | each for |
| | | | | probability |
| N + 11 | <FACE N | 3 | Integer | 000 to 999 |
| | AGE> | | | |
| N + 12 | <FACE N | 18 | String | A = Anger, D = |
| | EMOTION> | | | Disgust, F = |
| | | | | Fear, J = Joy, S = |
| | | | | Sadness, R = |
| | | | | Surprise - |
| | | | | followed by 2 |
| | | | | char digits after |
| | | | | each for |
| | | | | probability |
| N + 13 | <FACE N | 9 | String | P = Positive, N = |
| | SENTIMENT> | | | Negative, U = |
| | | | | Neutral - |
| | | | | followed by 2 |
| | | | | char digits after |
| | | | | each for |
| | | | | probability |

Other hash examples, include sound perception hash, speech perception hash, video perception hash, identity perception hash, tabulated data perception hash, contemplated herein with the scope of the present disclosure.

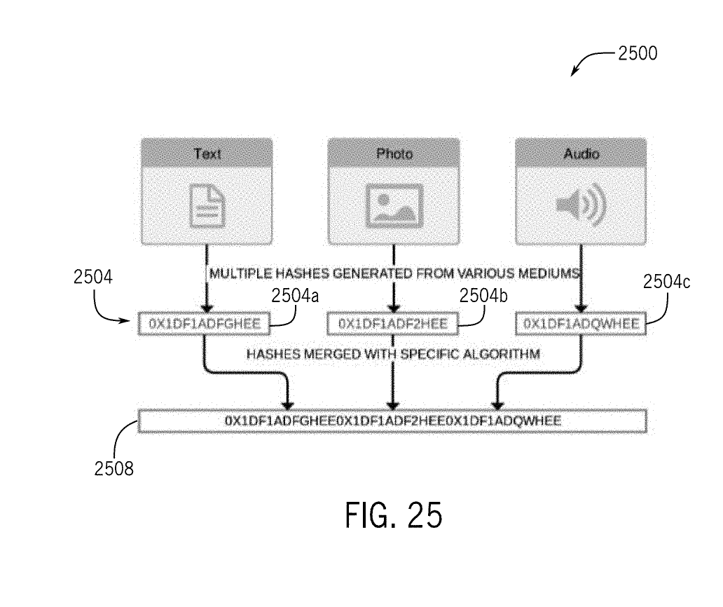

FIG. 25 depicts a diagram 2500 illustrating a process of creating a context hash code, such as a contextual perception hash. The process is similar to the perception hash, except the contextual perception hash is the merger of multiple perception hashes. The resultant contextual perception hash may allow for context comparison. As illustrated in FIG. 25, multiple perception hashes 2504 may be generated from various mediums, such as text, photo, and audio. In this regard, FIG. 25 shows a text perception hash 2504a, a photo perception hash 2504b, and an audio perception hash, each generated from the respective media file stored outside of the chain. The perception hashes 2504 may be merged with a specific algorithm, for example, into a contextual perception hash 2508. In other words, the contextual perception hash 2508 may represent the overall experience based on the different media, including media of different types.

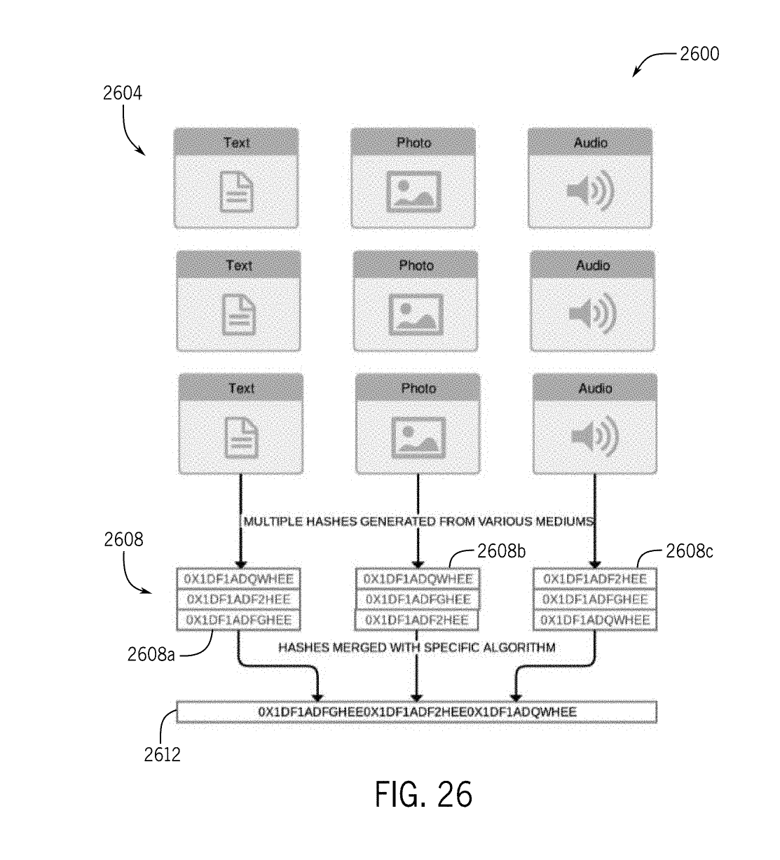

FIG. 26 is a diagram 2600 illustrating the process of creating a contextual perception hash in which the perception hashes are combined first prior to creating a contextual perception hash. As illustrated in FIG. 26, multiple data sets of the same media 2604 (e.g., text, photo, audio) may be combined, and a perception hash 2608 may be generated for each combined data set (e.g., a perception hash 2608a for the combined text media, a perception hash 2608b for the combined photo media, and a perception hash 2608c for the combined audio media). The combined perception hashes may be merged with a specific algorithm, for example, into a new contextual perception hash 2612 representing the overall experience based on the text, photo, and audio media.

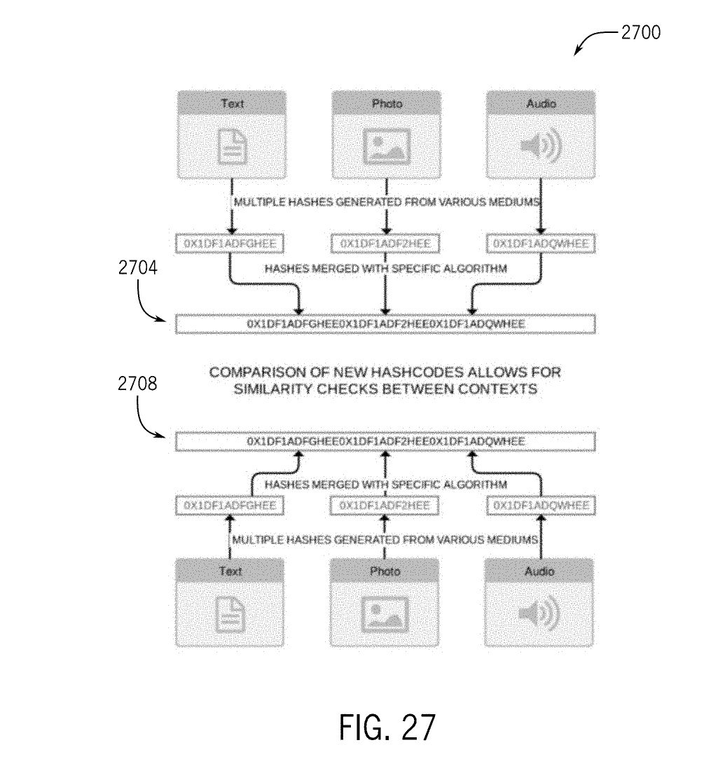

FIG. 27 illustrates a diagram 2700 showing how contextual perception hashes are comparable to allow for context similarity. In FIG. 27, multiple perception hashes are generated from various mediums, such as text, photo, and audio. The perception hashes are merged with specific algorithms, and the resulting contextual perception hashes are compared to allow for similarity checks between contexts. For example, audio, images, and text may be captured from an environment, such as a construction site. A contextual perception hash 2704 may be generated from these three types of mediums, and the contextual perception hash may be considered to represent a memory of a certain instance in time. The specific contextual perception hash to that experience or that snapshot of the environment may be stored in the chain to represent what that experience was, and the contextual perception hash may be compared to other contextual perception hashes 2708 to see if there are related experiences, similar to comparing a memory to another memory.

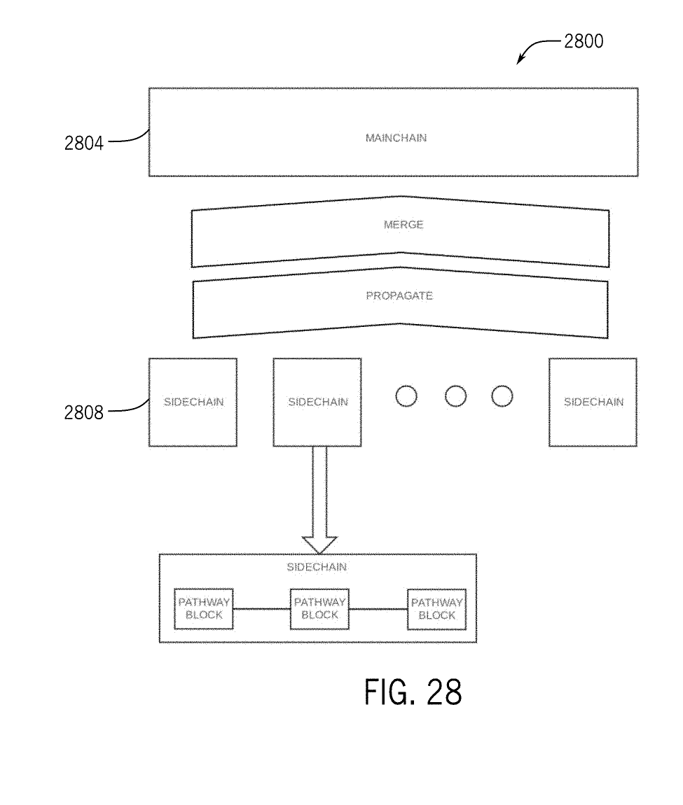

FIG. 28 depicts a diagram 2800 illustrating merging data from one chain to another chain. In particular, FIG. 28 illustrates different chains in the blockchain. For example, the blockchain may include a main chain 2804 and one or more side chains 2808. The main chain 2804 may be used as the primary compendium and may be used for lower volume activities than the side chains 2808. The side chains 2808 may be media specific (e.g., image, text, audio, etc.) and may be used for high volume, high error rate activities. The side chains 2808 may be formatted as a list or a graph, for example. Miners generally start working on the side chains 2808, then move to propagation, merging, and ultimately interacting with the main chain 2804. For example, miners may interact with the side chains 2808 by processing data and/or using the data. Once the miners reach a consensus regarding the hash for the raw data (e.g., by comparing and ranking the hashes created from the data), the hash data is inserted into the side chains. Then, the miners that were taking part in the side chain 2808 transaction go through the process of merging the data (between images, audio, text, and other formats) and then propagating the data into the main chain 2804 (e.g., placing the correct hash in its correct position on the main chain).

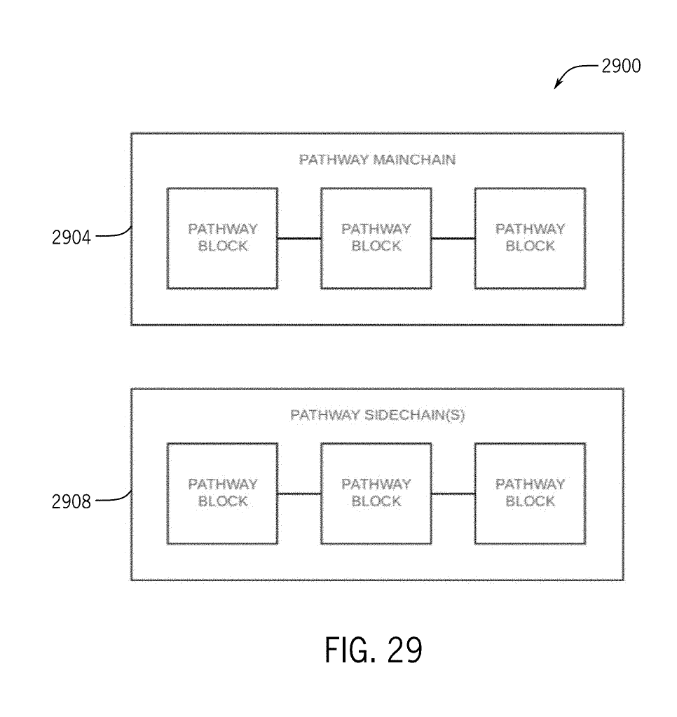

Referring to FIG. 29, a main chain 2904 may be meant for low volume insertions with high volume searching. Finalized learning may wind up here after propagation and mergers from one or more side chains 2908. The primary use of the main chain 2904 may be for identifications of known patters. The main chain 2904 may be the main compendium for the AGI. The one or more side chains 2908 may be meant for high volume insertions and propagations to the main chain 2904. The primary learning may take place in the side chains 2908. The side chains 2908 may include a lot of noise and false data. As illustrated in FIG. 29, the one or more main chains 2904 and side chains 2908 may include similar formats (e.g. blocks or nodes).

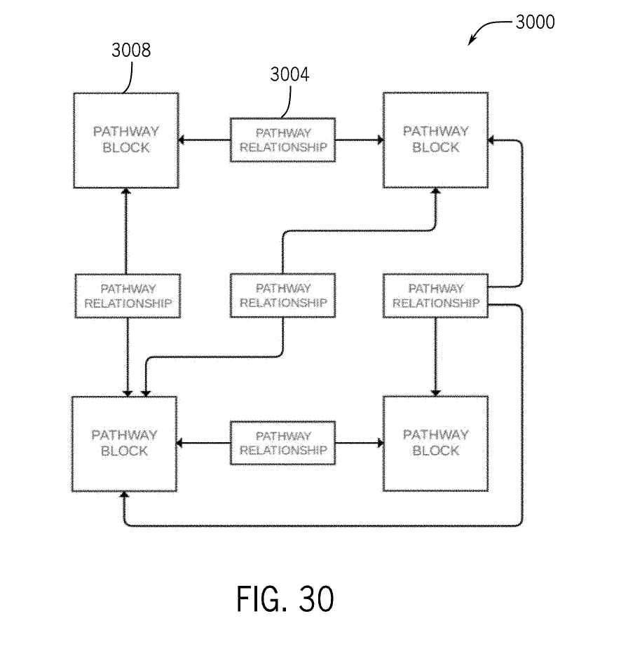

FIG. 30 illustrates a diagram 3000 showing pathway relationships 3004 between pathway blocks 3008. Pathway relationships 3004 may be similar to blocks 3008 except the pathway relationships 3004 may dictate how blocks 3008 are related to each other. For example, the blockchain can be traversed by blocks or by relationships. In other words, the relationships may provide an alternative assignment of blocks, which may be important for the AGI. In the blockchain, one can iterate block by block or traverse relationships.

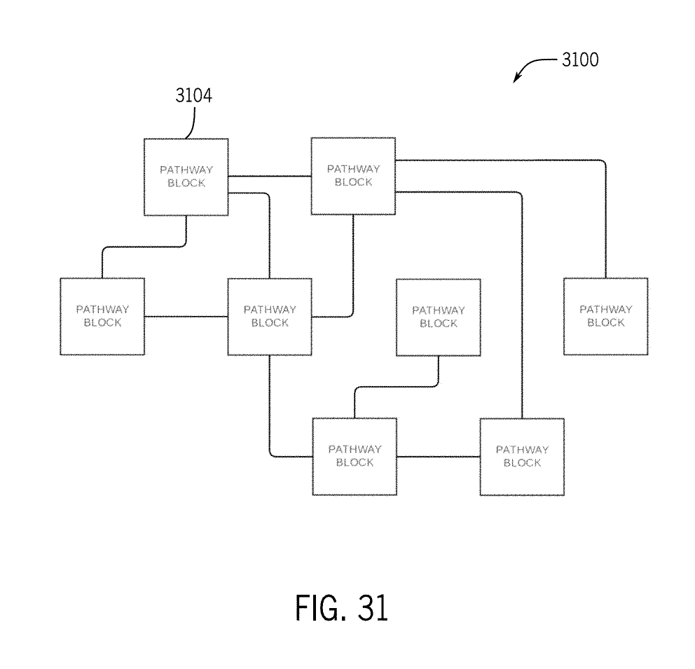

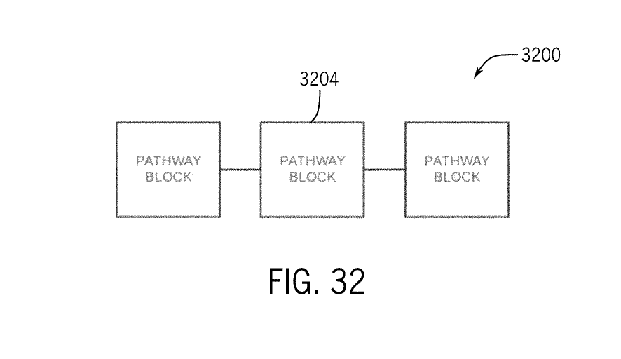

FIG. 31 illustrates a diagram 3100 showing how the blocks or nodes 3104 of the blockchain may be organized as a graph. The blockchain can be traversed directly using certain languages, such as GRAPHQL type languages. FIG. 32 illustrates a diagram 3200 showing how the nodes 3204 of the blockchain may be organized as a list.

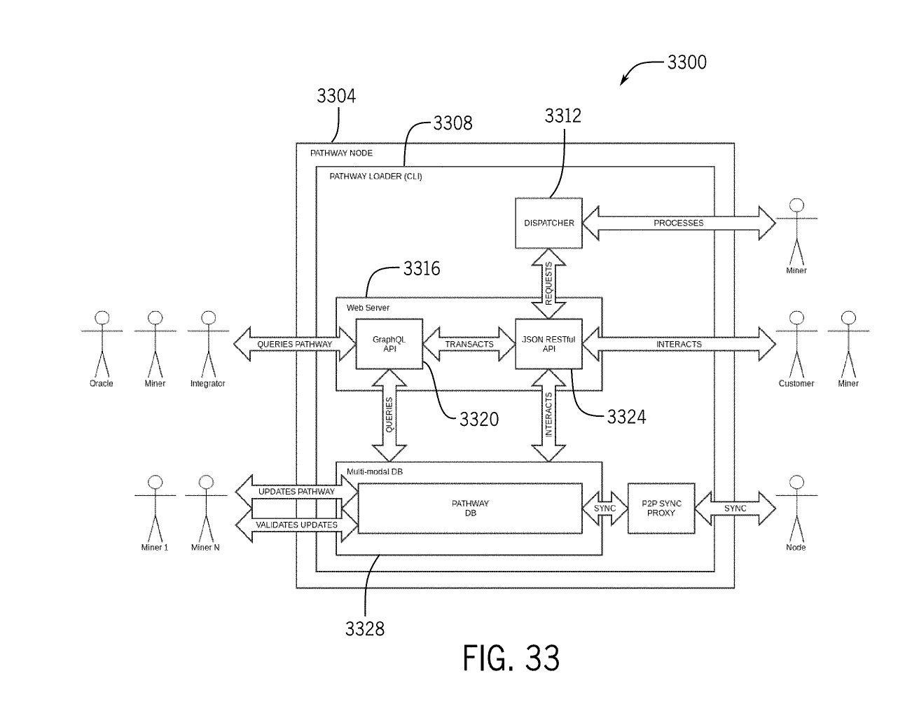

FIG. 33 depicts a diagram 3300 illustrating PATHWAY NODE interactions. This section is meant to demonstrate how a PATHWAY node interacts with all external parties including another PATHWAY NODE.

A PATHWAY NODE 3304 is a server on a decentralized or centralized network running the VOSAI PATHWAY LOADER COMMAND LINE INTERFACE (CLI). In the following diagram of a PATHWAY NODE 3304 we illustrate the inner components of the PATHWAY LOADER CLI 3308 which when combined with one or more PATHWAY HOSTS make up the decentralized network of PATHWAY HOSTS. There are a few main components to the PATHWAY LOADER CLI.

For example, a dispatcher 3312 is responsible for relay requests/responses (messages) between PATHWAY HOST NODES and VOSAI MINERS running the VOSAI LEARNER. Generally, miners initiate these messages and are interacting directly with the DISPATCHER. Miners can only interact with the DISPATCHER by means of the LEARNER.

A Web Server 3316 is also included, which is a standard off the shelf enterprise grade open source web server embedded into the PATHWAY NODE for serving messages between outside parties and internal components.

Shown within the Web Server 3316, a Graph QL API 3320 is included. The Graph QL API 3320 is an open source data query and manipulation language for APIs. We leverage Graph QL to interface directly with the PATHWAY database of AI information. Recall, PATHWAY is a decentralized ledger technology designed to store AI information instead of storing currency or token transactions. Currently, there are no DLT solutions on the market that allows for easy queries and searches against the DLT itself. For example, in Ethereum it is required to make a separate database of information that reorganizes the data structures such that it makes it easy to perform searches, indexes, analytics, and reporting. By enabling Graph QL features over the PATHWAY DLT (DB) we would be the first to allow for this ability. More specifically, how these tie into the use of perception hashes on a DLT as compared to all other approaches of using cryptographic hashes.

Within the Web Server 3316, a JSON RESTful API 3324 is shown. This is the standard canonical messages created for the VOSAI Platform which encompass all potential uses of AI in any organization. These messages are further described in a later section.

FIG. 33 also includes a multi-modal database 3328. The multi-modal database 3328 is in fact the PATHWAY DLT is an enterprise grade technology designed to work within decentralized networks complete with standard enterprise features such as RAFT consensus for data integrity and synchronization between other PATHWAY NODES. The important thing to note here is that we have made it possible to perform RAFT consensus in a P2P network which is decentralized. Generally speaking, a RAFT consensus data synchronization system is used in enterprises where all known servers are controlled by the organization. In our case, we are in decentralized network where servers come and go without centralized management.

FIG. 33 also shows various customers and integrators with respect to the PATHWAY NODE 3304. It is important to note the two actors that interact with the PATHWAY NODES directly. There are many actors that interact with the platform but the main focus here is the difference between a Customer and an Integrator. This stems from the usage of Graph QL queries against PATHWAY DLT and what it enables thereafter.

A Customer is a standard user of the platform that primarily uses the VOSAI API in order to enable their organization with different types of AI technologies. A Customer may choose to integrate with the Graph QL component if they chose. An Integrator on the other hand primarily interfaces with the data directly contained on the PATHWAY DLT. They do not contribute to the data or learning that takes place on the platform—but rather—they leverage what is already known for their own applications. Integrators could become Customers.

The important take away here is, Customer need to send us data and process it with AI techniques, whereas Integrators just want to get the data the platform is already aware of. This ultimately “enables” the Integrators' applications or systems with AI capabilities.

Lastly, the ability to monetize the information on the PATHWAY DLT is performed through this. Originators of the data (Customers) are incentivized for their information each time an Integrator accesses the data for their purposes.

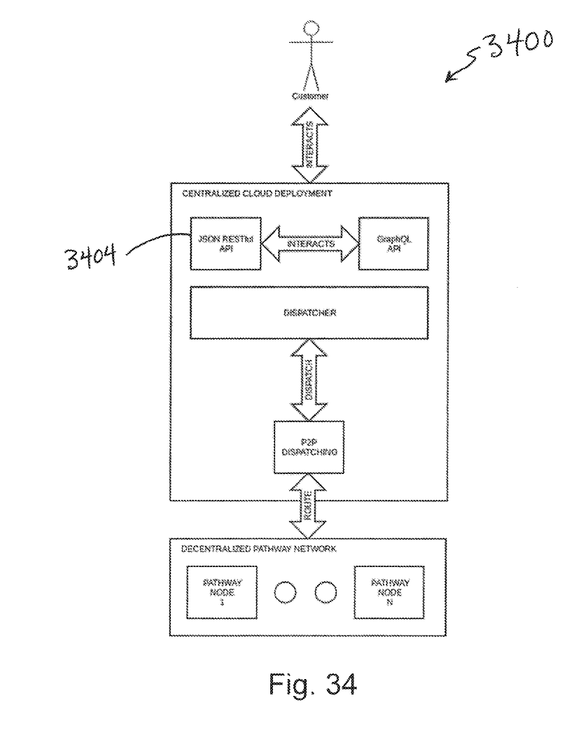

FIG. 34 depicts a diagram 3400 illustrating a centralized/decentralized deployment architecture. Standard internet infrastructure technology such as DNS (domain name system) does not exist in the decentralized landscape. Therefore, there is a need to have an architecture that can be deployed in various ways to allow for easily migrating to a purely decentralized world.

The following diagrams demonstrate how the platform is architected for deployment. In Phase 1, the architecture allows for a hybrid deployment in that the VOSAI API 3404 is hosted within an infrastructure of our choosing (likely a cloud provider or data center) which is the gateway between the consumers of the platform and the actual decentralized network made up of PATHWAY host nodes and Miner operations running the VOSAI Platform.

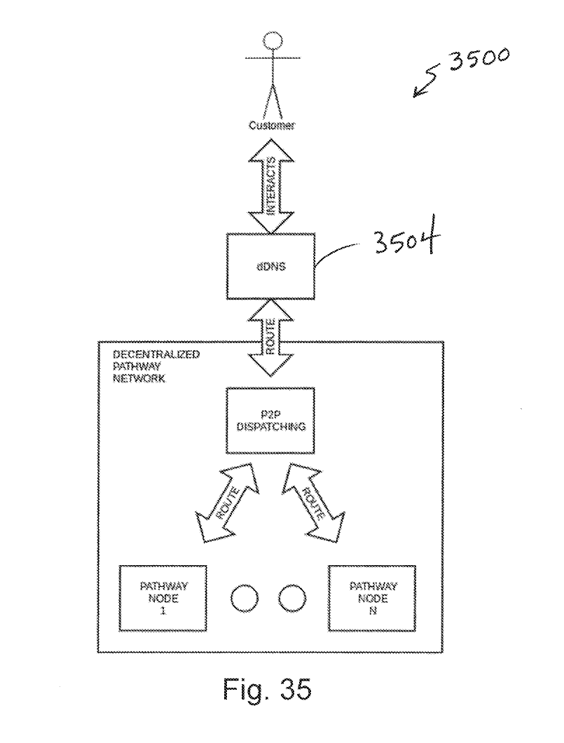

FIG. 35 depicts a diagram 3500 illustrating a decentralized deployment architecture. In Phase 2, we demonstrate the use of a technology which is meant to replace the standard DNS of today with a new technology aptly named dDNS. In the Phase 2 diagram, we demonstrate consumers of the platform directly interfacing with a dDNS 3504 which then appropriately routes requests between the consumers systems and the activated portions of the decentralized network related to their request. dDNS permits consumers of decentralized platforms as VOSAI to make requests to the platform without centralized authorities. Interactions between consumers and portions of the decentralized network operate in a manner of peer-2-peer communications.

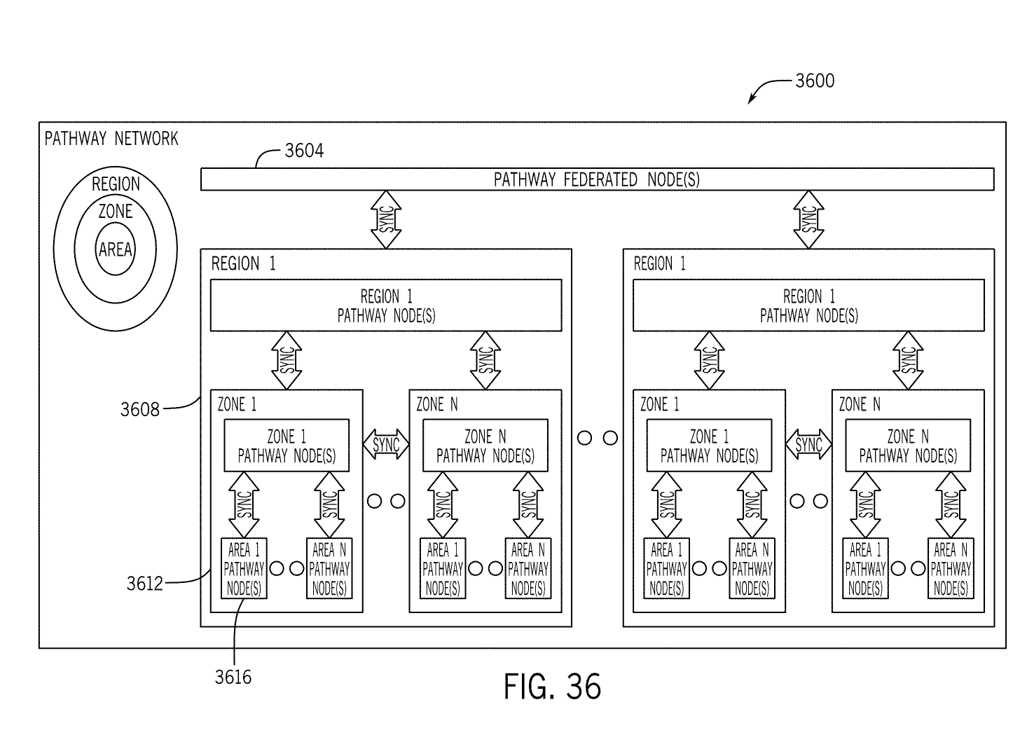

FIG. 36 depicts a diagram 3600 illustrating a pathway network architecture. The following sections illustrate, how the PATHWAY NETWORK is configured and architected for growth. The first layer of the PATHWAY network are the federated nodes 3604 controlled by VOSAI Inc. itself. These federated nodes 3604 are never interacted with directly by any Customer of the Platform. Rather, the federated nodes 3604 are decentralized point for all nodes within the network to synchronize with. Primarily Region nodes 3608 synchronize directly with federated nodes. All other nodes below a region synchronize with their respective region node.

The world is broken down into sections named Regions, Zones, and Areas. Each of these are considered a geographic section of the world. A Region is a large geographic region of the world (e.g., Europe, France, North America, USA). A Zone is a subsection of a Region (e.g., a State, or the NE USA). An Area resides within a given Regions Zone. An Area could be thought of as a City or subsection otherwise classified according to load in that given Zone.

The important take away here is to note that this is a decentralized network and the platform automatically routes any and all requests by geographic areas of the world as per this structure. Therefore, if a user is in New York City and they are accessing the platform (either data or API) then their request is directed to the nearest Region/Zone/Area. Starting from the bottom (Area) and working its way up (Region) until the request is handled. This is a seamless experience for the Customer or Integrator and happens automatically. If no Region is available then the nearest Region is responsible for the requests. In this regard, as shown in FIG. 36, within the region node 3608, zone nodes 3612 may reside. Further, within the zone nodes 3612, area nodes 3616 can reside, and so on.

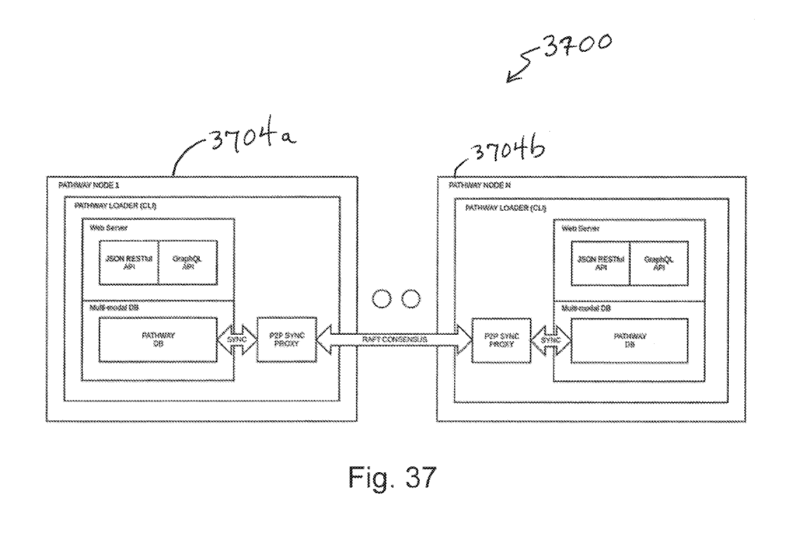

FIG. 37 depicts a diagram 3700 illustrating pathway node interactions, such as an interaction between a first node 3704a and a second node 3704b. This section further demonstrates the use of using a P2P Sync Proxy which enables proper synchronization and communication between PATHWAY NODES exclusively by allowing for RAFT consensus to be used in a P2P manner over a decentralized network.

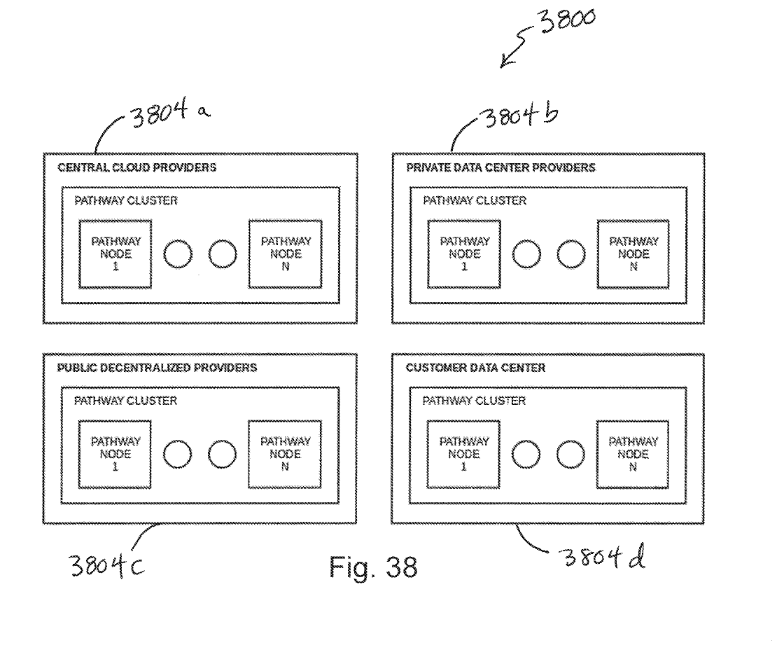

FIG. 38 depicts a diagram 3800 illustrating pathway deployment configurations. This section demonstrates that the PATHWAY NODES can be deployment in any manner which include the ability to be deployed to centralized systems, decentralized systems, customer data centers or in private data centers not part of any of the previously mentioned. For example, FIG. 38 shows node implementation in one or more of a central cloud provider 3804a, a private data center provider 3804b, a public decentralized provider 3804c, and a customer data center 3804d.

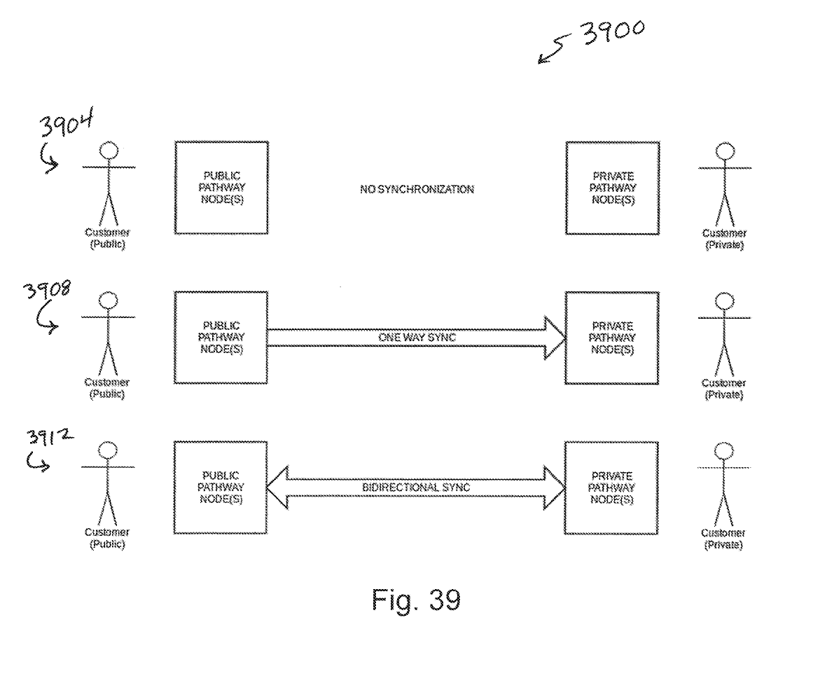

FIG. 39 depicts a diagram 3900 illustrating private/public pathway synchronization. The following section demonstrates how data can be synchronized between different PATHWAY nodes based on the desired implementation. There are primarily three synchronization mechanisms that can occur between PATHWAY NODES.

In a first mode 3904, No Sync is provided. The first mode 3904, there is a disconnect between one set of PATHWAY NODES from another SET of PATHWAY NODES. These is reserved for rare occasions where data learned in the platform and exchanged throughout the decentralized network is so sensitive that it cannot intermingle with other data or requests. Ideal application of this is generally reserved for government agencies.

In a second mode 3908, a one way sync is provided. In the second mode 3908, public data contained on public PATHWAY NODES can be synced with privately hosted PATHWAY NODES without synching the private nodes data back to the public decentralized network Customers pay additional fees for this configuration.

In a third configuration 3912, a bidirectional sync is provided. In the third mode 3912, data can be completely synced between PATHWAY NODES and is considered the default setting for a PATHWAY NODE host deployment.

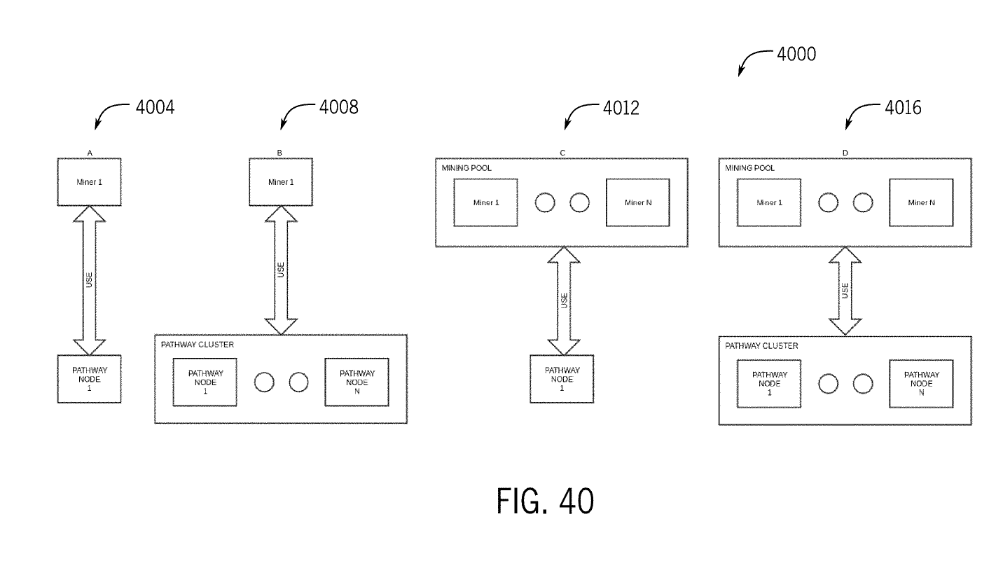

FIG. 40 depicts a diagram 4000 illustrating miner/pathway deployment. The purpose of this section is to illustrate how Miners and PATHWAY Nodes work together and how they are deployed with the given architecture. There are four base cases for these deployments.

In a first configuration 4004, one Miner and one Pathway Node are associated. Given the nature of the network (decentralized) it's possible to have a singular Miner partner with one and only one Miner running at any given time. In this scenario, the Miner would point itself either to a remote PATHWAY NODE or a locally hosted PATHWAY NODE.

In a second configuration 4008, one Miner is associated with a cluster of PATHWAY NODE. Similar to the first configuration 4004, except that in this scenario the Miner points to a cluster of PATHWAY NODES. The Miner can chose to be a PATHWAY host or leverage known decentralized PATHWAY NODES.

In a third configuration 4012, a cluster of Miners is associated with a singular PATHWAY NODE. This is often a case for large Miner operations. Miner operations may span data centers and operated by a singular organization partnered with VOSAI. In this configuration, it behooves the Miner partner to host one PATHWAY NODE within their network and allow their Miner servers access to specific PATHWAY NODE which then in term synchronizes with its respective Area, Zone, or Region Nodes.

In a further configuration 4016, a cluster of Miners is associated with a cluster of PATHWAY NODE. A similar case to case 3, often determined by performance or fault tolerance reasons. A Miner operation with many miners may choose to either host a cluster of PATHWAY NODES which sync with their respective Area, Zone, or Region nodes and are directly used for their own Mining processes. Alternatively, if an Area, Zone, or Region has the required PATHWAY NODES to handle the load of traffic from the Miners, then the Miner operation can opt to use these clusters of PATHWAY NODES in lieu of their own.

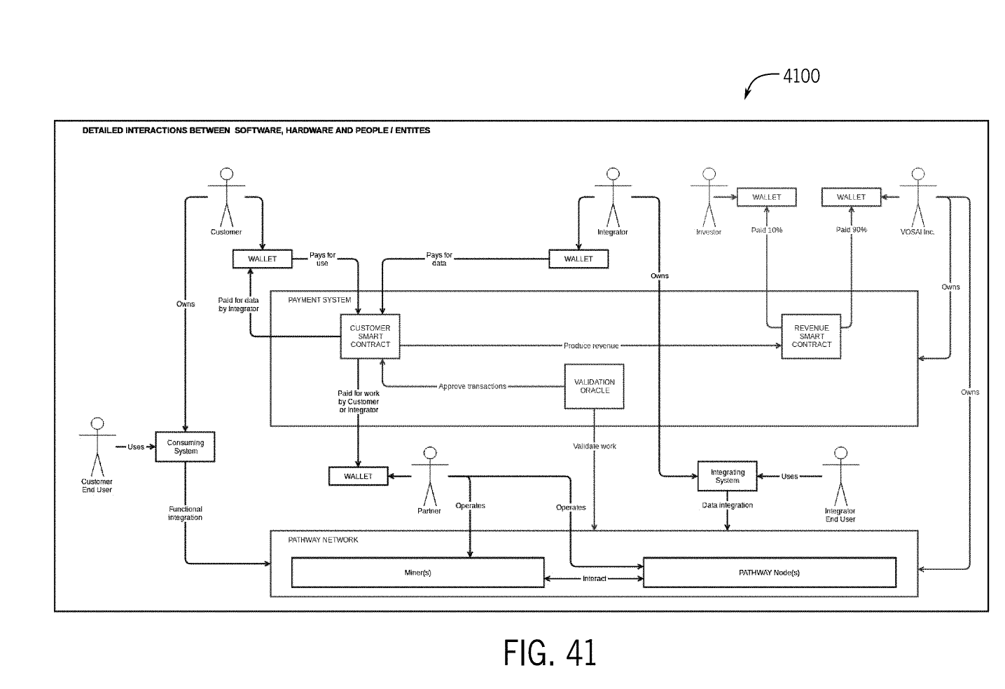

FIG. 41 depicts a diagram 4100 illustrating token flow interactions across a network. This section is meant to illustrate all interactions within the system as it relates to Entities/People and token distributions between all related parties. This diagram is best broken down into two concepts. The first is how token flow into the system. The second (latter) is how token flow out of the system.

With respect to token inflow, there are two sources where tokens originate from. Customers and Integrators. Customers and Integrators were previously described in this document therefore we will not expand on their differences herein. A Customer pays to use the VOSAI platform with the VOSAI specific tokens. These tokens are paid on demand per request made to the platform. Upon availability of these tokens, they can then be distributed to related parties thereafter. An Integrator also works the same as a customer in that they pay for data queried. A specific amount is paid for the amount of data queried and resulted in.

A secondary piece to this entire platform, is that end users of the Integrator or the Customer can also partake in a token distribution. For example, if a Customer leverages the platform for facial recognition and its End User providers' faces used within the Customers application. Then the End User can be incentivized should the Customer chose to do so for the data provided.

With respect to token outflow, Token outflow is related to who receives tokens that enter the system. Upon entering the platform, these tokens are held in a smart contract which is agreed to automatically between a Customer/Integrator and a Miner/PATHWAY Host. Once the PATHWAY HOST or Miner has completed their function then tokens are received for the respective work and the results of the work are returned to the Customer or Integrator. Simultaneously to this, a portion of the remaining tokens are distributed to a revenue smart contract which then in turn distribute tokens to Presale Investors and back to the VOSAI organization for reuse for its Customers.

With respect to token circular flow, tangential to all previously described interactions it's important to note that there is the potential for a circular flow of tokens within the system. Specifically, as it relates to the Customer directly. The Customer is the source of information and in turn they can be incentivized with additional tokens each time their data is used by an Integrator. In this case, the Customer has become enabled with the ability to not have to pay additionally for platform use because of their ability to provide substantial data which is heavily used by others of the platform. Therefore, in theory they would be able to access the system in perpetuity or until the data is no longer accessed. Therefore, it is paramount for early stage Customers to provide as much as data as possible to the platform in order to guarantee this.

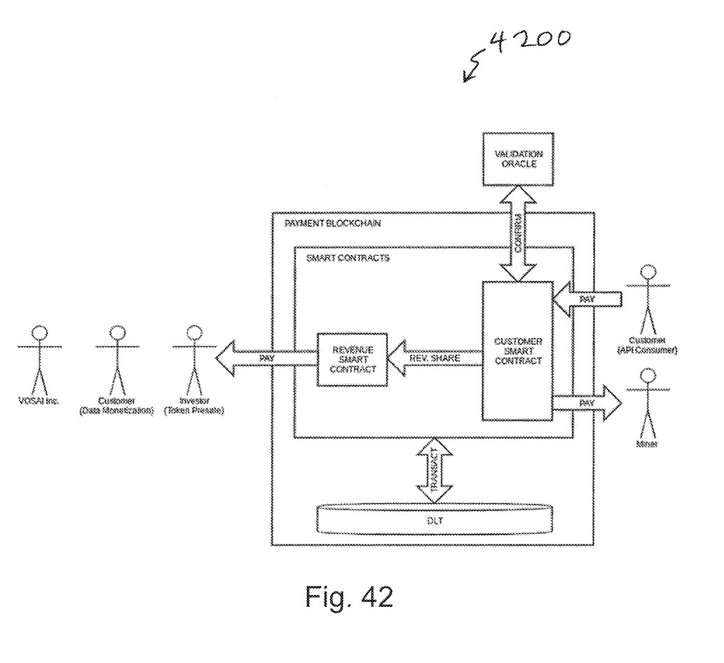

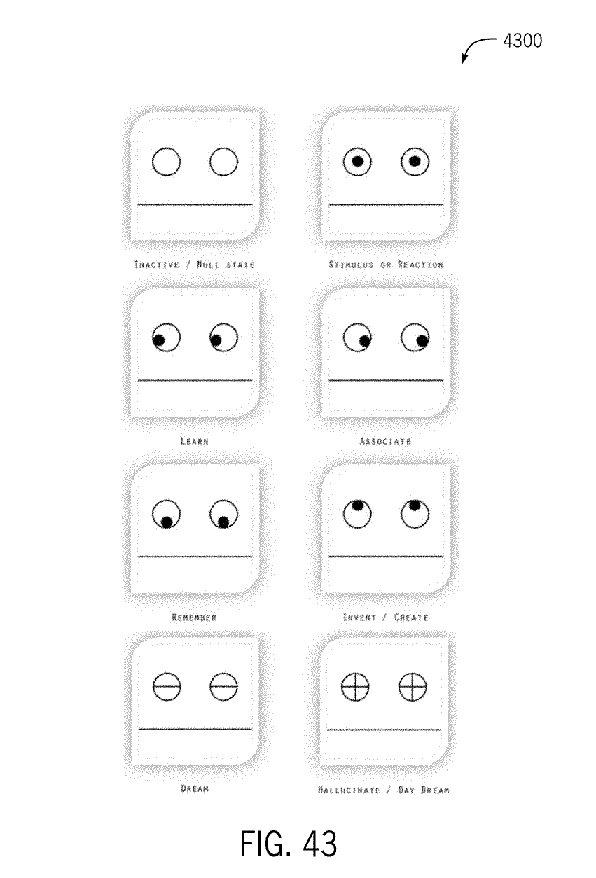

FIG. 42 depicts a diagram 4200 illustrating payment system interactions across a network. The purpose of this section is to demonstrate how payments are processed within the platform. The intent of the VOSAI platform as a whole is to remain payment gateway agnostic in that we can swap between public blockchains like Ethereum or EOS in order to handle payment processing. Moreover importantly, there is an extra step where we use a concept of an Oracle, which is responsible for bridging the gap between the PATHWAY DLT and an existing popularized DLT like Ethereum in order to validate and authorize payments exchanging the VOSAI token between parties for work requested and work performed or data requested and data stored.

### Artificial Intelligence (AI)

(i) Problems with Existing Systems

Our history is filled with countless innovations, innovations that have had unpredictable side effects on our world. Artificial intelligence (AI), and more particularly artificial general intelligence (AGI), has many applications. For the sake of clarity, an AGI is the intelligence of a machine that could successfully perform any intellectual task that a human being can. One of the problems with AGI is how to create and incorporate it into daily life that only allows the beneficial aspects and excludes the negative side effects of AGI. If not created and incorporated correctly, AI, and specifically AGI, will disrupt governments, economies, workforces, social, physical, and emotional aspects of our lives.

(ii) AI Overview

The creation of AI, and particularly AGI, may include leveraging commonly known techniques which include artificial neural networks, genetic algorithms, knowledge bases, hybrid data stores, and CPU/GPU processing power in a distributed messaging architecture conducive to scaling infinitely. The overall approach may include five phases: AGI, initial training, validation, identification, and incorporation.

In the AGI phase, the AGI may learn patterns over bytes at its most basic of function. Initially, the AGI is directed towards images and written languages, specifically the English language. The key differentiator to this approach is that rather than focusing one or a handful of ML/CV algorithms against a specific dataset, a particular recipe of algorithms is applied to a broad set of datasets such that it is sufficiently generic for broad applicability while not narrowing our focus on just one specific context. The AGI may be a combination of these techniques in a pattern that is analogous to the assumed workflows of the human mind and how it learns. Upon completion of the AGI phase, the AGI may include a software application with limited training and user interfaces.

In the initial training phase, the training used for learning may be seeded in the AGI. Training may include known English words, books, stories, and isolated data created by human interactions. The isolated data created by human interactions may be gathered manually through a crowd sourced effort or by means of transcripts of available conversations, either within the public domain or within private data collection processes. Upon completion of the initial training phase, the AGI may include training and smoke testing of the system.

In the validation phase, the AGI may be exposed in a controlled manner to public outlets (e.g., social media, email, and chat) in order to validate its ability to learn language over time without the need for commonly used NLP techniques. The validation may be monitored at all times and evaluated both externally without interaction as well as during interaction by selected team members and crowd sourced efforts. Upon completion of the validation phase, the AGI may be validated and evolved. The AGI may be able to converse free flowingly, either by listening and reacting to stimulus or promoting its own stimulus in hopes of a reaction.

In the identification phase, key functions in existing work life that could benefit from this technology by having a symbiotic relationship may be identified. Identified candidate cases may be fielded from numerous sectors ranging from common jobs to the most complicated jobs. Upon completion of the identification phase, a set of identified cases and how the incorporation of the AGI takes place within functions for work life for selected candidates may be delivered.

In the incorporation phase, various candidate applications which lend towards the integration into normal work life for selected cases the identification phase may be produced. Upon completion of the incorporation phase, one or more prototypical applications demonstrating the seamless integration into the workforce working collaboratively with human counterparts may be provided. Initially the AGI may learn from data generated by the human counterpart performing their daily duties. Ultimately, the AGI may begin to enhance the work of the counterpart however possible when related to communications in the English language, for example. Alternatively, the artificial intelligence network or system may integrate with previous integrations from the previous phase or new integrations providing the capability to reduce the scope of work and focus more on the AGI.

The creation of AGI involved specific underlying hardware, which may include GPU and/or FPGA components in order to perform operations faster and more efficiently than a CPU. The AGI generally requires the fastest available processing. Therefore, the artificial intelligence network or system may or may not use a cloud-based solution due to bottlenecks and performance issues arising specifically with virtualization and certain GPUs.

Generally, there are four categorizations to the components of the AGI that require specific hardware and performance: CPUs, GPUs/DPUs, FPGA, and data stores. Regarding CPUs, many cores and threads may be useful, as well as multiple CPUs per server over a cluster of servers, to increase processing speed. In regards to GPUs, a virtual system with dedicated time to use the GPU may be useful, and other factors including costs and power consumption also may be considered. Generally, the AGI is capable of adapting to its underlying hardware. In some embodiments, any server where the AGI resides has at least one GPU while taking into account it may be distributing its processing across multiple GPUs or a cluster of servers with multiple GPUs. Custom servers created specifically for the purposes of training and learning may be used, as well as cloud-based solutions to properly address the requirements and demands of the AGI. In regards to DPUs, a DPU based system may be designed solely for machine learning algorithms where processors are integrated and architected in a pattern best suited for the data volume and intensity of the ML algorithms. In regards to FPGA, the AI network or system may include a FPGA backed solution for the AGI. To further improve the performance of highly specialized algorithms that may not run nearly as fast on a GPU. Alternative means of computing machine learning algorithms may or may not be FPGA based.

In regards to data stores, a standard relational database may suffice for an AGI. However, in some embodiments, the AI network or system may include non-standard data stores for a proper AGI. For example, the use of document, key-value, and graph databases may be employed for the AGI. The data stores may grow to a very large size and may scale to many servers, increasing the need for adequate storage space. Meta-data (e.g., images, audio, video) may be added to the data stores, and may increase the amount of storage desired. In some embodiments, the underlying hard drives are spindle-based, and in some of these embodiments the hard drives spin at no less than 7200 RPM. In some embodiments, solid state storage is used. The following table lists example hardware specifications for servers of the AI network or system. Development workstations and servers may have various configurations.

TABLE

| Basic Processing (CPU) | Core Processing (CPU) |
|---|---|
| 2-4 servers load balanced | 2-8 servers distributed |
| Single or dual multi-core CPUs | Dual multi-core CPUs/server |
| 8 GB RAM minimum | 16 GB RAM minimum |
| 64-128 GB Storage (Spindle) | 512 GB-1 TB Storage (Spindle) |
| 1x Gigabit connectivity | 2x Gigabit connectivity |
| Advanced Processing (GPU) | Data Stores |
| 2-8 servers distributed | 2-4 servers clustered |
| Dual multi-core CPUs/server | Dual multi-core CPUs/server |
| 32 GB RAM minimum | 64 GB RAM minimum |
| 1 TB-5 TB Storage (SSD) | 10-50 TB Storage (SSD) |
| 4x Gigabit connectivity | 4x Gigabit connectivity |
| 8-way (minimum) GPU | |
| FPGA requirements TBD | |

The AI network or system may leverage open source software as much as possible. The AI network or system may use various operating systems. In some embodiments, the operating system may be Ubuntu for workstations and Debian for servers. Alternatively, in some embodiments, the operating system may be Red hat or Cent. In some embodiments, the AI network or system may use Windows or Apple based operating systems. Various programming languages may be used, such as Python, C/C++, and assembly or alternate lower level languages. JSON or XML formats for messages and/or configurations may be leverage. Binary serialization may be employed as well.

Regarding architecture, the AGI may follow best practices for enterprise software. A highly distributed messaging architecture may be employed where the state is not stored within any component and all components share a canonical messaging format. The architecture may allow the system to infinitely scale according to its underlying infrastructure. Internal messages may be encrypted.

Regarding data stores, the use of hybrid data stores (e.g., NoSQL) may be employed as the primary data store back end for the AGI. Graph, Document, and Key/Value data stores may be used. There may be two options for a data store. The first option may be a multi-modal database possessing the requirements for the AGI. The second option may be three different data stores. One for each type of store. Regardless of which option is employed, the AI solution can meet the demands of the AGI. Moreover, the employed option may be scaled with the system automatically with little to no performance degradation. Integrated development environments, tools, and libraries, including third party components, may be used.

Regarding machine learning, the AI network or system may leverage third party components on an as need basis. In some embodiments, existing frameworks for machine learning may be combined with specific constructs and patterns to support the AGI. Any libraries chosen leveraging CPUs, GPUs, DPUs, or FPGAs may be chosen such that they are agnostic to the make, model, and manufacturer of these hardware components. For example, rather than leveraging CUDA libraries for NVidia, the use of Open CL may be employed. Open CL may allow for any GPU to be utilized regardless if it is from AMD or NVidia, for example.

The chosen architecture and design of the AGI may be based on the core concept of the design. For example, the design may primarily work at the byte level. Sequences of bytes may be categorized accordingly. Without categorization, the AGI would be unable to determine if the bytes are a video, image, sound, or text. Training and learning may be assigned to these sequences of bytes. The initial approach may cover spoken languages from any origin with our focus on the English language, for example. However, the same approach with no change to the system may allow for the inclusion of images, video, and audio I/O. The system may be capable of “re-learning” information and assigning new artifacts. For example, the AGI may learn the word “dog” and understands a few things about a dog at the language level. Thereafter, the AI could be shown an image, video, or sound clip of a dog. The new data may then be associated with the dog. The AGI may consume as well as produce these images of its own accord. This is merely an example.

(ii) AI Technologies

One approach to AI in general is to leverage existing technologies where possible. In some embodiments, the AI may be focused on natural languages (e.g., English). In contrast to existing NLP frameworks and techniques which are designed on the premise of understanding sentence structures ahead of time, in some embodiments this feature is removed from the AI, allowing for a simple and pure approach with the intent that the system learns sentence structures over time. This learning approach may include one or more of the following components: artificial neural networks, genetic algorithms, knowledge bases, and hybrid data stores (e.g., Graph, Document, Key/Value stores). These components may be designed into a software architecture, which may be modeled after the learning methods of the human mind. In addition to these components, the AI may include one or more of the following algorithms: mutational algorithms, evolutionary algorithms, and fractal algorithms. Additionally, the AI may include a specialized form of number randomization for guaranteeing randomness absolutely, and many of the algorithms may use the random number generation.

The resultant functionality of the AI may be a truly ‘free thinking” AGI which is undirected programmatically. The AI may be directed through the training provided and any derivative learning which takes place as a result of the training. In some circumstances, no two instances of the AGI are alike, which may be ensured by the system architecture and the manner by which the algorithms are pieced together. The AGI may be capable of learning any language and scale to include images, audio, and video over time. Scaling to other mediums may include input and output of these media types. In some embodiments, the AI may include existing technologies to provide supporting functionality and/or machine learning.

Prior to deployment of the AI, unit tests typically are used to ensure proper functionality of all parts of the system (e.g., underlying code). Unit tests may be a part of a continuous integration process. Regression testing may automatically occur during each build cycle ensuring previous code units work as expected. Regression tests may be a part of the continuous integration process. Also, performance tests typically are used to ensure optimal hardware performance (e.g., GPUs). Any algorithm used (custom or not) may be designed to allow for execution across one or more GPUs including the spanning of servers of multiple GPUs. The AI system may include data stores for single server deployments and/or clusters of servers. The AI system may use data stores built with native programming languages such as C or C++, for example. The AI system may use graph traversals that ensure the fastest of solutions are employed while optimizing all graph traversals for the absolute fastest executions.

To validate the system, one approach of validation may be to show signs of improvement and machine thought, whether correct or not. Much like humans, the AI system can learn from mistakes. Generally, the system receives input and determines whether or not to respond. Input and output is given reinforcement (e.g., positive, negative, or neutral). Based on the input and reinforcement, the system determines what to done. In some embodiments, the AI system is tested with different workflows modeled after the human mind's way of learning. Each workflow has access to a few basic functions, including storing information, fetching information, learning, training, and associations on data. The workflow may dictate if and when these units of work are executed for the given context. The evidence of learning can be validated by analyzing the workflows executing and whether or not the system chose to learn and/or think based on its inputs and outputs. The system may grow over time through these interactions. For example, the system may be designed to continually analyze the data it has absorbed and learned. Throughout the course of the life of the AGI, the system may be tested to determine if it is capable of associating words to words and concepts. A simple graph traversal and/or analysis of the graph may indicate if this is occurring. External validation of association may come in the form of a response provided by the system associating additional words and concepts in response to a given input.

Various types of data may be used to train the AGI. In some embodiments, metadata is used. For example, initial data used for training of the AGI may be entered manually to validate the concepts and underlying components of the system. Unlike other systems, the AGI may consume bytes of data with related reinforcements to that data. Optionally, a desired reaction may be provided to the AGI. Over time, the AGI may learn based on this information and learn the ability to react, respond, or stimulate external users of the AGI with this learned data. This may be scaled to include a crowd sourced model in which users are instructed to enter stimulus with reinforcement and desired reactions to validate the system is adapting and learning based on the stimulus it receives.

In an effort to rapidly scale and train the AGI, metadata used for training may be bulk loaded directly into the AGI data store. The system may later pick up and start its own retraining processes to start categorizing the information accordingly. The bulk loaded metadata may be comprised of every know letter, word, and definitions of these items in the English language. Once loaded, the system may not be able to use this information until it has retrained itself on the data. This retraining effort may occur over time as stimulus/reactions tuples are fed into the system. The crowd sourced effort may continue during this part of the process to expedite the training. The system may analyze how the AGI categorizes the stimulus/reactions tuples. From this, customized data sets may be created and used for training. The customized data sets may automatically impact the AGI at a grand scale and the AGI may be able to make use of it in future stimulus/reaction interactions. In some embodiments, the AGI may be fed conceptual data by means of publicly available transcripts, such as from conversations between individuals, movie scripts with dialog, or fictional literal works of art, to facilitate training.

During the development, testing, and validation of the AGI, the system may use simplified user interfaces to provide quick and insightful statuses of the AGI during its execution. For example, FIG. 43 includes a diagram 4300 including various illustrations demonstrating the status of the AGI at any given time. The illustrations may be in the form of a cartoon face comprised of only eyes and a mouth. The eyes may indicate a state of the AGI. The mouth may indicate whether a response is coming from the AGI and may move. Eyebrows may be included to indicate the reinforcement type (e.g., positive, negative, and neutral).

The following table describes how the AI system may collaborate with humans to achieve desired results.

TABLE

| Base Collaboration | Indirect Collaboration |
|---|---|
| Initial testing and seeding of base | Comprised of compiled data from |
| test.cases from engineers | humans |
| This process validates the stimulus | Used to seed initial stimulus/ |
| reaction capabilities of the system | reaction tuples |
| Human interaction is performed | Derived from human interactions |
| here to validate the success of | Based on the known understanding |
| learning over time | of how humans learn as infants |
| Crowd Sourced Collaboration | Social Collaboration |
| Scripted in nature initially | Unscripted interactions |
| Crowd sourced workers (e.g. | Leverage social media outlets |
| Mechanical Turk) is leveraged for | Facebook |
| this process | Twitter |
| Once manual stimulus reaction | Email |
| scripts are performed by humans | Slack |
| the humans are instructed to | SMS |
| interact naturally | Reddit |
| Objective is to direct each crowd | Only possible after previous |
| sourced resource is an objective | collaborations take place |
| and a proposed script or script | AGI continues to expand and grow |
| framework to follow for interaction | with these stimulus/reaction tuples |
| with the AGI | |

### Compute

(i) Problems with Existing Systems

Cloud infrastructure is lacking to accommodate the AI system. For example, the VOSAI AGI may use extensive compute power. The compute power may be costly, custom, and not completely available in existing cloud providers. Existing cloud providers typically focus on delivering an infrastructure that works very well for standard websites, e-commerce, and enterprise systems. However, existing cloud providers typically do not have the ability to compute massive amounts of data using GPUs or the ability to scale to thousands of CPU cores at a cost effective price. The cloud systems have been designed to work for the most commonly used systems in the world today, such as websites, web services, databases, caching, messaging, and general application servers (e.g., WWW, FTP, SSH, SMTP, SNMP). Also, machine learning systems are expensive to build. They often require thousands of GPU based servers processing petabytes of information as fast as possible. Moreover, the network and storage requirements alone for this infrastructure is astronomical. It has become such a problem that it has led to new developments in server architecture that deviate from the CPU/GPU paradigm. The advent of TPUs and DPUs are promising but not yet proven in the market. Many of these solutions are not yet readily available to the masses for deployment and use.

The past few decades we have seen evolutions of infrastructures take place. From main frames, client server, having a server room, having a cage in a data center, make your own data center, or leveraging a third party data center to cloud providers. These advancements have been great and have saved organizations millions in the process while costing them millions at the same time. Organizations have been forced to continually upgrade, change, or migrate systems between these environments, time and time again. Moreover, enterprise systems developed using too many of the tools provided by these infrastructures have become married forever and difficult to migrate thereafter.

Many cloud providers and data centers offer privacy and security mechanisms, but improvements are needed when it comes to privacy and user data. For example, many governments have demanded and obtained access to private data stored by companies. Email providers, for example, have disclosed data to the government without user permission. Furthermore, user data has been sold between companies for profit. Additionally, select entities and/or personnel have used, developed, expanded, and controlled existing systems for their own monetary gain.

(ii) Compute Overview

The AI network or system may include a generic compute layer (VOSAI Compute) which completely abstracts the underlying infrastructure at the application level. The compute layer may be agnostic to infrastructure. The compute layer may serve as the primary infrastructure of an AI based system, such as VOSAI AGI. For example, the compute layer may allow the AGI to scale infinitely where resources are automatically added at a far lower cost. The compute layer may allow the AGI to flourish with a far lower cost in infrastructure. The compute layer may include the basics of decentralizing compute power at the GPU level such that the AGI can harness the power of the world computers GPUs rather than GPUs located in a data center or cloud provider. The compute layer may grow over time to include enterprise applications such as data stores, caching mechanisms, message queues, and others.

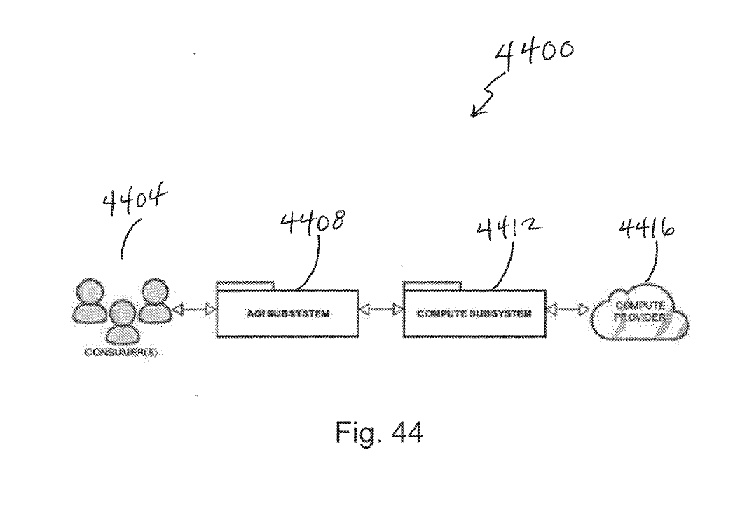

VOSAI Compute is a layer between the AGI and the actual back end compute executing AGI code. The compute layer may enable the AGI the ability to be agnostic to compute back end while rapidly adapting to the latest technologies. This ability allows for delivering better performance and quality of output from the AGI to its consumers with minimal effort and costs. The effort and cost typically is reflected at the VOSAI organization as well as cost pass-through to the end consumer. FIG. 44 illustrates a diagram 4400 showing a high-level approach to the VOSAI compute layer. A consumer 4404 is a system that leverages the AGI to perform some task. The consumer 4404 may be using the AGI for conversations between its end users and the purpose of the consumer's business. The AGI subsystem 4408 is the module(s) responsible for handling inbound requests from the outside world and relaying them accordingly to the AGI internal systems. The compute subsystem 4412 may be where the AGI actually resides, which is associated with a computer provided 4416.

Infrastructure may be used for both hardware and software levels to support the VOSAI system. For example, the compute layer may leverage the world computer for processing of machine learning functions for the AGI. In some embodiments, the entire AGI system including message queues, caching layers, and data stores may run on the world computer.

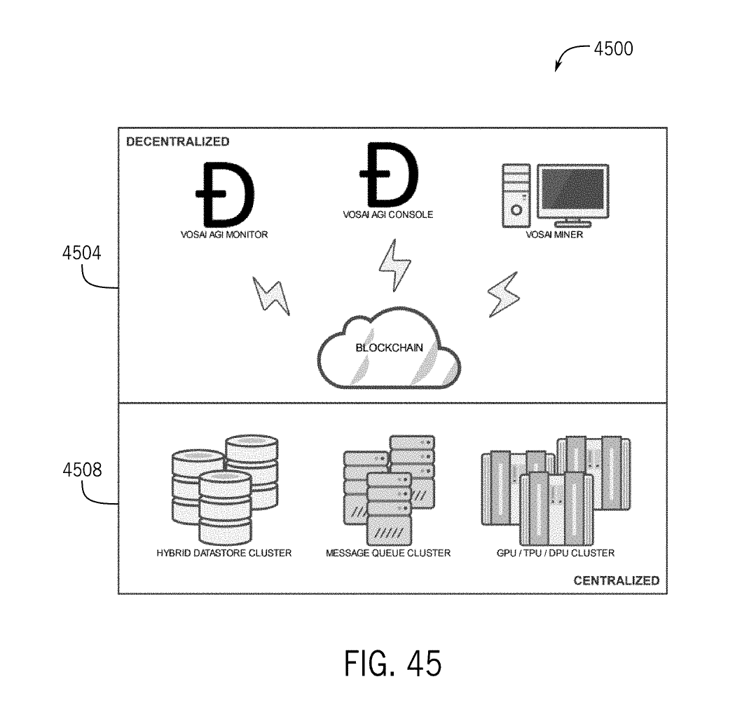

As illustrated diagram 4500 of FIG. 45, the AI system may be segmented into central siloes 4504 and decentral silos 4508, although in some embodiments the entire VOSAI system may be implemented in a decentralized infrastructure. Referring to FIG. 45, the AI system may include a AGI monitor, a AGI console, a miner, a hybrid datastore cluster, a message queue cluster, and a processing unit cluster. The AGI monitor, AGI console, and the miner may communicate with the blockchain via a network. The VOSAI AGI monitor may be a decentralized application (DAPP) used to monitor the current state of the AGI. The VOSAI AGI console may be a DAPP allowing users to interface directly with the system in a simple chat like interface, for example. The VOSAI miner may be a standard application running on a mining rig which takes requests from the network to process machine learning functions which may be CPU, GPU, DPU, or TPU intensive, for example. The hybrid data store cluster may be a specialized set of data stores which combine relational, graph, document, and key/value store databases into one unified system. This hybrid data store may be used for VOSAI AGI and may amass data infinitely. This can be scaled to the world computer using supporting infrastructure. The message queue cluster may be a supporting cluster to the VOSAI AGI system. The VOSAI AGI may be designed as a purely message based and distributed set of systems. Given the nature of a messaging system, queues may be useful. The processing unit cluster (e.g., GPU/TPU/DPU Cluster) may be a supporting cluster which performs machine learning functions much like that of the VOSAI Miner. The processing unit cluster may evolve as technology evolves to support research and development of machine learning algorithms and specific supporting hardware.

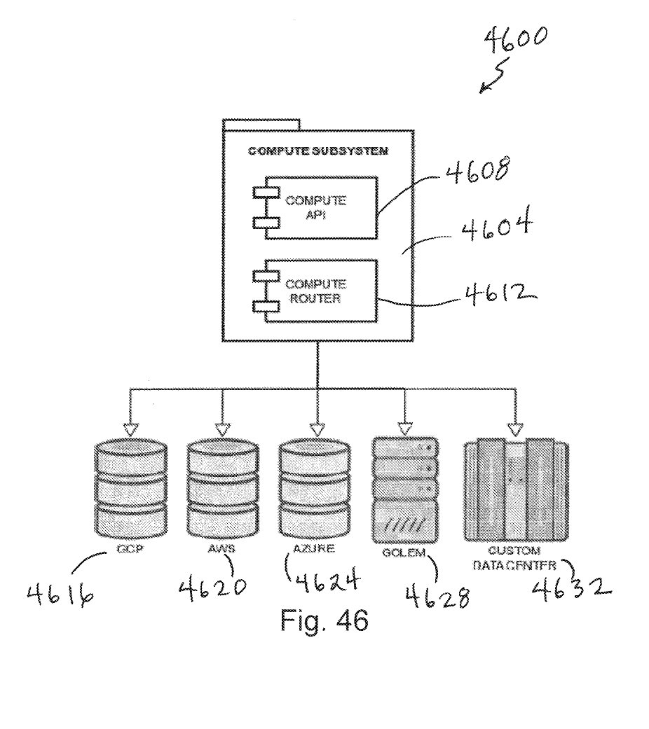

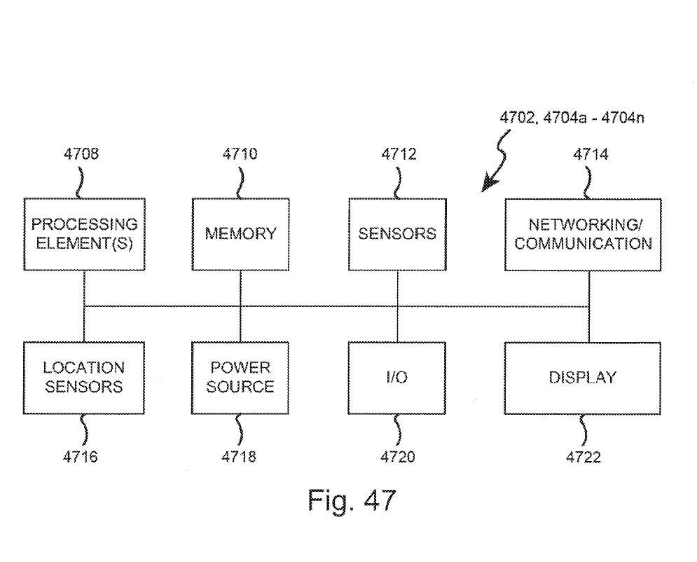

FIG. 46 is a simplified diagram 4600 of a compute layer of the AI system. As illustrated in FIG. 46, the compute layer may include a compute subsystem 4604. The compute subsystem 4604 may include a compute application programming interface 4608 (API) and a compute router 4612. The compute API 4608 may handle requests from the AGI subsystem, and may be considered a restful API. The compute router may be a daemon responsible for routing the request to the appropriate compute back end.

The compute subsystem 4604 may communicate with a compute back end. For example, as illustrated in FIG. 46, the compute subsystem may be integrated with a cloud provider 4616 (e.g., a Google Cloud Platform (GCP)), which may serve as a compute back end. Additionally, or alternatively, the compute subsystem may be integrated with Golem 4628 or a similar compute back end, which may leverage blockchain and/or a crowd sourced approach to computing. In some embodiments, a custom compute back end specialized for VOSAI Compute may be used. Existing applications and frameworks may be ported to the compute back end to work appropriately.

The compute subsystem may communicate with one or more cloud providers. For example, as illustrated in FIG. 46, the compute subsystem may be integrated with GCP 4616, Amazon Web Services 4620 (AWS), Microsoft Azure 4624, and/or other cloud providers. In some embodiments, one or more of the cloud providers may be removed from the system if they are deemed useless.

The compute subsystem may communicate with a data center. As illustrated in FIG. 46, the compute subsystem may be integrated with a custom data center 4632, which may be specialized for both machine learning and mining applications. The data center 4632 may be used to create compute layer modules and may be developed against the infrastructure illustrated in FIG. 46. The data center 4632 may include one or more advanced reduced instruction set computer machines (ARMs) and/or CPUs. The data center may be GPU agnostic. The data center 4632 may be DPU backed. The data center 4632 may use one or more FPGAs. The data center may use various means of power and cooling.

FIG. 47 is a simplified block diagram of a computing device, such as computing device that operates to execute any of functionality described herein, such as that of the various chains an chain nodes. In this regard, the computing device can be one or more computers of the “world computer” and define a portion of the decentralized memory storage structure. The client devices 4704 a-4704 n and/or server 4702 may include one or more of the components shown in FIG. 47 such as one or more processing elements 4708, one or more memory components 4710, one or more sensors 4712, a networking/communication interface 4714, a location sensor 4716, a power source 4718, an input/output interface 4720, and/or a display 4712. It should be noted that FIG. 47 is meant as exemplary only, in other examples the computing devices of the system, e.g. the server 4702 and user devices 4704 a-4704 n, may include fewer or more components than those shown in FIG. 47.

The one or more processing elements 4708 may be substantially any electronic device capable of processing, receiving, and/or transmitting instructions. For example, the processing element 4708 may be a microprocessor or a microcomputer. Additionally, it should be noted that the processing element 4708 may include more than one processing member. For example, a first processing element may control a first set of components of the computing device and a second processing element may control a second set of components of the computing device where the first and second processing elements may or may not be in communication with each other. Additionally, each processing element 4708 may be configured to execute one or more instructions in parallel.

The memory 4710 stores electronic data that may be utilized by the computing devices 4702, 4704 a-4704 n. For example, the memory 4710 may store electrical data or content e.g., audio files, video files, document files, and so on, corresponding to various applications. The memory 4710 may be, for example, non-volatile storage, a magnetic storage medium, optical storage medium, magneto-optical storage medium, read only memory, random access memory, erasable programmable memory, flash memory, or a combination of one or more types of memory components. In many embodiments, the server 4702 may have a larger memory capacity than the user devices 4704 a-4740 n.

The sensors 4712 may provide substantially any type of input to the computing devices 4702, 4704 a-4704 n. For example, the sensors 4712 may be one or more accelerometers, microphones, global positioning sensors, gyroscopes, light sensors, image sensors (such as a camera), force sensors, and so on. The type, number, and location of the sensors 4712 may be varied as desired and may depend on the desired functions of the system 4700.

The networking/communication interface 4714 receives and transmits data to and from the network 4706 to each of the computing devices 4702, 4704 a-4704 n. The networking/communication interface 4714 may transmit and send data to the network 4706, and/or other computing devices. For example, the networking/communication interface may transmit data to and from other computing devices through the network 4706 which may be a cellular or other wireless network (WiFi, Bluetooth) or a wired network (Ethernet), or a combination thereof.

The location sensors 4716 provide location information, such as GPS data, for the computing devices. In some embodiments the location sensors 4716 may include a GPS receiver or other sensors that track the strength and other characteristics of a signal, such as a cellular signal, to determine a location for the computing device. In embodiments including a GPS receiver, the location sensors 4716 may receive data from three or more GPS satellites and then may use the satellite information to determine a location of the device. The location sensors 4716 may be configured to determine latitude and longitude information for the computing device, e.g. the user devices 4704 a-4704 n. It should be noted that in many embodiments the location sensors 4716 may use a combination of GPS satellite data and data from other sources, such as WiFi and/or cellular towers. The accuracy, format, preciseness of the latitude and longitude (or other location data from the location sensors 4716) may vary based on the type of computing device and the type of location sensors 4716.

As will be discussed in more detail below, the latitude and longitude or other location data may be transmitted from the user devices 4704 a-4704 n to the sever 4702. The server 4702 in some instances may store the location of each of the user devices 4704 a-4704 n in an uniform resource locator (URL) or other web address that may be accessible by the server 4702 and other computing devices granted access. For example, the server 4702 may include a URL endpoints list that includes the location data for a plurality of the user devices 4704 a-4704 n in communication with the server 4702, this will be discussed in more detail below.

The computing devices 4702, 4704 a-4704 n may also include a power supply 4718. The power supply 4718 provides power to various components of the computing devices 4702, 4704 a-4704 n. The power supply 4718 may include one or more rechargeable, disposable, or hardwire sources, e.g. batteries, power cord, or the like. Additionally, the power supply 4718 may include one or more types of connectors or components that provide different types of power to the computing devices 4702, 4704 a-4704 n. In some embodiments, the power supply 4718 may include a connector (such as a universal serial bus) that provides power to the computer or batteries within the computer and also transmits data to and from the controller 4704 to the machine 4702 and/or another computing device.

The input/output interface 4720 allows the computing devices 4702, 4704 a-4704 n to receive inputs from a user and provide output to the user. For example, the input/output interface 4720 may include a capacitive touch screen, keyboard, mouse, stylus, or the like. The type of devices that interact via the input/output interface 4720 may be varied as desired.

The display 4722 provides a visual output for the computing devices 4702, 4704 a-4704 n. The display 4722 may be substantially any size and may be positioned substantially anywhere on the computing devices 4702, 4704 a-4704 n. For example, the server 4702, if it includes a screen, the display may be a separate component from the server 4702 and in communication therewith, whereas the user devices 4704 a-4704 n may include an integrated display screen. In some embodiments, the display 4722 may be a liquid crystal display screen, plasma screen, light emitting diode screen, and so on. In some embodiments, the display 4722 may also function as an input device in addition to displaying output from computing device. For example, the display 4722 may include capacitive touch sensors, infrared touch sensors, or the like that may capture a user's input to the display 4722. In these embodiments, a user may press on the display 4722 in order to provide input to the computer device. In other embodiments, the display 4722 may be separate from or otherwise external to the electronic device, but may be in communication therewith to provide a visual output for the electronic device.

### API

The VOSAI API is a RESTful JSON Web Service easily consumed by any consuming application permitted the system is capable of exchange JSON request and responses and has the ability to communicate with the standard HTTP and HTTPS protocols. It will be appreciated that any of the APIs described hereinafter can be used or associated with the foregoing decentralized memory storage structures, chains, and so, on. Further, while specific examples of APIs are described herein, this is not meant as limiting. Rather, other APIs can be used, consistent with the scope and spirit of the presented disclosure.

A RESTful API is an application program interface (API) that uses HTTP requests to GET, PUT, POST and DELETE data. A RESTful API—also referred to as a RESTful web service—is based on representational state transfer (REST) technology, an architectural style and approach to communications often used in web services development.

REST technology is generally preferred to the more robust Simple Object Access Protocol (SOAP) technology because REST leverages less bandwidth, making it more suitable for internet usage. An API for a website is code that allows two software programs to communicate with each another. The API spells out the proper way for a developer to write a program requesting services from an operating system or other application.

The platform's API includes some basic types that must first be addressed to ensure cross platform compatibility.

The follow table illustrates the base data types expected by the platform. Consuming systems should build to the platforms basic data types accordingly.

| Type | Details |
|---|---|
| integer | 0 to 9223372036854775807. For more information review the |
| | integer specification. |
| string | null, 0 to 1024. For more information review the string |
| | specification. |
| uuid4 | Adheres to the RFC4122 specification always expressed as a |
| | string in the platform |
| decimal | −999999999999999999 to 999999999999999999. For more |
| | information review the decimal specification |
| list | null, 0 to limit expressed in request messages |
| byte[ ] | null, base 64 array of bytes, often up to 8 MB currently |
| | supported in the platform |
| Complex | A type that is comprised of one or more basic types is |
| Type | considered to be a Complex Type. |

Messages within the VOSAI API all contain a common set of properties, attributes, and capabilities. These constructs are intended to be generic in nature for all messages exchanged with the API. Before getting into these constructs its import to know the most basic of these, primarily Message Type, Message Result, and Message Version. These are the most basic of enumerated constructs that allow you to act in a simple and effective manner.

Every message contains a result. The intent of the message result is to indicate that if a request/response action was successful or not. In which cases, consuming systems should handle messages results appropriately in order to ensure consistent, bug free operation of their integrated systems.

The following table indicates the acceptable values for a Message Result with descriptions as stated within.

| Name | Value | Description |
|---|---|---|
| Unknown | 0 | A message with a result of unknown is just that. It's not clear what is |
| | | happening or happened or going to happen with the message. Often |
| | | messages are set to unknown when they are first instantiated. In rare |
| | | occasions, the system may have completely fallen short of processing the |
| | | request in which cases a message is marked as unknown. |
| Ok | 1 | A message with a result of OK indicates that the system received the |
| | | message and processed it as expected. Consuming systems should first |
| | | check to ensure any response message from the API is OK before |
| | | consuming the response itself. |
| Fail | 2 | A message with a result of Fail indicates that the system received the |
| | | message and processed it. However, an issue arose while handling the |
| | | message. In which case, Consuming systems should then turn their codes |
| | | attention to the result codes and messages provided for the failure. |

Each and every message has a respective Message Type. A Message Type does nothing more than indicate if the message in question is a request or response. Requests are messages sent to the VOSAI API. Responses are messages sent back to consuming systems by the VOSAI API. At no time will the VOSAI API receive a message of type Response. This would result in a Message Result equal to Fail.

The following table indicates the acceptable values for a Message Type with descriptions as stated within.

| Name | Value | Description |
|---|---|---|
| Unknown | 0 | Generally, no message will be marked as unknown. |
| | | There are rare occasions where unknown messages |
| | | are created and is generally during the instantiation of |
| | | these messages prior to populating their attributes |
| | | and properties. |
| Request | 1 | Consuming systems must indicate every message sent |
| | | to the VOSAI API as a Request type message. |
| | | Anything else would not be accepted. |
| Response | 2 | VOSAI API will respond to appropriate messages sent |
| | | in with a proper and related Response type message. |

As with any proper enterprise messaging system, a message has a respective version. For the sake of simplicity, we have kept version numbers out of the initial releases of the platform.

The following table indicates the acceptable values for a Message Version with descriptions as stated within.

| Name | Value | Description |
|---|---|---|
| Previous | 0 | The following table indicates the acceptable values for |
| | | a Message Version with descriptions as stated within. |
| Current | 1 | Indicates this message version is the recent |
| | | production version of the platform. |
| Next | 2 | Indicates this message version is for a future version |
| | | possible version of the platform. This is often |
| | | used by Alpha and Beta partners for early |
| | | adoption of our next releases. |

All messages in the VOSAI API derive from a base construct called the Base Message. Both Requests and Responses derive from a Base Message and it is safe for you to assume every message will contain at least this information within any request response message.

The following table indicates the acceptable values for a Base Message with descriptions as stated within.

| Name | Type | Notes | Required |
|---|---|---|---|
| name | string | Specifies the messages name. The name | True |
| | | must be an acceptable name supported by | |
| | | the system and is specific to the context of | |
| | | your request. Therefore, these are not | |
| | | dynamic from the consumers systems they | |
| | | are statically defined by the VOSAI API. | |
| topic | string | Specifies the messages topic. The topic | True |
| | | must be an acceptable topic supported by | |
| | | the system and is specific to the context of | |
| | | your request. Therefore, these are not | |
| | | dynamic from the consumers systems they | |
| | | are statically defined by the VOSAI API. | |
| created | decimal | Indicates when the message was created by | True |
| | | means of a integer timestamp. | |
| type | Message | Indicates the type of message defined. | True |
| | Type | | |
| payload | List | At the base message level, a payload is not | False |
| | | required. However, for all derived | |
| | | messages a payload is often required as it | |
| | | is closely related to the name and topic | |
| | | tuple. The payload is often a list of tuples | |
| | | supporting the variables/data required to | |
| | | process a message. | |
| conversation_id | uuid4 | A unique identifier created by the VOSAI | False |
| | | API. This identifier allows consuming | |
| | | systems to track a message down to a | |
| | | specific transaction or request. Keep track | |
| | | of these identifiers as they are useful when | |
| | | debugging your systems. | |
| async_response_url | string | An optional parameter which allows | False |
| | | asynchronous requests to the VOSAI API. | |
| | | This URL is a consumer's URL which is | |
| | | configured within the system. | |
| | | Asynchronous requests sent into VOSAI | |
| | | API will always return immediately and | |
| | | never block with the assumption that the | |
| | | response for the related request will be sent | |
| | | out to a different end point. | |
| version | | Indicates the version of the message in | True |
| | | question. | |

The following table illustrates a raw JSON view of the Base Message construct.

{

// represents a timestamp
created: 153128941134,
// unknown type since this is only a base message
type: 0,
version: 1,
// generated by the platform
conversation_id: “123412341-1234124-24141-4-33141”,
// not required but illustrates how to pass a callback handler to the
platform
async_response_url: “https://your.domain.com/api_callback”,
// these fields are intentionally left blank for example purposes
name: ””,
topic: ””,
payload: { }

}

For the sake of simplicity, we have left out the name, topic, and details of the payload as they are explained in further detail in the Messages section of this documentation.

Much like the Base Message, the Base Request message serves as the foundation for all request messages made by consumers of the VOSAI API. It extends additional properties to the request from the Base Message to account for specific properties and attributes as they relate to a request message.

The following table indicates the acceptable values for a Base Request with descriptions as stated within.

| Name | Type | Notes | Required |
|---|---|---|---|
| limit | Integer | An optional integer value which indicates | False |
| | | to the VOSAI API to limit the number | |
| | | of values received in a related | |
| | | response message. | |
| type | Message | This should always be set to Request | True |
| | Type | Message Type. Any other value will result | |
| | | in an unknown response from the VOSAI | |
| | | API. | |

The following table illustrates a raw JSON view of the Base Request construct.

{

created: 153128941134,
type: 1,
version: 1,
conversation_id: “123412341-1234124-24141-4-33141”,
async_response_url: “https://your.domain.com/api_callback”,
// note that this is the only new field added which limits the result size
limit: 10
name: ””,
topic: ””,
payload: { },

}

For the sake of simplicity, we have left out the name, topic, and details of the payload as they are explained in further detail in the Messages section of this documentation.

Much like the Base Message and Base Request Message, the Base Response message serves as the foundation for all response messages created by the VOSAI API. It extends additional properties to the response from the Base Message to account for specific properties and attributes as they relate to a response message.

The following table indicates the acceptable values for a Base Response with description as stated within.

| Name | Type | Notes | Required |
|---|---|---|---|
| id | string | A unique identifier for the specific response | True |
| | | message assigned by the VOSAI API. Use this | |
| | | identifier for any troubleshooting or tracking | |
| | | your consuming system may require. | |
| elapsed | Integer | An optional integer indicating the duration of | False |
| | | time it took for the VOSAI API to process your | |
| | | request. This is often helpful in understanding | |
| | | how your requests perform while better | |
| | | enabling you to fine tune your systems for | |
| | | performance reasons. | |
| result | Message | Indicates the result of your request as it relates | True |
| | Result | to this response. Please review Message Result | |
| | | for further information. | |
| result_code | Integer | An optional static integer code which is only | False |
| | | populated should an issue arise. Consuming | |
| | | systems should assume that if the response has | |
| | | a result of Fail - then and only then - should it | |
| | | check with the respective result codes in order | |
| | | to determine how to best handle the issue. A | |
| | | result of Fail does not imply the system has | |
| | | failed - but rather - it implies your request was | |
| | | not valid or there was an issue with the request | |
| | | that your consuming system should account | |
| | | for. | |
| result_message | string | An optional static string description for the | False |
| | | result code. In other words, a plain English | |
| | | explanation of what occurred. Consuming | |
| | | systems should never create logic against this | |
| | | message as it may be subject to change at any | |
| | | time. Consuming systems should use the | |
| | | combination of Message Result and Result | |
| | | Code instead. | |
| type | Message | This value will always be set to a Response | True |
| | Type | type since this is a response message. In the | |
| | | event that the type is indicated as Unknown | |
| | | then an issue has arisen during your request | |
| | | that needs to be addressed. First validate that | |
| | | you have a well-formed request. Secondly, | |
| | | contact support with the respective ID so we | |
| | | can further troubleshoot any issues you may | |
| | | have. | |

The following table illustrates a raw JSON view of the Base Response construct.

{

// a unique id assigned to this specific response
id: “98322341-1234124-24141-4-33141”,
conversation_id: “123412341-1234124-24141-4-33141”,
created: 153128941134,
type: 2,
version: 1,
// optional field which will indicate the time to execute your request
elapsed: 4398,
// indicates a successful response
result: 1,
// these two fields are optionally returned - in this case its redundant
result_code: 1,
result_message: ““,
name: ””,
topic: ””,
payload: { }

}

For the sake of simplicity, we have left out the name, topic, and details of the payload as they are explained in further detail in the Messages section of this documentation.

The VOSAI API comes prepackaged with a set of known error response messages of which all derive from a base Generic Response Message. The VOSAI API platform attempts to make every effort to ensure no abrupt errors and/or issues arise. The API will gracefully respond with appropriate response messages whether there is an issue with your request or the platforms own internal error reporting. We do not anticipate consuming systems to ever see internal errors. The only likely event where this may occur is when we are performing upgrades to the next version or making deployments to production. In these events, all consumers of the API will be notified accordingly.

The following table illustrates a raw JSON view of the Generic Error Response construct.

```
{
  // a unique id assigned to this specific response
  id: ”98322341-1234124-24141-4-33141”,
  // use this id to trouble shoot your message exchanges
  conversation_id: ”123412341-1234124-24141-4-33141”,
  created: 153128941134,
  type: 2,
  version: 1,
  // optional field which will indicate the time to execute your request
  elapsed: 4398,
  // any response not equal to 1 is considered an error
  result: 0,
  // these two fields will always return with a specific result
  code/message
  result_code: 0,
  result_message: , ““
  // the platform attempts to indicate which name/topic was requested
  name: ””,
  topic: ””,
  // the platform attempts to use the same payload provided in the
  request
  payload: { }
}
```

Names and topics allow for messages to be less statically defined while allowing the platform to fluidly upgrade, downgrade, patch, or deploy new production components at run time with minimal to no impact to consuming systems.

Every message has a name within the platform. These names are often specific to a function the platform is performing. For example, LEARN is a name of a message which indicates the platform is about to learn on a given payload.

The following is a list of available names supported or to be supported by the platform.

| Name | Description |
|---|---|
| unknown | This is a reserved name by the platform and only used in rare occasions where |
| | issues arise. |
| format | This is a reserved name by the platform and only used in rare occasions where |
| | issues arise. Generally related to formatting issues in a response or request |
| | message. |
| learn | Signals to the platform that it should perform a learning operation against the |
| | payload provided. |
| predict | Signals to the platform that it should performing a prediction operation against |
| | the payload provided. |
| compose | Indicates the platform will attempt to compose a new payload from the |
| | payload(s) provided. Please refer to topics for more uses. |
| verify | Instructs the platform to verify the payload provided is indeed the payload |
| | suggested. Please refer to topics for more uses. |
| extract | Instructs the platform to extract certain elements from the payload provided. |
| | Please refer to topics for more uses. |
| identify | Instructs the platform to identify certain elements in the payload provided. |
| | Please refer to topics for more uses. |
| detect | Instructs the platform to detect certain qualities in the payload provided. Please |
| | refer to topics for more uses. |
| transcribe | Instructs the platform to transcribe in plain text from the payload provided. |
| | Please refer to topics for more uses. |
| range | Instructs the platform to perform range finding abilities based on the payloads |
| | provided. Please refer to topics for more uses. |
| weigh | Instructs the platform to weigh elements in the payload. A weighing is often |
| | translated into a unit of measure as it relates to the weight of an object. Please |
| | refer to topics for more uses. |
| converse | A name used for enabling the platforms automated chat abilities. Please refer to |
| | topics for more uses. |
| invent | A special feature of the platform to invent new payloads as it desires from |
| | existing payloads or known payloads already in the platform. Please refer to |
| | topics for more uses. |
| imagine | Similar to invent except that a broader range of creativity is granted to the |
| | platform as it comes to creating new payloads. Please refer to topics for more |
| | uses. |
| recognize | Instructs the platform to recognize certain elements within the payload provided. |
| | Please refer to topics for more uses. |
| recall | Instructs the platform to search, find, and fetch information within itself. This |
| | process is often tied to identification (identify). Please refer to topics for more |
| | uses. |

Names are static, case sensitive values. It is important for consuming systems to adhere to these constraints. If any of these names are off by even one character, improper spacing or encoding then these will result in an error response.

Every message has a topic within the platform. These topics are often specific to a context for a function the platform is performing.

The following is a list of available topics supported or to be supported by the platform.

| Name | Description |
|---|---|
| font | Indicates the context is related to type setting e.g., fonts. |
| music | Indicates the context is related to music. |
| music-notes | Indicates the context is related to musical notes. |
| music-audio | Indicates the context is related to music tracks of raw audio. |
| crypto | Indicates the context is related to crypto-currency. |
| bill | Indicates the context is related to bills from service providers. |
| image | Indicates the context is related to images. |
| face | Indicates the context is related to faces. |
| face-features | Indicates the context is related to faces and the features thereof. |
| face- | Indicates the probability the age, gender, and diversity of a face. |
| demographic | |
| face- | Indicates the sentiment of a face. This includes emotions and sentiment. |
| sentiment | Emotions include joy, anger, disgust, sadness, fear, and surprise while |
| | Sentiment includes positivity, negativity, and neutrality. Each of these are |
| | expressed in a number from 0-100 where the totality is equal to 100 |
| | respective to each (e.g., emotion and sentiment). |
| object | Indicates the context is related to objects found in images. |
| handwriting | Indicates the context is related to handwriting found in images of documents. |
| palette | Indicates the context is related to color palettes often used for branding, |
| | design and marketing efforts for either digital or print. |
| English | Indicates the context is related to the spoken and/or written English |
| | language. |
| art | Indicates the context is related to art forms of any type. |
| chat | Indicates the context is related to chatting between two parties. |

Topics are static, case sensitive values. It is important for consuming systems to adhere to these constraints. If any of these topics are off by even one character, improper spacing or encoding then these will result in an error response.

The intent of this section is to indicate how names and topics are mapped within the VOSAI API. Ensure your organizations consuming systems are programmed accordingly as it relates to sending requests to the platform with the correct mappings.

The following table maps names to topics that are currently supported in the platform. There are far more topics and names available, but these are currently in place.

| Name | Supported Topics |
|---|---|
| learn | bill, face, font and object |
| identify | bill, face, font and object, |
| predict | crypto |
| verify | face |
| compose | font, music-notes, music-audio and palette |
| transcribe | handwriting |
| range | object |
| weigh | object |
| detect | object |
| converse | chat |

The previous list currently contains the supported name/topic tuples at the time of this writing. The platform will automatically begin to include previously stated names and topics as demanded by the consumers of the platform.

If you wish to have a name/topic mentioned that is not currently active within the system please contact us and let us know. Furthermore, if a name/topic is not presented herein and you have recommendations for new tuples or updates to existing tuples, please let us know.

A payload is just that—it's the payload sent along with any request or response exchanged with the platform. Each and every payload is directly related to the name/topic tuple provided in the original request message sent to the platform. The payload at its most basic is a simple list of constructs provided. Payloads can support text, bytes, images, audio, video—really just about any type of data can be provided as long as its associated with the respective name/topic tuple.

For more information on payloads please refer to Messages within the documentation. Within Messages, we will provide examples of requests and responses as it relates to each name/topic tuple message exchanged.

In the below example table, we demonstrate the generate syntax for containing a payload within any platform message. For more concrete examples of payload please refer to our Messages section.

```
{
  created: 153128941134,
  type: 1,
  version: 1,
  name: ””,
  topic: ””,
  payload: { }
}
```

Platform messages are used as the primary communication between consuming systems and the VOSAI API platform.

Every exchange between a consuming system and the platform is performed through the use of messages. A message contains at the most basic level three primary elements which are required to perform any machine learning operation: (i) Name of the Message, (ii) Topic of the Message, and (iii) Payload associated to the Name/Topic Message.

Ensure consuming systems adhere to the other meta data related to each request/response message as defined previously under the Messaging, Result Codes, and Result Messages, Names and Topics and Payload sections of this documentation.

The API described here can also be used to learning real world objects, and is described in greater detail below. With respect to detecting objects in an image, it is a very common functionality used across a myriad of use cases including robotics, industrial automation, and social media outlets for marketing purposes or beyond. The act of detecting objects is simply just that—show the platform an image and the platform attempts to detect the objects and how many there are within the image provided. This is different than identification of objects. Please refer to Identifying Objects section.

The following JSON example tables demonstrate the use of this functionality within the platform.

```
{
  created: 153128941134,
  type: 1,
  version: 1,
  name: “detect”,
  topic: “object”,
  payload:
  {
  source: “base64-image-byte-data”,
  format: “png”
  }
}
```

```
{
  id: ”16643341-1234124-24141-4-33141”,
  conversation_id: ”123412341-1234124-24141-4-33141”,
  created: 153128941134,
  type: 2,
  version: 1,
  elapsed: 4398,
  result: 1,
  name: “detect”,
  topic: “object”,
  payload:
  [
  [
  x: 10,
  y; 10,
  width: 150,
  height: 300
  ],
  [
  x: 160,
  y: 10,
  width: 150,
  height: 300
  ]
  ]
}
```

The following table describes each of the properties passed thru the payload both in the request and response messages.

| Name | Type | Size | Description |
|---|---|---|---|
| source | byte[ ] | 8 MB | A byte array containing the raw contents of |
| | | | an source. |
| format | string | 4 | A string indicating the format of the source. |
| | | | The acceptable formats are gif, png, bmp, |
| | | | jpg, jpeg, and pdf. |
| x | integer | 0 to | An integer representing the starting X |
| | | 9223372036854775807 | coordinate within the source. |
| y | integer | 0 to | An integer representing the starting Y |
| | | 9223372036854775807 | coordinate within the source. |
| width | integer | 0 to | An integer representing the width of the |
| | | 9223372036854775807 | section within the source to be bounded. |
| height | integer | 0 to | An integer representing the height of the |
| | | 9223372036854775807 | section within the source to be bounded. |

The platform implements that latest available technology for detecting objects from a given image. At the highest level, an image is sent into the platform, the platform leverages the most commonly used algorithms for detecting objects within a frame, it boxes the image by detected object and then produces a response with cropped images for each object it believes is an object in the image.

Upon requesting the platform to detect objects, the platform performs these steps to produce bounding boxes to the image. From this point, the platform crops the images into numerous other images. The response message will contain a listing of these images in binary format ready for you consuming platform to use.

It is important to take note of the fact that detecting objects is not the same as identifying objects. A separate message is used to attempt to identifying objects in a given image. A similar response is provided with the exception that each cropped image includes potential names to help identify the object found.

With respect to identifying objects in an image, it is similar to detecting objects with the difference that when the platform identifies an object—it internally uses detection then attempts to identify each object. For example, an image of a tree is provided and we detect all the primary objects but then further identify them by saying this is a fruit or a leaf.

The following JSON example tables demonstrate the use of this functionality within the platform.

```
{
  created: 153128941134,
  type: 1,
  version: 1,
  name: “identify”,
  topic: “object”,
  payload:
  {
  source: “base64-image-byte-data”,
  format: “png”
  }
}
```

```
{
  id: ”16643341-1234124-24141-4-33141”,
  conversation_id: ”123412341-1234124-24141-4-33141”,
  created: 153128941134,
  type: 2,
  version: 1,
  elapsed: 4398,
  result: 1,
  name: “identify”,
  topic: “object”,
  payload:
  [
  {
  name: “toy doll”,
  x: 10,
  y; 10,
  width: 150,
  height: 300
  },
  {
  name: “toy doll”,
  x: 160,
  y: 10,
  width: 150,
  height: 300
  }
  ]
}
```

The following table describes each of the properties passed thru the payload both in the request and response messages.

| Name | Type | Size | Description |
|---|---|---|---|
| source | byte [ ] | 8 MB | A byte array containing the raw contents of an |
| | | | image. |
| format | string | 4 | A string indicating the format of the source. The |
| | | | acceptable formats are gif, png, bmp, jpg, jpeg, |
| | | | and pdf. |
| name | string | 1024 | A string representing the name of the object |
| | | | identified. |
| x | integer | 0 to | An integer representing the starting X coordinate |
| | | 9223372036854775807 | within the source. |
| y | integer | 0 to | An integer representing the starting Y coordinate |
| | | 9223372036854775807 | within the source. |
| width | integer | 0 to | An integer representing the width of the section |
| | | 9223372036854775807 | within the image to be bounded. |
| height | integer | 0 to | An integer representing the height of the section |
| | | 9223372036854775807 | within the source to be bounded. |

For the sake of simplicity, refer to detecting objects section of this documentation. The only difference between this message and detecting objects message is that the platform includes meta data information that attempts to elaborate on the object that has been identified.

The VOSAI platform doesn't know everything and does need to learn what things are in the world. Using this message allows your system to “train” or “teach” or what we call let VOSAI “learn” what an object is.

The following JSON example tables demonstrate the use of this functionality within the platform.

```
{
  created: 153128941134,
  type: 1,
  version: 1,
  name: “learn”,
  topic: “object”,
  payload:
```

```
[
  {source:”base64-image-data”, format=“png”, name=“toy doll”},
  {source:”base64-image-data”, format=“png”, name=“toy doll”},
  {source:”base64-image-data”, format=“png”, name=“toy doll”},
  {source:”base64-image-data”, format=“png”, name=“toy doll”},
  {source:”base64-image-data”, format=“png”, name=“toy doll”},
  {source:”base64-image-data”, format=“png”, name=“toy doll”}
]
```

}

```
{
id: ”16643341-1234124-24141-4-33141”,
  conversation_id: ”123412341-1234124-24141-4-33141”,
  created: 153128941134,
  type: 2,
  version: 1,
  elapsed: 4398,
  // use result to determine the success of this response
  result: 1,
  name: “learn”,
  topic: “object”
  // no payload required
}
```

The following table describes each of the properties passed thru the payload both in the request and response messages.

| Name | Type | Size | Description |
|---|---|---|---|
| source | byte [ ] | 8 MB | A byte array containing the raw |
| | | | contents of an image. |
| format | string | 4 | A string indicating the format of the |
| | | | source. The acceptable formats are gif, |
| | | | png, bmp, jpg, jpeg, and pdf. |
| name | string | 1024 | A string representing the name, identifier, |
| | | | or classifier of the object. |

This message works in an inverse manner to detecting and identifying objects. With this message, consuming systems upload cropped images—either provided by the platform or the consuming systems—and attaching respective classifiers and identification information for each cropped image.

Faces are one example use case, the application of which is explained in greater detail below. In this section we will walk through a few items as it relates to using machine learning with human faces—e.g., facial recognition techniques.

The ability to detect faces within an image allows to build a foundation of functionality that will later be explore in the next sections. Detecting a face works the same way as detecting an object within an image. There is no identification that takes place. The platform simply says these seem to be faces or face like.

The following JSON example tables demonstrate the use of this functionality within the platform.

```
{
  created: 153128941134,
  type: 1,
  version: 1,
  name: “detect”,
  topic: “face”,
  payload:
  {
  source:”base64-image-data”, format=“png”}
  }
}
```

```
{
  id: ”16643341-1234124-24141-4-33141”,
  conversation_id: ”123412341-1234124-24141-4-33141”,
  created: 153128941134,
  type: 2,
  version: 1,
  elapsed: 4398,
  result: 1,
  name: “detect”,
  topic: “face”,
  payload:
  [
  {
  x: 10,
  y: 10,
  width: 25,
  height: 60
  },
  {
  x: 160,
  y: 10,
  width: 35,
  height: 61
  }
  ]
}
```

The following table describes each of the properties passed thru the payload both in the request and response messages.

| Name | Type | Size | Description |
|---|---|---|---|
| source | byte [ ] | 8 MB | A byte array containing the raw contents of an |
| | | | image. |
| format | string | 4 | A string indicating the format of the source. The |
| | | | acceptable formats are gif, png, bmp, jpg, jpeg, |
| | | | and pdf. |
| x | integer | 0 to | An integer representing the starting X coordinate |
| | | 9223372036854775807 | within the source. |
| y | integer | 0 to | An integer representing the starting Y coordinate |
| | | 9223372036854775807 | within the source. |
| width | integer | 0 to | An integer representing the width of the section |
| | | 9223372036854775807 | within the source to be bounded. |
| height | integer | 0 to | An integer representing the height of the section |
| | | 9223372036854775807 | within the source to be bounded. |

The platform implements the most commonly used techniques and algorithms for detecting faces within an image. Consuming systems would upload one or more images that may or may not contain faces within them. Once uploaded, the platform would then analyze the images, create bounding boxes around each potential face, and respond with a list of cropped images each representing a potential face.

As with previous messages related to objects, the platform then creates bounding boxes around potential faces. Take note that the platform missed a face because it did not deem it a complete face. Furthermore, the platform also ignores objects and potential faces that may appear to be a face such that only a list of faces is provided. The response from the platform would include a list of faces with respective meta data like locations within image.

What good is detecting a face within knowing who it is? With this message you can train the platform to learn a specific face. This may be used for profiling of your customers or security reasons. For example, the platform may be trained to understand every known criminal or terrorist and could further be used to protect your organizations from these bad actors should they be encountered.

The following JSON example demonstrate the use of this functionality within the platform.

```
{
  created: 153128941134,
  type: 1,
  version: 1,
  name: “learn”,
  topic: “face”,
  payload:
```

```
[
  {source:”base64-image-data”, format=“png”, name=“john doe”},
  {source:”base64-image-data”, format=“png”, name=“john doe”},
  {source:”base64-image-data”, format=“png”, name=“john doe”},
  {source:”base64-image-data”, format=“png”, name=“john doe”},
  {source:”base64-image-data”, format=“png”, name=“john doe”},
  {source:”base64-image-data”, format=“png”, name=“john doe”}
]
```

}

{

id: ”16643341-1234124-24141-4-33141”,
conversation_id: ”123412341-1234124-24141-4-33141”,
created: 153128941134,
type: 2,
version: 1,
elapsed: 4398,
// use result to determine the success of this response
result: 1,
name: “learn”,
topic: “face”
// no payload required

}

The following table describes each of the properties passed thru the payload both in the request and response messages.

| Name | Type | Size | Description |
|---|---|---|---|
| source | byte [ ] | 8 MB | A byte array containing the raw contents |
| | | | of an image. |
| format | string | 4 | A string indicating the format of the source. |
| | | | The acceptable formats are gif, png, bmp, |
| | | | jpg, jpeg, and pdf. |
| name | string | 1024 | A string representing an identifier for the face |
| | | | in the source. Typically, the name of a person |
| | | | or email suffices and is up to the consuming |
| | | | system on how best to classify the face for |
| | | | later use. |

Learning a face requires that consuming systems understand who the face belongs to.

The platform takes this information it learns over the image or set of images provided associating the images with a given identifier—in this case the person's name. The analysis performed is outside the scope of this documentation but adheres to commonly used techniques in computer vision as it relates to facial recognition.

Internally, the platform uses algorithms to perform its analysis over the face of the individual by learning the shapes, measurements, dimensions, and locations of each part of the persons face. This is illustrated above by means of guidelines overlaying the photo.

Identifying faces works just like identifying objects. The platform must first learn who the faces are before it can accurately identify these faces. Once the platform learns the face it can then identify these faces in any image you provide.

The following JSON example table demonstrate the use of this functionality.

{

created: 153128941134,
type: 1,
version: 1,
name: “identify”,
topic: “face”,
payload:
{
source:”base64-image-data”, format=“png”
}

}

{

id: ”16643341-1234124-24141-4-33141”,
conversation_id: ”123412341-1234124-24141-4-33141”,
created: 153128941134,
type: 2,
version: 1,
elapsed: 4398,
result: 1,
name: “identify”,
topic: “face”,
// no payload will return if face could not be identified
payload:
{
identifier: “john doe”
}

}

The following table describes each of the properties passed thru the payload both in the request and response messages.

| Name | Type | Size | Description |
|---|---|---|---|
| source | byte [ ] | 8 MB | A byte array containing the raw contents |
| | | | of an image. |
| format | string | 4 | A string indicating the format of the source. |
| | | | The acceptable formats are gif, png, bmp, |
| | | | jpg, jpeg, and pdf. |
| identifier | string | 1024 | A string representing the classifier for the |
| | | | face in the source. This could either be a |
| | | | name or some sort of specific identifier |
| | | | unique to the consuming system. |

Once a consuming system has taught the platform about a given face it can then move to help identify this face without knowing any other information except for an image of the person's face. Obviously, if a new face is presented that is not already known then the system would be unable to identify the face.

Verifying a face is a slight derivative from identifying a face from the previous example. Verification of a face is confirming that the face provide is who they say they are. For example, say your corporate network requires a photo of an employee before signing into the network. Once the platform is trained on this particular employee, then your security system can make a request with this message to the platform with both the face presented and their identifying information such as a name or email address.

The following JSON example tables demonstrate the use of this functionality within the platform.

{

created: 153128941134,
type: 1,
version: 1,
name: “verify”,
topic: “face”,
payload:
{
source:”base64-image-data”, format=“png”, name: “john doe”
}

}

{

id: ”16643341-1234124-24141-4-33141”,
conversation_id: ”123412341-1234124-24141-4-33141”,
created: 153128941134,
type: 2,
version: 1,
elapsed: 4398,
result: 1,
name: “verify”,
topic: “face”,
payload:
{
verified: “true”
}

}

The following table describes each of the properties passed thru the payload both in the request and response messages.

| Name | Type | Size | Description |
|---|---|---|---|
| source | byte [ ] | 8 MB | A byte array containing the raw contents |
| | | | of an image. |
| format | string | 4 | A string indicating the format of the source. |
| | | | The acceptable formats are gif, png, bmp, |
| | | | jpg, jpeg, and pdf. |
| name | string | 1024 | A string representing the classifier for the |
| | | | face in the source. This could either be a name, |
| | | | email, or some sort of custom identifier used |
| | | | by the consuming system. |

Facial features are that components that make an individual's face can be extracted for recognition. For example, eyes, ears, nose, mouth, eyebrows, chin, cheeks are all considered to be a feature of a face. With this message, you can further break down the features of an individual's face. This is a specific use case designed for facial recognition companies and require such information.

The following JSON example table demonstrate the use of this functionality within the platform.

{

created: 153128941134,
type: 1,
version: 1,
name: “extract”,
topic: “face-features”,
payload:
{
source:”base64-image-data”, format=“png”
}

}

```
{
  id: ”16643341-1234124-24141-4-33141”,
  conversation_id: ”123412341-1234124-24141-4-33141”,
  created: 153128941134,
  type: 2,
  version: 1,
  elapsed: 4398,
  result: 1,
  name: “extract”,
  topic: “face-features”,
  payload:
```

[
{feature: “forehead”, x: 0, y: 10, height: 100, width: 500},
{feature: “eyebrows”, x: 1, y: 20, height: 10, width: 500},
{feature: “eyes”, x: 2, y: 30, height: 10, width: 500},
{feature: “cheeks”, x: 3, y: 40, height: 40, width: 500},
{feature: “mouth”, x: 4, y: 50, height: 20, width: 100},
{feature: “chin”, x: 5, y: 60, height: 20, width: 100},
{feature: “left-ear”, x: 6, y: 70, height: 50, width: 50},
{feature: “right-ear”, x: 7, y: 80, height: 50, width: 50},
{feature: “left-eye”, x: 8, y: 90, height: 10, width: 50},
{feature: “right-eye”, x: 9, y: 100, height: 10, width: 50},
{feature: “left-brow”, x: 10, y: 200, height: 10, width: 50},
{feature: “right-brow”, x: 11, y: 300, height: 10, width: 50}
]

}

The following table describes each of the properties passed thru the payload both in the request and response messages.

| Name | Type | Size | Description |
|---|---|---|---|
| source | byte [ ] | 8 MB | A byte array containing the raw contents of |
| | | | an image. |
| format | string | 4 | A string indicating the format of the source. |
| | | | The acceptable formats are gif, png, bmp, |
| | | | jpg, jpeg, and pdf. |
| feature | string | 32 | |
| x | integer | 0 to | An integer representing the starting X |
| | | 9223372036854775807 | coordinate within the source. |
| y | integer | 0 to | An integer representing the starting Y |
| | | 9223372036854775807 | coordinate within the source. |
| width | integer | 0 to | An integer representing the width of the |
| | | 9223372036854775807 | section within the source to be bounded. |
| height | integer | 0 to | An integer representing the height of the |
| | | 9223372036854775807 | section within the source to be bounded. |

There are cases where consuming systems of the platform need to analyze faces more than just the big picture per say. In this message, the platform attempts to detect a face and break it down to its parts. For example, the platform can then take the original image and produce a list of sub-images that make up the face returning them as the response to the original request. For the example of a face, sub-images can include a forehead, eyebrows, eyes, cheeks or nose, mouth or teeth, a chin, among other possibilities. The image is simply cropped up and returned to the consuming system. Except that each image includes meta information that describes what that cropped image is.

The platform will make every attempt to perform this operation as specific as possible. If an image is provided to the platform like this one demonstrated then the platform will be responded with addition images breaking down the face bit by bit. For example, a sub-image directed to the eyes could be further broken down into a left and a right eye.

It's often required to categorize faces in more than just logical buckets, for example, such as by demographic identification. For example, understanding the age, gender, or diversity of the face in question can aid organizations with improving customer service or more targeted marketing/advertising capabilities.

Demographic identification allows consuming systems to understand the age, gender, and diversity of the face in context. The platform will make ever attempt to provide the highest probability of information based on the known set of information at the time of identification.

The following JSON example tables demonstrate the use of this functionality within the platform.

{

```
created: 153128941134,
type: 1,
version: 1,
name: “identify”,
topic: “face-demographic”,
payload:
  {
  source:”base64-image-data”, format=“png”
  }
```

}

{

id: ”16643341-1234124-24141-4-33141”,
conversation_id: ”123412341-1234124-24141-4-33141”,
created: 153128941134,
type: 2,
version: 1,
elapsed: 4398,
result: 1,
name: “identify”,
topic: “face-demographic”,
payload:
[
[

diversity:

[
asian: 10,
black: 5,
european: 5,
hispanic: 50,
white: 24,
other: 1
],

age: 65,
sex: “male”

]
]

}

The following table describes each of the properties passed thru the payload both in the request and response messages.

| Name | Type | Size | Description |
|---|---|---|---|
| source | byte [ ] | 8 MB | A byte array containing the raw contents of an |
| | | | image. |
| format | string | 4 | A string indicating the format of the source. |
| | | | The acceptable formats are gif, png, bmp, jpg, |
| | | | jpeg, and pdf. |
| diversity | Complex | N/A | Complex Type that represents the diversity of a |
| | Type | | given face. |
| diversity.asian | integer | 0 to 100 | An integer representing the probability of this |
| | | | diversity. |
| diversity.black | integer | 0 to 100 | An integer representing the probability of this |
| | | | diversity. |
| diversity.european | integer | 0 to 100 | An integer representing the probability of this |
| | | | diversity. |
| diversity.hispanic | integer | 0 to 100 | An integer representing the probability of this |
| | | | diversity. |
| diversity.white | integer | 0 to 100 | An integer representing the probability of this |
| | | | diversity. |
| diversity.other | integer | 0 to 100 | An integer representing the probability of this |
| | | | diversity. |
| age | integer | 0 to 150 | An integer representing the estimated age. |
| sex | string | 8 | A string representing the sex of the face. Male, |
| | | | Female, Other. |

Further, sentiment identification can be used to determine the emotional state of a face. Organizations can leverage this information to better understand their customers, employees or any other person that may interact with their organization.

The following JSON example tables demonstrate the use of this functionality within the platform.

{

created: 153128941134,
type: 1,
version: 1,
name: “identify”,
topic: “face-sentiment”,
payload:
{
source:”base64-image-data”, format=“png”
}

}

```
  {
  id: ”16643341-1234124-24141-4-33141”,
  conversation_id: ”123412341-1234124-24141-4-33141”,
  created: 153128941134,
  type: 2,
  version: 1,
  elapsed: 4398,
  result: 1,
  name: “identify”,
  topic: “face-sentiment”,
  payload:
  [
  [
```

emotion:
[

anger: 2,
disgust: 5,
fear: 3,
joy: 80,
sadness: 0,
surprise: 10
],

sentiment:

```
  [
  positivity: 75,
  negativity: 20,
  neutral: 5
  ]
  ]
  ]
}
```

The following table describes each of the properties passed thru the payload both in the request and response messages.

| Name | Type | Size | Description |
|---|---|---|---|
| source | byte [ ] | 8 MB | A byte array containing the raw |
| | | | contents of an image. |
| format | string | 4 | A string indicating the format of |
| | | | the source. The acceptable |
| | | | formats are gif, png, bmp, jpg, |
| | | | jpeg, and pdf. |
| emotion | Complex | N/A | A Complex Type representing |
| | Type | | the emotional state of the face. |
| emotion.anger | integer | 0 to | An integer representation of the |
| | | 9223372036854775807 | probability of this emotion. |
| emotion.disgust | integer | 0 to | An integer representation of the |
| | | 9223372036854775807 | probability of this emotion. |
| emotion.fear | integer | 0 to | An integer representation of the |
| | | 9223372036854775807 | probability of this emotion. |
| emotion.joy | integer | 0 to | An integer representation of the |
| | | 9223372036854775807 | probability of this emotion. |
| emotion.sadness | integer | 0 to | An integer representation of the |
| | | 9223372036854775807 | probability of this emotion. |
| emotion.surprise | integer | 0 to | An integer representation of the |
| | | 9223372036854775807 | probability of this emotion. |
| sentiment | integer | 0 to | An integer representation of the |
| | | 9223372036854775807 | probability of this emotion. |
| sentiment.positivity | integer | 0 to | An integer representation of the |
| | | 9223372036854775807 | probability of this emotion. |
| sentiment.negativity | integer | 0 to | An integer representation of the |
| | | 9223372036854775807 | probability of this emotion. |
| sentiment.neutrality | integer | 0 to | An integer representation of the |
| | | 9223372036854775807 | probability of this emotion. |

It will be appreciated that the foregoing application can be adapted to other areas of recognition and analysis. For example, in addition to the capability to detect, identify and learn faces and/or objects. The platform can be expanded upon to include things like ranging or weighing objects in a given image. These use cases are often useful for robotics or health applications.

With respect to ranging objects, in robotics and self-driving vehicles, it's important for systems to accurately assess the environment they reside in. Often times expensive sensors and devices are employed in order to ensure proper operations. With the advancements in computer vision we are capable of ranging a given object if the object is already known.

For example, a camera on an autonomous vehicle has snapped an image of what's in front of it. The platform can first detect objects in the image in front of the vehicle. Next it may form a bounded box around an identified object, and crop it accordingly.

The platform then attempts to determine the range to the object based on the information the platform already knows about street cones. For example, a street cone can average in size including height and width dimensions. Leveraging basic computer vision techniques and known camera settings a consuming application of the platform can use this image to allow the platform to determine the estimated range to an object.

The platforms response includes a list of detected AND identified objects along with each object respective range from the cameras viewpoint. At this point, the autonomous vehicle consuming system can act based on this information, such as that demonstrated in the below sample tables.

{

created: 153128941134,
type: 1,
version: 1,
name: “range”,
topic: “object”,
payload:
{
source:”base64-image-data”, format=“png”
}

}

{

id: ”16643341-1234124-24141-4-33141”,
conversation_id: ”123412341-1234124-24141-4-33141”,
created: 153128941134,
type: 2,
version: 1,
elapsed: 4398,
result: 1,
name: “range”,
topic: “object”,
payload:
[
{
x: 10,
y: 10,
width: 150,
height: 300,
distance: 1924
},
{
x: 160,
y: 10,
width: 150,
height: 300,
distance: 1751
}
]

}

The following table describes each of the properties passed thru the payload both in the request and response messages.

| Name | Type | Size | Description |
|---|---|---|---|
| source | byte [ ] | 8 MB | A byte array containing the raw contents of an |
| | | | image. |
| format | string | 4 | A string indicating the format of the source. |
| | | | The acceptable formats are gif, png, bmp, jpg, |
| | | | jpeg, and pdf. |
| x | integer | 0 to | An integer representing the starting X |
| | | 9223372036854775807 | coordinate within the source. |
| y | integer | 0 to | An integer representing the starting Y |
| | | 9223372036854775807 | coordinate within the source. |
| width | integer | 0 to | An integer representing the width of the section |
| | | 9223372036854775807 | within the source to be bounded. |
| height | integer | 0 to | An integer representing the height of the section |
| | | 9223372036854775807 | within the source to be bounded. |
| distance | integer | 0 to | An integer representing the estimated distance to |
| | | 9223372036854775807 | the object in centimeters. |

With respect to weighing objects, the ability to weigh an object in an image can prove to be useful for many organizations. These organizations may include farms, packing houses, warehouses, medical, a mobile app for adhering to your diet and the like.

As an example, for a picture containing peppers, the platform breaks down this image into a set of images that represent identified objects—in this case—peppers. Similar to previous messages, the platform responds with cropped images of each object including respective meta data for each image. In this case—what is the object (pepper) and how much does it weigh, such as that demonstrated in the below sample table.

{

created: 153128941134,
type: 1,
version: 1,
name: “weigh”,
topic: “object”,
payload:
{
source:”base64-image-data”, format=“png”
}

}

{

id: “16643341-1234124-24141-4-33141”,
conversation_id: “123412341-1234124-24141-4-33141”,
created: 153128941134,
type: 2,
version: 1,
elapsed: 4398,
result: 1,
name: “weigh”,
topic: “object”,

payload:

[
{

```
  x: 10,
  y: 10,
  width: 150,
  height: 300,
  weight: 190
```

} ,
{

```
  x: 160,
  y: 10,
  width: 150,
  height: 300,
  weight: 251
```

}
]

}

The following table describes each of the properties passed thru the payload both in the request and response messages.

| Name | Type | Size | Description |
|---|---|---|---|
| source | byte [ ] | 8 MB | A byte array containing the raw contents of an |
| | | | image. |
| format | string | 4 | A string indicating the format of the source. The |
| | | | acceptable formats are gif, png, bmp, jpg, jpeg, |
| | | | and pdf. |
| x | integer | 0 to | An integer representing the starting X coordinate |
| | | 9223372036854775807 | within the source. |
| y | integer | 0 to | An integer representing the starting Y coordinate |
| | | 9223372036854775807 | within the source. |
| width | integer | 0 to | An integer representing the width of the section |
| | | 9223372036854775807 | within the source to be bounded. |
| height | integer | 0 to | An integer representing the height of the section |
| | | 9223372036854775807 | within the source to be bounded. |
| weight | integer | 0 to | An integer representing the estimated weight of |
| | | 9223372036854775807 | the object in the source. Measurement is in |
| | | | grams. |

It is important to note that platform must be aware of what the object is in order to perform this task. Therefore, having the platform learn over objects is important for those organizations that do not have commonly found objects in the world used within their systems.

Bills and invoices are another application. In this section we will walk through a few items as it relates to using machine learning with bills received by everyone from a service provider like your internet bill.

With respect to learning bills, the process of learning a particular bill (e.g., invoice) requires consuming system to send a myriad of invoices and bills with related information which is used to train the platform about the bill itself. This later allows consuming systems to automate the input of these bills into their systems to better aid customers. This is often a use case in banking or any other financial technology company.

The following JSON example tables demonstrate the use of this functionality within the platform.

```
{
  created: 153128941134,
  type: 1,
  version: 1,
  name: “learn”,
  topic: “bill”,
  payload:
  [
```

[

```
  source:”base64-image-data”,
  format=“png”,
  logo: {x: 10, y: 10, width: 100, height: 25, name=“acme company”},
  address: {x: 10, y: 110, width; 200, height: 100}
  total: {x: 1000, y: 1000, width: 250, height: 100}
  ],
```

[

```
  source:”base64-image-data”,
  format=“pdf”,
  logo: {x: 10, y: 10, width: 100, height: 25, name=“acme company”},
  address: {x: 10, y: 110, width: 200, height: 100}
  total: {x: 1000, y: 1000, width: 250, height: 100}
  ]
  ]
}
```

```
{
  id: ”16643341-1234124-24141-4-33141”,
  conversation_id: ”123412341-1234124-24141-4-33141”,
  created: 153128941134,
  type: 2,
  version: 1,
  elapsed: 4398,
  // use result to determine the success of this response
  result: 1,
  name: “learn”,
  topic: “bill”
  // no payload required
}
```

The following table describes each of the properties passed thru the payload both in the request and response messages.

| Name | Type | Size | Description |
|---|---|---|---|
| source | byte [ ] | 8 MB | A byte array containing the raw |
| | | | contents of an image. |
| format | string | 4 | A string indicating the format of the |
| | | | source. The acceptable formats are |
| | | | gif, png, bmp, jpg, jpeg, and pdf. |
| logo | Complex | N/A | A Complex Type indicating where the |
| | Type | | logo, if any, can be found within the |
| | | | source. |
| logo.x | integer | 0 to | An integer representing the starting X |
| | | 9223372036854775807 | coordinate within the source. |
| logo.y | integer | 0 to | An integer representing the starting Y |
| | | 9223372036854775807 | coordinate within the source. |
| logo.width | integer | 0 to | An integer representing the width of |
| | | 9223372036854775807 | the section within the source to be |
| | | | bounded. |
| logo.height | integer | 0 to | An integer representing the height of |
| | | 9223372036854775807 | the section within the source to be |
| | | | bounded. |
| logo.name | string | 1024 | A string representation of the name |
| | | | associated with the logo within the |
| | | | source. |
| address | Complex | N/A | A Complex Type indicating where the |
| | Type | | address, if any, can be found within |
| | | | the source. |
| address.x | integer | 0 to | An integer representing the starting X |
| | | 9223372036854775807 | coordinate within the source for the |
| | | | address. |
| address.y | integer | 0 to | An integer representing the starting Y |
| | | 9223372036854775807 | coordinate within the source for the |
| | | | address. |
| address.width | integer | 0 to | An integer representing the width of |
| | | 9223372036854775807 | the section within the source to be |
| | | | bounded. |
| address.height | integer | 0 to | An integer representing the height of |
| | | 9223372036854775807 | the section within the source to be |
| | | | bounded. |
| total | integer | 0 to | A Complex Type indicating where the |
| | | 9223372036854775807 | total, if any, can be found within the |
| | | | source. |
| total.x | integer | 0 to | An integer representing the starting X |
| | | 9223372036854775807 | coordinate within the source for the |
| | | | total. |
| total.y | integer | 0 to | An integer representing the starting Y |
| | | 9223372036854775807 | coordinate within the source for the |
| | | | total. |
| total.width | integer | 0 to | An integer representing the width of |
| | | 9223372036854775807 | the section within the source to be |
| | | | bounded. |
| total.height | integer | 0 to | An integer representing the height of |
| | | 9223372036854775807 | the section within the source to be |
| | | | bounded. |

The platform takes in a source image and attempts to learn particular information found on the bill. By identifying where certain information on the request, the consuming system is teaching the platform how to identify these bills for subsequent request.

With respect to identifying bills, the act of identifying bills assumes your consuming system has already trained the VOSAI platform on the bills in question. Once trained, the platform can then be used to identify new bills encountered by your systems while enabling your platform to automatically insert meta data on these bills with minimal effort. This ultimately removes the need for manual data entry while improving your customers experience.

The following JSON example tables demonstrate the use of this functionality within the platform.

```
{
  created: 153128941134,
  type: 1,
  version: 1,
  name: “identify”,
  topic: “bill”,
  payload:
  [
```

[source:”base64-image-data”, format=“png”, id: 1],
[source:”base64-image-data”, format=“bmp”, id: 2],
[source:”base64-image-data”, format=“gif”, id: 3],
[source:”base64-image-data”, format=“pdf”, id: 4]

]
}

```
{
  id: ”16643341-1234124-24141-4-33141”,
  conversation_id: ”123412341-1234124-24141-4-33141”,
  created: 153128941134,
  type: 2,
  version: 1,
  elapsed: 4398,
  result: 1,
  name: “identify”,
  topic: “bill”,
  payload:
  [
  [id: 1, name: “acme co”, total: 999.99, address: “12312 SW 12 ST Miami, FL”]
  [id: 2, name: “acme co”, total: 129.99, address: “12312 SW 12 ST Miami, FL”]
  [id: 3, name: “acme co”, total: 79.99, address: “12312 SW 12 ST Miami, FL”]
  [id: 4, name: “acme co”, total: <span class=“cm-operator”>−1.99, address: “12312 SW
12 ST Miami, FL”]
  ]
}
```

The following table describes each of the properties passed thru the payload both in the request and response messages.

| Name | Type | Size | Description |
|---|---|---|---|
| source | byte [ ] | 8 MB | A byte array containing the raw contents of |
| | | | an image. |
| format | string | 4 | A string indicating the format of the source. |
| | | | The acceptable formats are gif, png, bmp, |
| | | | jpg, jpeg, and pdf. |
| id | integer | 0 to | |
| | | 9223372036854775807 | |
| name | string | 1024 | |
| total | decimal | −999999999999999999 | |
| | | to | |
| | | 999999999999999999 | |
| address | string | 1024 | |

Other application can include additional messages. Additional messages include the following: (i) transcribing from audio and images of documents; (ii) predictions on historical information as it relates to logistics, financial markets, inventory, cash flow; (iii) linguistics for interactive chat bot conversations; (iv) palette composition; (v) font detection, composition, identification; (vi) music composition, creation and production; (vii) art composition, creation and production, among various other possibilities.

Turn to results, result codes and messages is static information provided by the VOSAI API to allow consuming systems to properly handle responses based on the requests provided. A Result Code is an optional property found on a response from the VOSAI API. Consuming systems should use the Result Code to programmatically handle any issues that may arise from their request to the platform.

Result Codes are represented as integers at the message level and can be interpreted by the following table below.

| Name | Value | Description | Message |
|---|---|---|---|
| Unknown | 0 | An unknown issue arose and | |
| | | consuming systems should | |
| | | assume that request made in the | |
| | | same manner should not be | |
| | | processed further. Please | |
| | | contact support to troubleshoot | |
| | | or assist with the diagnosis of | |
| | | the issue. Often times this | |
| | | arises when a request has been | |
| | | slightly formatted | |
| | | inappropriately or improper | |
| | | encoding was used. | |
| Ok | 1 | Simply means there is nothing | |
| | | wrong with your request and the | |
| | | response is Ok. This may mean | |
| | | that there was an issue with the | |
| | | request, but the platform was | |
| | | able to assume and recover from | |
| | | the issue and mark the response | |
| | | as Ok. | |
| Fail | 2 | A fail result code is as stated. | |
| | | Your request failed to produce a | |
| | | proper response. This is the | |
| | | broadest of result codes and | |
| | | generally used when an issue | |
| | | has not be previously classified | |
| | | by the platform as a common | |
| | | occurrence. | |
| MessageUnknown | 3 | A request was provided to the | Message is |
| | | platform that was unknown. | unknown |
| | | The platform can accept any | |
| | | JSON message, but will only | |
| | | process those messages it | |
| | | understands and supports. This | |
| | | allows us to easily upgrade or | |
| | | downgrade as required by the | |
| | | platform and its consumers. | |
| FormatError | 4 | There was a formatting issue | Content is |
| | | with the JSON request | not JSON or |
| | | associated to this response. | an |
| | | Please check your consuming | unacceptable |
| | | systems and refer to our | JSON |
| | | documentation for proper | schema |
| | | formatting. | |
| ResponseNotJsonable | 5 | This indicates that the platform | Content is |
| | | could not produce a response | not JSON or |
| | | message that could be fit into a | an |
| | | JSON format. This may be due | unacceptable |
| | | to an invalid payload format | JSON |
| | | provided to the platform. | schema |
| | | Please confirm the payload | |
| | | provided for your requested is | |
| | | formatted properly and marked | |
| | | accordingly with meta data as | |
| | | described by the documentation. | |
| ResourceNotEnabled | 6 | The platform has the ability to | System is |
| | | enable or disable resources | unavailable |
| | | dynamically by request or | at this time |
| | | consumer. This feature allows | |
| | | us to easily upgrade, | |
| | | downgrade, patch and remove | |
| | | access or grant access to the | |
| | | resource. If your consuming | |
| | | system continues to receive this | |
| | | result code then contact support | |
| | | staff in order to enable this | |
| | | resource for your organization. | |
| TopicMismatch | 7 | Messages provided to the | Topic is not |
| | | platform require a name/topic | provided or |
| | | tuple to be properly handled. | unknown for |
| | | When this result code presents | this URI |
| | | itself, the topic provided does | |
| | | not match the name provided by | |
| | | the consuming system. This | |
| | | may be due to typos or changes | |
| | | in the platform. We suggest | |
| | | checking your request message | |
| | | and validating it against the | |
| | | documentation to ensure the | |
| | | consumer has the proper topic | |
| | | set in the request message. | |
| NameTopicMismatchOrUnknown | 8 | When this result code presents | Name and/or |
| | | itself, it often means that the | Topic is not |
| | | platform has recognized both | provided or |
| | | the name and the topic. | unknown for |
| | | However, they are not a | this URI |
| | | supported tuple in the platform. | |
| | | Please refer to the | |
| | | documentation to ensure the | |
| | | request contains a support | |
| | | name/topic tuple. | |
| SystemUnavailable | 9 | This indicates that the platform | System is |
| | | is currently unavailable. This | unavailable |
| | | may arise in the following | at this time |
| | | circumstances: | |
| | | Platform upgrades, | |
| | | downgrades, patches, | |
| | | deployments. | |
| | | Your consuming system is | |
| | | beyond the limits set for | |
| | | your organization. | |
| | | Network connectivity issues | |
| | | between your consuming | |
| | | system and the platform. | |
| | | If this issue continues we | |
| | | suggest checking with each of | |
| | | the previously mentioned items. | |
| | | Moreover, if the issue does not | |
| | | resolve itself on its own, we | |
| | | suggest contacting support to | |
| | | aid in resolving the matter | |
| | | accordingly. | |
| MinerUnavailable | 10 | This indicates that your request | No miner |
| | | was received but the entire | was |
| | | miner network is full with | available for |
| | | requests. We make ever | your request |
| | | attempt to ensure this result | |
| | | code is never encountered. | |
| | | Should you encounter this issue | |
| | | we recommend consuming | |
| | | systems attempting the request | |
| | | again. We suggest waiting at | |
| | | minimum 30 seconds before | |
| | | attempting the same request. | |
| | | Unrelated requests can still be | |
| | | made and not held to this | |
| | | standard. | |
| MinerUnableToProcess | 11 | This indicates the platform | Miner was |
| | | received your request and | unable to |
| | | dispatched it for processing. | process your |
| | | However, there was an issue | request |
| | | with your payload and the | |
| | | miners were unable to handle | |
| | | the payload. This is often due | |
| | | to size restrictions or limitations | |
| | | for certain payload sizes. | |
| MnerUnreachable | 12 | This indicates that no miners | Miner was |
| | | were reachable. This only | not |
| | | occurs in the event of a network | reachable |
| | | upgrade in which all miners in | for your |
| | | our network are updating | request |
| | | platform software. We suggest | |
| | | waiting for a period of time | |
| | | before attempting your request | |
| | | again. Furthermore, we will | |
| | | make announcements as we | |
| | | perform these upgrades and | |
| | | suggest your organization | |
| | | monitor these notifications as | |
| | | they occur. | |

The following section illustrate a few ways consuming systems may receive results codes and messages for a given request/response tuple. It's important for consuming system to build accordingly in order to ensure smooth running of their platforms and the VOSAI API.

```
{
  id: ”16643341-1234124-24141-4-33141”,
  conversation_id: ”123412341-1234124-24141-4-33141”,
  created: 153128941134,
  type: 2,
  version: 1,
  elapsed: 4398,
  result: 0,
  result_code: 3,
  result_message: “Message is unknown”,
  // these fields left blank intentionally for example purposes
  // they would never return blank like in this example
  name: ””,
  topic: ””,
  payload: { }
}
```

Consuming systems should implement the following logic in order to handle any message exchange with the platform. First, check the result property for success. Second, if result=1, then assume message exchange is successful. Third, if result=0, then check result_code to determine how best to handle the issue. Fourth, if result=0, then check result_message for additional information.

We do not advise using our result_message field to display information to the users of the consuming system. The result_message is meant for internal purposes between the platform and the consuming system for troubleshooting purposes only.

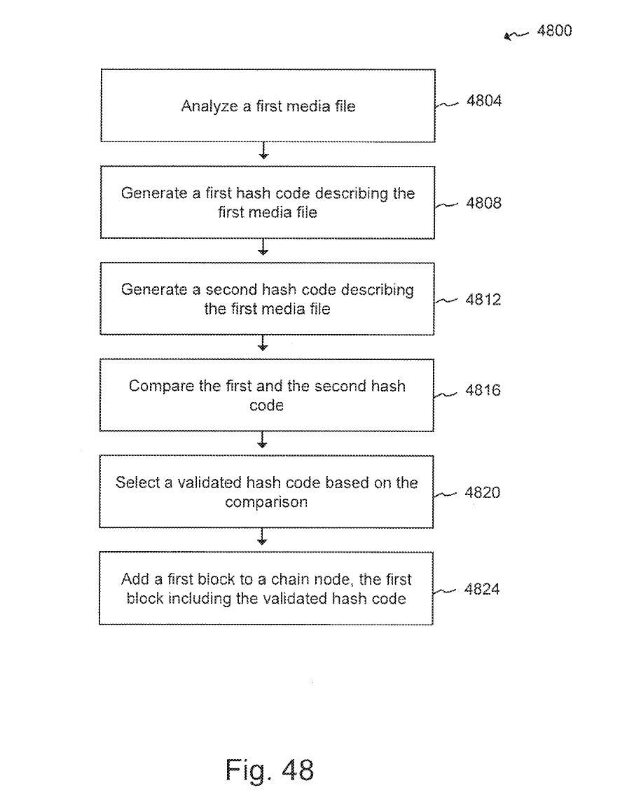

To facilitate the reader's understanding of the various functionalities of the embodiments discussed herein, reference is now made to the flow diagram in FIGS. 48-50, which illustrates processes 4800, 4900, and 5000, respectively. While specific steps (and order of steps) of the methods presented herein have been illustrated and will be discussed, other methods (including more, fewer, or different steps than those illustrated) consistent with the teachings presented herein are also envisioned and encompassed with the present disclosure.

In this regard, with reference to FIG. 48, process 4800 relates generally to a method of storing artificial intelligence data for a blockchain. The process 4800 can be used with any of the decentralized memory storage structures and chains described herein, for example, including the chains of diagrams 1800, 1900, and 2000 and variations and combinations thereof.

At operation 4804, a first media file is analyzed by two or more computers. For example and with reference to FIGS. 15 and 23, a media file 2304 can be analyzed by two or more computers. The two of more computers can be members of learning community 1504. The first media file can be a text file, an audio file, a video file, and/or other type of media file. The media file can be analyzed by the two or more computers in order to determine machine learnings from the media files, allowing the media files to be compared with other media files. In this regard, rather than compare the media file itself with another media file, a code, such as a hash code, representative of the images, can be compared with other codes. Further and as described herein, this can allow for reduced storage requirements through a network, for example, as the hash code or the machine learning can be stored on a chain or chain node, rather than the underlying media itself.

In this regard, at operation 4808, a first hash code is generated describing the first media file. For example and with reference to FIGS. 15 and 23, a hash code can be generated and stored in a hash code block 2316 of a block node 2320. The hash code stored in the hash code block 2316 can describe the media file 2304 without actually storing the contents of the media on the node. As described herein, the hash code can be the result of a specific machine learning algorithm or other analysis that attempts to convert the media file into a code describing the media and that can be compared with codes that describe other, potentially similar media files.

In part to facilitate validating the code and comparing with a community of learners, at operation 4812, a second hash code is generated describing the first media file. For example and with reference to FIGS. 15 and 23, the first media file 2304 can be analyzed by other members of the learning community 1504 for generation of a second hash code describing the media file. In some cases, this second hash code can also be stored in a chain node. The same media file thus can have a first and second hash code that has been determined to describe the media file, as determined separate computers in the learning community,

At operation 4816, the first hash code and the second hash code are compared. For example and with reference to FIG. 10, the first and second hash code can be compared to determine whether the code is validated. At operation 4820, a validated hash code is selected based on a comparison between the first hash code and the second hash code. In some cases, multiple other hash codes can be generated by other computers describing the same media file too. In this regard, the community of learners can collectively arrive at a consensus or generate agreement as to the best hash representation of the media file. This distributed approach allows for leveraging the “world computer” and machine leanings of multiple different computers, rigs, and the like to arrive at a validated code. And by using multiple computers distributed in this manner, the need for centralized data centers or other large centralized computing resources is reduced.

At operation 4824, a first block is added to a chain node. The first block includes the validated hash code describing the first media file. For example and with reference to FIG. 23, the validate code is stored on a node. This step thus represents that rather than the underlying media being stored on the chain node, only the validated hash code need be stored. This can reduce the overall storage requirements for the system and improve processing time for subsequent queries. For example, when new media is introduced into the system and a customer attempts to compare and query with other data, the hash codes can be queries and compared rather the media itself.

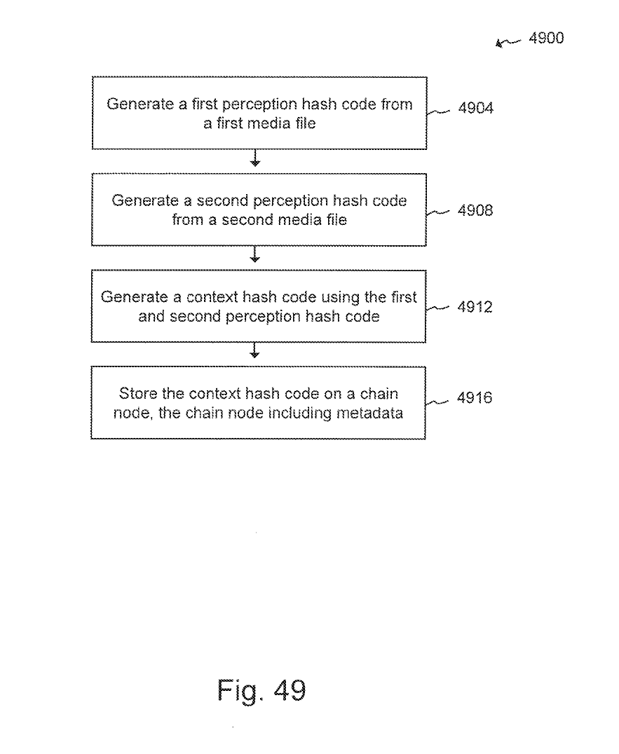

With reference to FIG. 49, process 4900 relates generally to a method of creating a multimedia hash for a blockchain storage structure. The process 4900 can be used with any of the decentralized memory storage structures and chains described herein, for example, such including the chains of diagrams 1800, 1900 and 2000 and variations and combinations thereof.

At operation 4904, a first perception hash code is generated from a first media file. For example and with reference to FIG. 25, a first perception hash code 2504a can be generated from a first media file, such as a text file. As described herein the perception hash is a particular type of hashing algorithm that aims to describe the underlying media itself. This can be analogous, in some embodiments, to a fingerprint of the media file, thus having the perception hash contain the relevant pieces of information by which to identify the underlying media file and compare it with other, possibly similar media files.

At operation 4908, a second perception hash code is generated from a second media file. For example and with reference to FIG. 25, a second perception hash code 2504b can be generated from a second media file, such as an audio or image file. In this regard, operation 4908 can be substantially analogous to that of operation 4904 in that it generates a perception hash. Notably, the perception hash can be for a different media file. For example, whereas the first media file of process 4900 may be a text file and second media file may be an audio file or a video file. In other cases, the second media file can be a separate text file from that analyzed with respect to operation 4904. In some cases, the first and second media file can be associated with one another. For example, the first media file can be an audio file from an environment or scene and the second media file can be a video file associated with the same environment or scene. In this regard, the first and second media file, together, can represent a multi-media repository of an actual physical environment or event. The individual perception hashes thus are machine learnings describing the individual media types or files.

The individual perception hashes can be combined to create a context hash, allowing for comparisons of the multi-media environment across a variety of use cases. For example, at operation 4912, a context hash code is generated using the first and second perception hash codes. For example and with reference to FIG. 25, portions or all of the first hash code 2504a and the second hash code 2504b can be combined to form a context hash code 2508. The context hash code 2508 can thus be a machine learning describing the multi-media environment. At operation 4916, the context hash code is stored on a chain node. The chain node includes metadata describing attributes of an environment associated with the first and second media file.

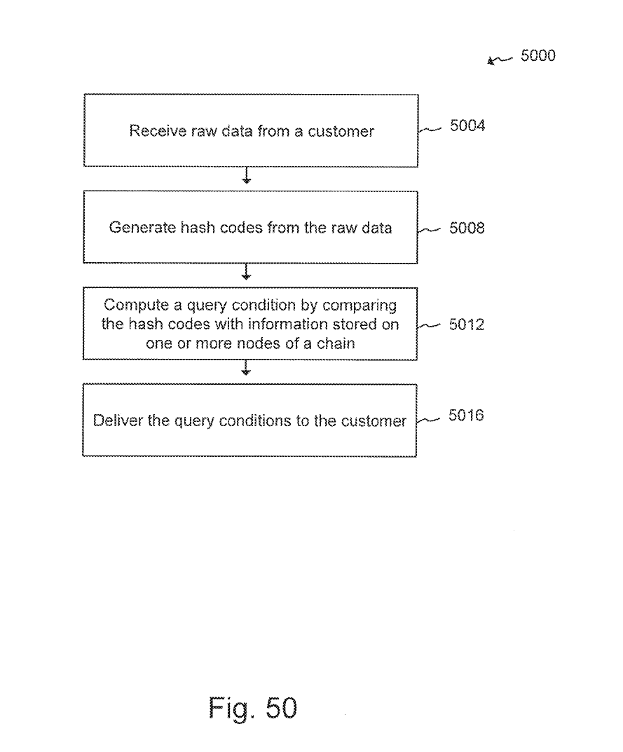

With reference to FIG. 50, process 5000 relates generally to a method of querying a data storage structure for artificial intelligence data. The process 5000 can be used with any of the decentralized memory storage structures and chains described herein, for example, including the chains of diagrams 1800, 1900, and 2000 and variations and combinations thereof.

At operation 5004, raw data is received from a customer for a customer application. The data includes media associated with an environment. For example and with reference to FIG. 33, a JASON RESTful API 3324 can receive raw data from a customer. This can be substantially any type or form of data that a customer wishes to analyze, including image, text, audio, and other data types. Using the various processes described herein, the customer is able to leverage the machine leanings of the community of learners, without having to invest in resource intensive artificial intelligence operations at a customer-centralized location or a user device, helping expand the use cases and benefits of the platform and machine learning.

At operation 5008, hash codes are generated from the raw data using a decentralized memory storage structure. For example and with reference to FIG. 33, PATHWAY node 3304 is associated with computing resources, including miners that can help generate hash codes for the raw data. This allows the raw data received from the customers to be described using machine learnings, which can be more easily queried across the chain than could the underlying media file itself.

At operation 5012, a query condition is computed by comparing the hash codes with information stored on one or more nodes of a chain. The query condition can be an application-specific request, such as identifying names, faces, objects, transaction, and so on. The information stored on the chain can be other hash codes that the platform has already learned described particular media types. This could be hash codes that describe media that is learned and stored on a main chain, as described herein. The customer is therefore able to leverage the machine learnings of the network across a wide variety and spectrum of uses cases, without necessarily investing in the initial machine learning itself. In turn, at operation 5016, the query condition is delivered to the customer for incorporation into the customer application. This could include delivering the query condition or other results to an end-user application, as may be appropriate for a given configuration.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B or C” means A or B or C or AB or AC or BC or ABC (i.e. A and B and C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A method for storing artificial intelligence data for a blockchain, comprising:
analyzing by two or more computers a first media file;
generating by the first computer a first hash code describing the first media file;
generating by the second computer a second hash code describing the first media file;
comparing the first hash code and the second hash code;
selecting a validated hash code based on a comparison between the first hash code and the second hash code; and
adding a first block to a chain node, wherein the first block includes the validated hash code describing the first media file.

2. The method of claim 1, wherein:
the chain node is associated with a side storage chain; and
the method further includes merging the first block with a main storage chain, the main storage chain including a compendium of learned content across a domain.

3. The method of claim 1, wherein the chain node further includes:
a metadata block describing attributes of an environment associated the first media file,
a related block describing a relationship of the chain node to another chain node, or
a data block including information derived from a machine learning process.

4. The method of claim 1, wherein:
the first media file includes a sound file, a text file, or an image file; and
the validated hash code references one or more of the sound file, the text file, or the image file without storing the one or more of the sound file, the text file, or the image file on the chain node or associated chain nodes.

5. The method of claim 1, further comprising:
determining the first or second computer is a validated learner by comparing the first hash code and the second hash code with the validate hash code; and
transmitting a token to the first or second computer in response to a determination of the first or second computer being a validated learner.

6. The method of claim 1, further comprising:
receiving a second media file from a customer;
generating another hash code by analyzing the second media file with the two or more computers or another group of computers;
computing a query condition for the artificial intelligence data by comparing the another hash code with the validated hash code of the first block or other information of the chain node; and
delivering the query condition to the customer for incorporation into a customer application.

7. A decentralized memory storage structure comprising:
a main storage chain stored on a plurality of storage components and comprising a plurality of main blocks; and
one or more side storage chains stored on the plurality of storage components and comprising a plurality of side blocks, wherein
one or more of the side blocks are merged into the main storage chain based on a validation process.

8. The storage structure of claim 7, wherein the plurality of main blocks and the plurality of side blocks comprise unique, non-random, identifiers, wherein the identifiers describe at least one of a text, an image, or an audio.

9. The storage structure of claim 8, wherein the at least one of the text, the image, or the audio is not stored on the main storage chain or the side storage chain.

10. The storage structure of claim 7, wherein the plurality of main blocks and the plurality of side blocks comprise block relationships describing a relationship between each block and another block in the respective main chain or side chain.

11. The storage structure of claim 7, further comprising two or more computers geographically distributed across the decentralized memory storage structure and defining a community of learners.

12. The storage structure of claim 11, wherein the validation process comprises a determining a validation hash code from the community of learners by comparing hash codes generated by individual ones of the two or more computers.

13. A method for creating a multimedia hash for a blockchain storage structure, comprising:
generating a first perception hash code from a first media file;
generating a second perception hash code from a second media file;
generating a context hash code using the first and second perception hash code; and
storing the context hash code on a chain node, the chain node including metadata describing attributes of an environment associated with the first and second media file.

14. The method of claim 13, further comprising performing a validation process on the first or second perception hash code.

15. The method of claim 14, wherein the validation process relies on a community of learners, each operating a computer that collectively defines a decentralized memory storage structure.

16. The method of claim 15, wherein:
each of the community of learners generates a hash code for the first or second media file; and
the generated hash codes are compared among the community of learners to determine a validated hash code for the first or second perception hash code.

17. The method of claim 13, wherein the first and second media file are different media types, the media types includes a sound file, a text file, or an image file.

18. The method of claim 13, wherein:
the method further includes generating a third perception hash code from a third media file associated with the environment; and
the operation of generating the context hash code further includes generating the context hash code using the third perception hash code.

19. The method of claim 13, wherein:
the environment is a first environment; and
the method further includes:
generating a subsequent context hash code for another media file associated with a second environment, and
analyzing the second environment with respect to the first environment by querying a chain associated with the chain node using the subsequent context hash code.

20. A method querying a data storage structure for artificial intelligence data, comprising:
receiving raw data from a customer for a customer application, the data including media associated with an environment;
generating hash codes from the raw data using a decentralized memory storage structure;
computing a query condition by comparing the hash codes with information stored on one or more nodes of a chain; and
delivering the query condition to the customer for incorporation into the customer application.

21. The method of claim 20, wherein the operation of receiving comprises using an API adaptable to the customer application across a domain of use cases.

22. The method of claim 21, wherein the API comprises a data format for translating user requests into the query condition for traversing the one or more nodes.

23. The method of claim 22, wherein the data format is a template modifiable by the customer.

24. The method of claim 20, wherein the information stored on the one or more chains includes validated hash codes validated by a community of users.

25. The method of claim 21, wherein information further includes metadata descriptive of the environment.

26. The method of claim 20, wherein the operation of generating hash codes from the raw data comprises generating context hash codes describing the media associated with the environment.

27. The method of claim 20, further comprising updating the one or more nodes of the chain with the generated hash codes.

28. The method of claim 27, wherein:
the chain is a private chain; and
the operation of updating further comprises pushing information associated with the updated one or more nodes of the private chain to other chains of a distributed network.
